(19) United States
(12) Patent Application Publication
(10) Pub. No.: US 2012/0215908 A1
(43) Pub. Date: Aug. 23, 2012

(54) METHOD AND SYSTEM FOR DETECTING IMPROPER OPERATION AND COMPUTER-READABLE NON-TRANSITORY STORAGE MEDIUM

(75) Inventors: Shinichi Tsunoo, Sagamihara (JP); Makoto Kayashima, Yamato (JP); Hiroshi Nakagoe, Yokohama (JP); Hiromi Isokawa, Sagamihara (JP); Norio Suzuki, Yokohama (JP); Tomotada Naito, Yokohama (JP)

(73) Assignee: Hitachi, Ltd.

(21) Appl. No.: 13/130,959

(22) PCT Filed: Feb. 18, 2011
(86) PCT No.: PCT/JP2011/053513

§ 371 Date: May 24, 2011

(51) Int. Cl. G06F 15/173

(52) U.S. Cl. 709/224

(57) ABSTRACT

An embodiment of this invention detects an improper operation to a file in a computer of a monitoring target in a computer system including a plurality of computers connected via a network. The monitoring target computer receives a file. The computer receives acquisition source information on the file transmitted from a different computer. The computer refers to information on improper operation requirements to determine whether transmission of the file meets the improper operation requirements or not, based on a combination of the acquisition source of the file indicated by the acquisition source information and a transmission destination of the file and if the improper operation requirements are met, it determines that the transmission of the file is an improper operation.

### TECHNICAL FIELD

This invention relates to a method for detecting an improper operation, a system for detecting an improper operation, and a computer-readable non-transitory storage medium and in particular, relates to detection of an improper operation with high risk of information leakage.

### BACKGROUND ART

To prevent leakage of confidential information in an organization is an important factor in information management in the system. For this reason, systems have been proposed that monitor information leakage from client computers in an organization. For example, PTL 1 discloses an example of a system for detecting a malicious operation or a pseudo malicious operation in client computers within a computer system.

In the technique described in PTL 1, the administrator preliminarily registers patterns defined as malicious operation. The computer (management computer) operated by the administrator can determine whether a user operation is an improper operation or not in accordance with the extent of matching between the contents of the log of user operations in a client computer and the registered patterns of improper operation.

### CITATION LIST

### Patent Literature

[PTL 1]

### SUMMARY OF INVENTION

### Technical Problem

The technique in PTL 1 enables the management computer to detect an improper operation expected (registered) by the administrator. However, in monitoring user operations, the volume of the log of user operations increases to cause a problem that the processing load in the management computer increases.

In the meanwhile, a file may be transferred between client computers. In this regard, it is important for the system to accurately learn the confidentiality of the transferred file (whether the transferred file is confidential information or not). The above-described PTL 1, however, does not disclose accurate detection of an improper operation to a file when a file is transferred between client computers.

### Solution to Problem

An aspect of the present invention is a method for detecting an improper operation to a file in a computer of a monitoring target in a computer system including a plurality of computers connected via a network. A first computer of a monitoring target receives a file. The first computer receives acquisition source information which is transmitted from a second computer and indicates an acquisition source of the file. The first computer receives an operation for transmitting the file. The first computer refers to information on improper operation requirements held in a data storage apparatus to determine whether the transmission of the file meets the improper operation requirements or not, based on a combination of the acquisition source of the file indicated by the acquisition source information and a transmission destination of the file. The first computer determines that the transmission of the file is an improper operation if the improper operation requirements are met.

### Advantageous Effects of Invention

According to an aspect of this invention, in transferring a file between computers in an organization, a file operation with high risk of leakage of confidential information in the organization can be detected more accurately.

### BRIEF DESCRIPTION OF DRAWINGS

FIG. 1 is a diagram schematically illustrating a configuration example of a system for detecting an improper operation in the first embodiment.

FIG. 2 is a diagram schematically illustrating a configuration example of a client computer in the first embodiment.

FIG. 3 is a diagram schematically illustrating a configuration example of an agent program that runs on a client computer in the first embodiment.

FIG. 4 is a diagram illustrating an example of a sequence to be performed among a user's operation, a dialogue operation monitoring module, and a browser monitoring module in receiving a file through a web browser in the first embodiment.

FIG. 5 is a diagram illustrating an example of a sequence to be performed among a user's operation, a dialogue operation monitoring module, a browser monitoring module, and a file operation monitoring module in receiving a file through a web browser in the first embodiment.

FIG. 6 is a diagram illustrating an example of a sequence to be performed among a user's operation, a dialogue operation monitoring module, and a TCP communication monitoring module in receiving a file through a mailer in the first embodiment.

FIG. 7 is a diagram illustrating an example of a sequence to be performed among a user's operation, a file operation monitoring module, and a TCP communication monitoring module in receiving a file by a drag-and-drop operation in a mailer in the first embodiment.

FIG. 8 is a diagram illustrating an example of a sequence to be performed among a user's operation, a dialogue operation monitoring module, and a browser monitoring module in sending a file through a web browser in the first embodiment.

FIG. 9 is a diagram illustrating an example of a sequence to be performed among a user's operation, a dialogue operation monitoring module, and a TCP communication monitoring module in sending a file through a mailer in the first embodiment.

FIG. 10 is a diagram illustrating an example of a sequence to be performed among a user's operation, a file operation monitoring module, and a TCP communication monitoring module in sending a file by a drag-and-drop operation in a mailer in the first embodiment.

FIG. 11 is a diagram illustrating an example of a sequence to be performed by a user's operation and a dialogue operation monitoring module in printing a file in the first embodiment.

FIG. 12A is a diagram illustrating an example of a sequence to be performed by a user's operation and a file operation monitoring module in receiving a file from a file server in the first embodiment.

FIG. 12B is a diagram illustrating an example of a sequence to be performed by a user's operation and a file operation monitoring module in sending file to a removable medium in the first embodiment.

FIG. 13A is a diagram illustrating an example of an incoming mail DB used in an agent in the first embodiment.

FIG. 13B is a diagram illustrating an example of a format of acquisition source information to be added to each file in the first embodiment.

FIG. 14 is a diagram illustrating an example of a flowchart of a browser monitoring module, which is a module in an agent, in the first embodiment.

FIG. 15 is a diagram illustrating an example of an overall flowchart of a dialogue operation monitoring module, which is a module in an agent, in the first embodiment.

FIG. 16 is a diagram illustrating an example of a flowchart of a thread for download/upload through a mailer performed by a dialogue operation monitoring module, which is a module in an agent, in the first embodiment.

FIG. 17 is a diagram illustrating an example of a flowchart of a thread for download/upload through a browser performed by a dialogue operation monitoring module, which is a module in an agent, in the first embodiment.

FIG. 18 is a diagram illustrating an example of a flowchart of a print check thread performed by a dialogue operation monitoring module, which is a module in an agent, in the first embodiment.

FIG. 19 is a diagram illustrating an example of a flowchart of a file operation monitoring module, which is a module in an agent, in the first embodiment.

FIG. 20 is a diagram illustrating an example of a flowchart of a TCP communication monitoring module, which is a module in an agent, in the first embodiment.

FIG. 21 is a diagram illustrating an example of a screen image of a web browser in the first embodiment.

FIG. 22 is a configuration diagram of a system including an improper operation detection system having a meta-information transfer function in the first embodiment.

FIG. 23 is a diagram schematically illustrating a configuration example of a client computer in the first embodiment.

FIG. 24 is a diagram schematically illustrating a configuration example of an agent program in the first embodiment.

FIG. 25A is a diagram exemplifying information in incoming DBs and outgoing DBs in the first embodiment.

FIG. 25B is a diagram exemplifying information in a meta-information DB in the first embodiment.

FIG. 26 is a diagram illustrating a sequence of processing of uploading a file using a browser in the first embodiment.

FIG. 27 is a diagram illustrating a sequence of process processing of attaching a file to a mail to send the mail in the first embodiment.

FIG. 28 is a diagram illustrating a sequence of processing of downloading a file using a browser in the first embodiment.

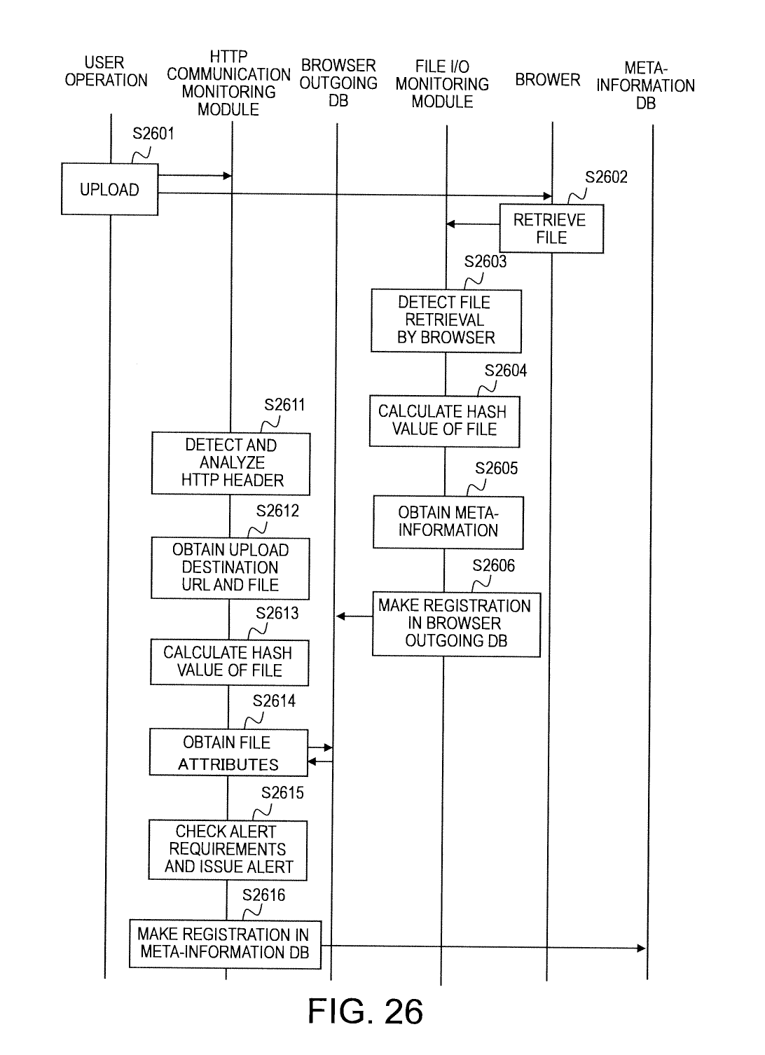

FIG. 26 is a diagram illustrating a sequence of processing of receiving a file using a mailer and saving the received file in the first embodiment.

FIG. 30 is a diagram illustrating a flowchart of a meta-information management module, which is a module in an agent, in the first embodiment.

FIG. 31 is a configuration diagram of a system including an improper operation detection system in the second embodiment.

FIG. 32A is a diagram schematically illustrating a configuration example of a client computer in the second embodiment.

FIG. 32B is a diagram exemplifying information stored in outgoing DBs and incoming DBs in the second embodiment.

FIG. 33 is a diagram schematically illustrating a configuration example of an agent program in the second embodiment.

FIG. 34 is a diagram illustrating a sequence of processing of uploading a file using a browser in the second embodiment.

FIG. 35 is a diagram illustrating a sequence of processing of attaching a file to a mail to send the mail in the second embodiment.

FIG. 36 is a diagram illustrating a sequence of processing of downloading a file using a browser in the second embodiment.

FIG. 37 is a diagram illustrating a sequence of processing of receiving a file using a mailer and saving the received file in the second embodiment.

FIG. 38 is a diagram exemplifying meta-information added to mail data to be obtained by a TCP communication monitoring module in an agent in the second embodiment.

FIG. 39 is a diagram schematically illustrating a configuration example of an agent program in the third embodiment.

FIG. 40 is a diagram illustrating a sequence of processing of uploading a file using a browser in the third embodiment.

FIG. 41 is a diagram illustrating a sequence of processing of attaching a file to a mail to send the mail in the third embodiment.

FIG. 42 is a diagram illustrating a sequence of processing of downloading a file using a browser in the third embodiment.

FIG. 43 is a diagram illustrating a sequence of a process of receiving a file using a mailer and saving the received file in the third embodiment.

FIG. 44 is a flowchart illustrating an outline of processing performed by a meta-information management module in an agent in the third embodiment.

### DESCRIPTION OF EMBODIMENTS

Hereinafter, embodiments of this invention will be described. For clarity of explanation, the following descriptions and accompanying drawings contain omissions and simplifications as appropriate. Throughout the drawings, like components are denoted by like reference signs and their repetitive explanation is omitted for clarity of explanation if not necessary.

In the embodiments, a technique for detecting an improper operation which might lead to leakage of confidential information will be described. The embodiments determine whether a file transmission is an improper operation or not using the combination of the acquisition source and the transmission destination of the file.

The embodiments transfer acquisition source information indicating the acquisition source of the file from an apparatus to another. Transferring acquisition source information in transferring a file from an apparatus to another allows the apparatus which receives the transferred file to learn the exact acquisition source of the file, so that the apparatus can make accurate determination of improper operation to transmit the file.

Hereinafter, some methods of transferring source information from an apparatus to another will be described. The methods are explained by way of the following first embodiment to third embodiment. The transfer of information (such as a file and source information) between apparatuses is transmission and receipt of information between apparatuses. The information transfer includes transmission of information received from a different apparatus to another different apparatus, and further, transmission of information created by a specific apparatus from the specific apparatus to a different apparatus.

### FIRST EMBODIMENT

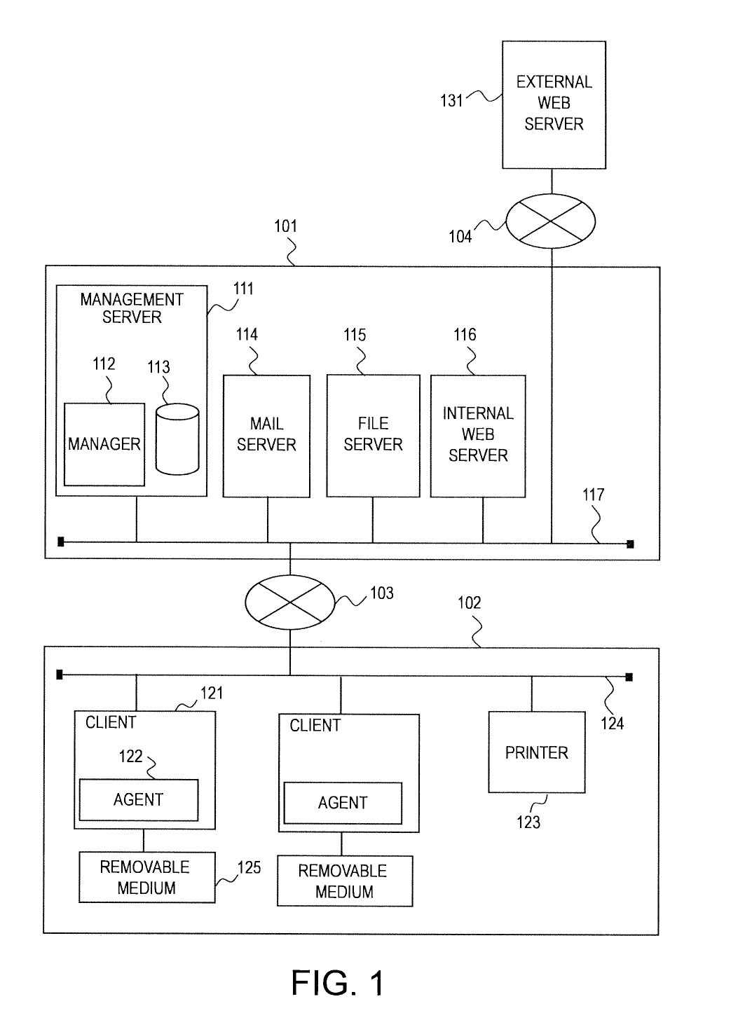

FIG. 1 schematically illustrates an overall configuration of an example of a computer system including an improper operation detection system in this embodiment. In this computer system, a LAN (local area network) 117 in an information center 101 and a LAN 124 in a site 102 are connected with a wide area network 103. The information center 101 is connected to the Internet and is connected to an external web server 131 outside the organization via another wide area network 104.

The information center 101 includes a management server 111, a mail server 114, a file server 115, and an internal web server 116 in the organization. These servers are computers which can communicate with other apparatuses (nodes) via the LAN 117.

In the site 102, a plurality of client computers 121 are provided. FIG. 1 exemplifies two client computers 121 by way of example and one of them is indicated with the reference sign 121. A network printer 123 is further provided in the site 102 for print use. They can communicate with other apparatuses via the LAN 124. In FIG. 1, an improper operation detection system is configured with the management server 111 and the client computers 121.

The management area of the management server 111 is the information center 101 and the site 102. The management server 111 manages the apparatuses provided in the management area as its management targets. Hereinafter, the apparatuses in the management area are the same as the internal apparatuses in the organization for simplicity of explanation. In the management server 111, a manager 112 and a disk (non-volatile data storage device) 113 work. The manager 112 controls the overall improper operation detection system and the disk 113 stores a client management DB (DataBase) which is used by the manager 112 to manage the plurality of client computers (FIG. 1 shows two client computers by way of example).

On each client computer 121, an agent program (hereinafter, also referred to as agent) 122 runs to monitor operations (including user operations) in the client computer 121. The client computers 121 are computers such as personal computers, mobile information terminals, or mobile phones. A user of a client computer 121 performs tasks using the mail server 114, the internal web server 116, the file server 115, and others.

The external web server 131 and removable media 125 like flash memories in the storage media connected to the client computers 121 are equipment out of the management by the management server 111.

The system in this embodiment locates the acquisition source of a file (including a folder for storing a plurality of files) and the transmission destination of the file to detect an improper operation, particularly by a client computer 121, with high probability of information leakage. Specifically, in the system of this embodiment, an agent 122 works on its monitoring target client computer 121 to monitor the operations in the client computer. Accordingly, the computer on which the agent 122 works to monitor its operations (file transmissions) for improperness is the monitoring target computer.

If the acquisition source of a file and the transmission destination of the file belong to the respective predetermined groups, the agent 122 regards the file transmission as an improper operation to be detected. In a preferred configuration described below, if the acquisition source of a file is an apparatus within the management area of the management server 111 and the transmission destination of the file is an apparatus outside the management area, the operation is regarded as an improper operation to be detected. In the following description, a file is a collective of data, which is a target of receiving/transmitting, and a plurality of files may be bundled into a file (for example, a folder).

In this configuration, the group (organization) of acquisition sources and the group (organization) of transmission destinations to be the criterion for improper operation are the same (the both of them are the group of apparatuses forming the management area) but may be different depending on the design. In this configuration, the client computers in the management area are the monitoring target client computers with agents working thereon. An agent may run on a computer different from a client computer (for example, a server) to monitor the operations within the computer for improperness.

A feature of the system of this embodiment is transfer (including share caused by the transfer) of information on file acquisition source within the management area. The acquisition source information is information about the acquisition source of a file and includes infoi illation for identifying the acquisition source of the file. In this embodiment, nodes in the improper operation monitoring system (mostly, client computers 121) can receive information on file acquisition source from another node (mostly, client computers 121).

In the management area, a file may be transmitted and received between client computers 121. For accurate detection of an improper operation to the file, it is necessary that (the agent 122 of) a client computer 121 which transmits the file to the outside of the management area is able to identify the acquisition source of the file.

The system of this embodiment transmits and receives information on file acquisition source between computers so that the client computer which transmits a file to the outside of the management area obtains the acquisition source information on the file to be able to detect an improper operation accurately. In particular, the system can prevent erroneous detection of transmission of a file that is not originally confidential as an improper operation.

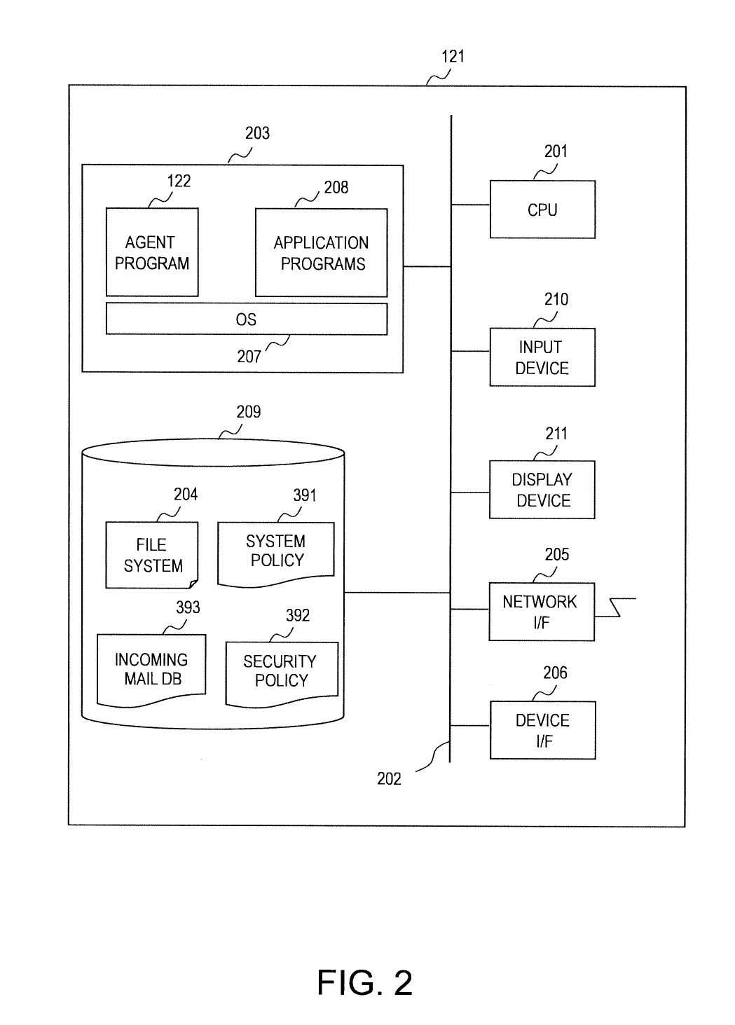

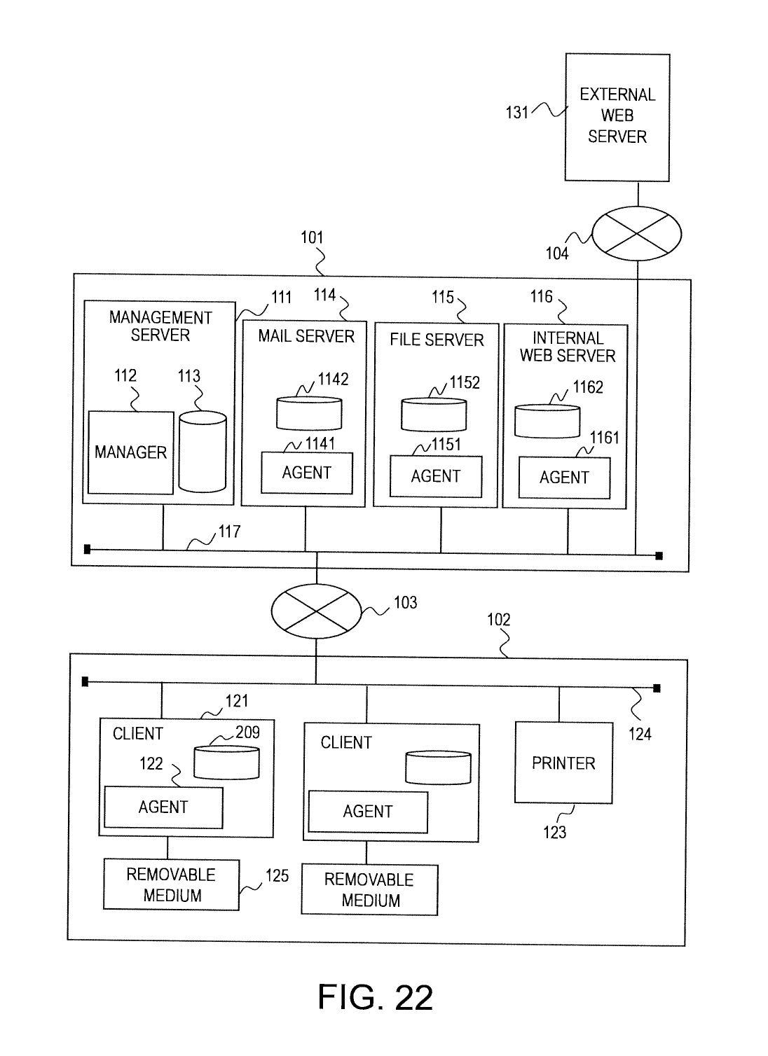

As described above, the agent determines whether a file transmission from a client computer 121 is an improper operation or not in accordance with predetermined rules. Hereinafter, this embodiment will explain some examples of methods of detecting a file receipt and a file transmission responsive to a user's operation and a method of determining an improper operation in transmitting a file, while referring to FIG. 2 to FIG. 21. Thereafter, this embodiment will explain processing including transfer of acquisition source information from a node to another while referring to FIG. 22 to FIG. 30.

FIG. 2 is a block diagram illustrating a configuration example of a client computer 121 in this embodiment. The client computer 121 comprises a CPU (Central Processing Unit) 201 of a processor, a bus 202, a memory 203 of a primary storage apparatus, a network I/F (Interface) 205, a device I/F 206, a disk apparatus 209, an input device 210, and a display device 211.

The device I/F 206 is configured with a USB (Universal Serial Bus) interface, for example. The processor of the client computer 121 may include a plurality of CPUs. These points are the same as in other embodiments.

The basic hardware configurations of the servers 111, 114, 115, and 116, which are the other computers in the management area, are the same as that of the client computer 121. Accordingly, detailed explanations on the configurations of the servers 111, 114, 115, and 116 are omitted.

In the memory 203, an OS (Operating System) 207 is loaded. In addition to the agent 122 for detecting an improper operation, application programs 208 such as a file explorer, a web browser, a mailer, a word processor, and a spreadsheet are stored in the memory 203 to run on the OS 207.

The disk apparatus 209 stores a system policy 391, a security policy 392, an incoming mail DB 393, and a file system 204. The file system 204 includes an area to be managed by the functions of the OS and files stored therein.

FIG. 2 shows programs in the memory 203 for convenience of explanation. Data (including programs) required for processing in the client computer 121 are typically loaded into the memory 203 from the disk apparatus 209 of a non-volatile secondary storage device. The CPU 201 operates in accordance with these programs to work as an operation part for implementing the functions executed by the programs.

The programs are executed by the CPU 201 to perform predetermined processing using a storage device and a communication I/F. Accordingly, the explanations in this embodiment having the subjects of “program” may be replaced with those having the subjects of “CPU 201”. The processing executed by a program are the processing executed by the computer on which the program runs.

In this embodiment (and other embodiments), information to be stored in data storage areas including the memory 203 and the disk apparatus 209 may be expressed in any data structure regardless of the data structure. For example, the system policy 391 and the security policy 392 may each be a single file or a plurality of files. The incoming mail DB 393 typically has a table structure including a plurality of columns but may have any structure. The foregoing explanations about the operations of the computer and the data structures of the information are the same as those in the servers or other embodiments, which will be described later.

A user of a client computer 121 uses any of the application programs 208 to store files attached to mails that are addressed to the user and delivered to the mail server 114, files stored in the file servers 115, and files registered in the internal web server 116 to the local file system 204 in the disk apparatus 209 as local files.

The files stored in the local file system 204 may be sent to the outside of the client computer 121 by any of the application programs 208. For example, a file explorer copies a file to a removable medium connected to the device I/F 206.

The print function of a word processor or a spreadsheet prints a file with the network printer 123. A mailer attaches a file to a created mail body and sends the file to a recipient inside or outside the organization. The web browser uploads a file to the internal web server 116 or the external web server 131.

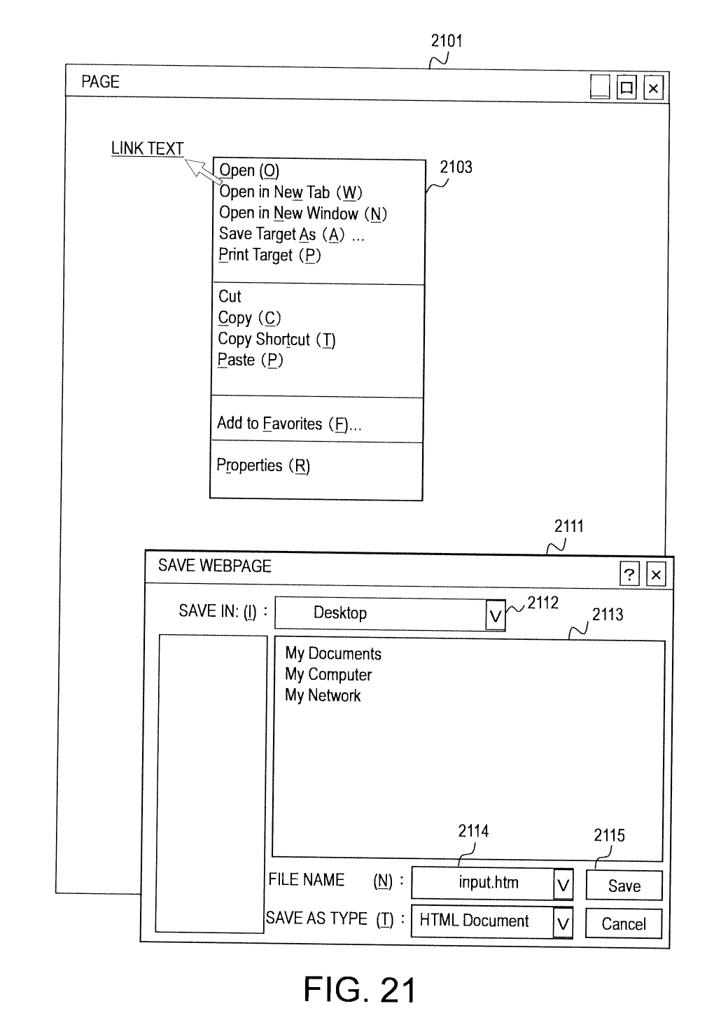

FIG. 21 exemplifies a screen of a web browser. FIG. 21 shows an example of a screen image when a user operates a web browser on a client computer 121 to receive a file. On the web browser screen (the screen of the display device coupled to the client computer 121) 2101, an area called link exists. A click by the user on the link with a pointing device (which is an example of an input device, typically a mouse) causes screen transition or a dialogue box (hereinafter, also referred to as dialogue) to pop up.

If the user puts the mouse cursor over a link text and clicks the left button, the display screen image transitions to the next image (also referred to as page) or processing to display a download dialogue 2111 for downloading the target (file) at the clicked link is performed.

If the user puts the mouse cursor over a link text and clicks the right button, a pop-up window so-called context menu is displayed. In the example of the drawing, the context menu 2103 includes an item “Save Target As . . . ”. Left-clicking this item opens a download dialogue 2111 for downloading the target file.

The download dialogue 2111 includes a field 2112 that indicates the location to save the downloaded file, a field 2113 that shows the choices of folders to save the file, and a field 2114 that indicates the file name to be saved.

The user can rewrite the file name to be saved. The user operates the fields 2112 and 2113 to select a folder to save the file, and changes the file name to be saved in the field 2114 as necessary. By clicking the save button 2115, the user can download the file using the web browser and save the file to an intended folder.

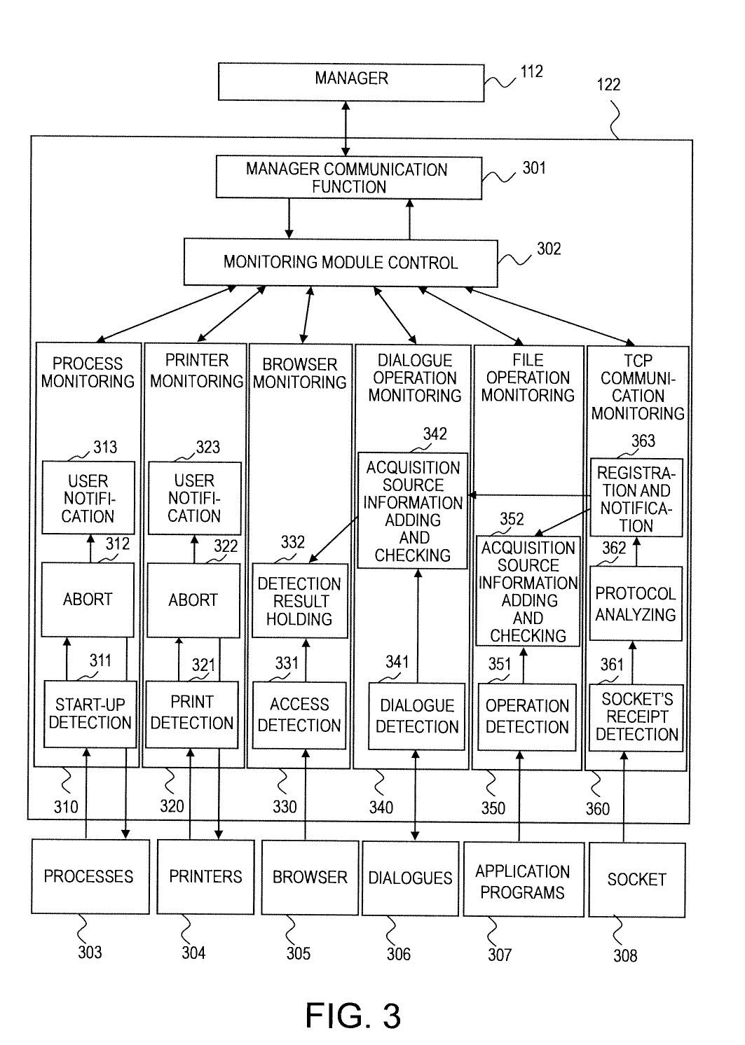

FIG. 3 is a diagram exemplifying a module configuration of the agent 122 running on a client computer 121. The agent 122 includes a manager communication function module 301 for communicating with the manager 112 working on the management server 111 and a monitoring module control module 302 for controlling the monitoring modules which monitor operations by the user in the client computer 121.

The agent 122 further includes a process monitoring module 310, a printer monitoring module 320, a browser monitoring module 330, a dialogue operation monitoring module 340, a file operation monitoring module 350, and a TCP communication monitoring module 360.

The process monitoring module 310 monitors processes 303 of application programs running on the client computer 121. The printer monitoring module 320 monitors output operations (transmission operations) to printers 304 including the network printer 123. The browser monitoring module 330 monitors operations through the web browser 305 by the user.

The dialogue operation monitoring module 340 monitors dialogues 306 which are displayed on the screen of the client computer 121 and are used to select a file for the user to download or upload. The file operation monitoring module 350 monitors operations on the screen of the client computer 121 to application programs 307 by the user using the input device (for example, clicks of buttons and drag-and-drops of objects displayed in application windows).

The TCP communication monitoring module 360 monitors the states of transmitting and receiving data streams by application programs (for example, the mailer) that transmit and receive data via a network using a TCP/IP socket 308 through operations by the user.

The agent 122 has a system policy 391 which is a configuration file (configuration information) for controlling operations of the modules and a security policy 392 which is a configuration file (configuration information) for controlling security. Moreover, it has an incoming mail DB 393 for storing information required by the monitoring modules to configure information related to user operations. The contents and the role of the incoming mail DB 393 will be described later. The security policy 392 includes information on file acquisition source and file transmission destination that is to be criterion for improper operation.

As shown in FIG. 3, the process monitoring module 310 has a start-up detection function 311 for detecting that a process 303 has been requested to start in the client computer 121, an abort function 312 for aborting the start of the process 303 if the process 303 is against the security policy 392, and a user notification function 313 for notifying the user of the start aborted.

The printer monitoring module 320 has a print detection function 321 for detecting that a print using some printer 304 has been requested in the client computer 121, an abort function 322 for aborting the print if the data to be printed is against the security policy 392, and a user notification function 323 for notifying the user of the print aborted.

The browser monitoring module 330 has an access detection function 331 for detecting an access to a web server using the browser 305 in the client computer 121 and a detection result holding function 332 for temporarily holding the URL of the accessed web server, received HTML data, and others.

The dialogue operation monitoring module 340 has a dialogue detection function 341 for detecting that a select file dialogue or a print dialogue is displayed by a user's operation of an application program 208 on the client computer 121 and an acquisition source information adding and checking function 342 for adding information on file acquisition source and checks the added acquisition source information.

In this regard, the operations to display a select file dialogue are an operation to download or upload a file using the web browser 305, an operation to save an attached file from a received mail using the mailer, and an operation to attach a file to an outgoing mail, for example. The operation to display a print dialogue is an operation to select a print function in the word processor or the spreadsheet, for example.

The file operation monitoring module 350 includes an operation detection function 351 and an acquisition source information adding and checking function 352. The operation detection function 351 is to detect a click operation of a mouse button in a window of an application program on the client computer 121 or a drag-and-drop operation of an object displayed in a window. The acquisition source information adding and checking function 352 is to add file acquisition source information to a file operated using a mouse and checks the added acquisition source information.

In this regard, the file operations by clicking of the mouse button are an operation that right-clicks a link displayed on the screen of the web browser 305 to save the object indicated by the link as a file in the displayed menu and an operation that drags and drops a file attached to a received message window of the mailer to copy the file to the desktop, for example.

The TCP communication monitoring module 360 has a socket's receipt detection function 361, a protocol analyzing function 362, and a registration and notification function 363. The socket's receipt detection function 361 detects transmission or receipt of a file via a network by a user's operation of a network application program on the client computer 121. The protocol analyzing function 362 analyzes data transmitted or received through the socket.

If the client computer 121 receives a file through the socket 308, the registration and notification function 363 registers information on the file in the incoming mail DB 393 and notifies the acquisition source information adding and checking functions 342 and 352 of the information on the acquisition source of the file.

The foregoing monitoring modules each have a function to communicate with other monitoring modules or the incoming mail DB 393, a function to send an alert to the manager 112 through the monitoring module control module 302 and the manager communication function module 301, and a function to create an alert or a log of detection results, in accordance with the result of detection.

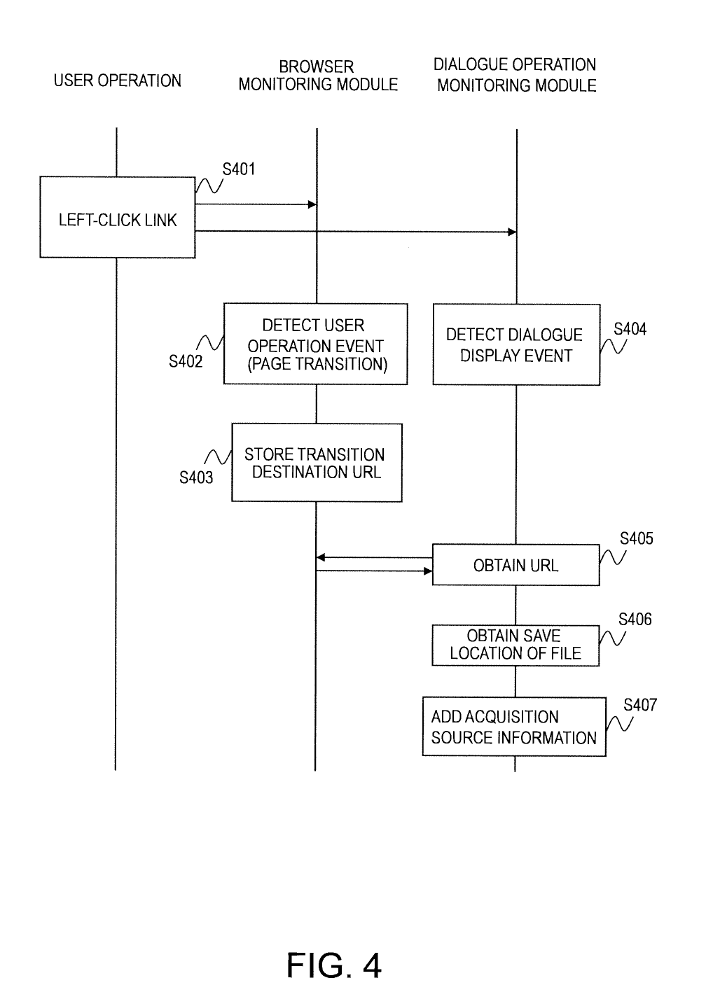

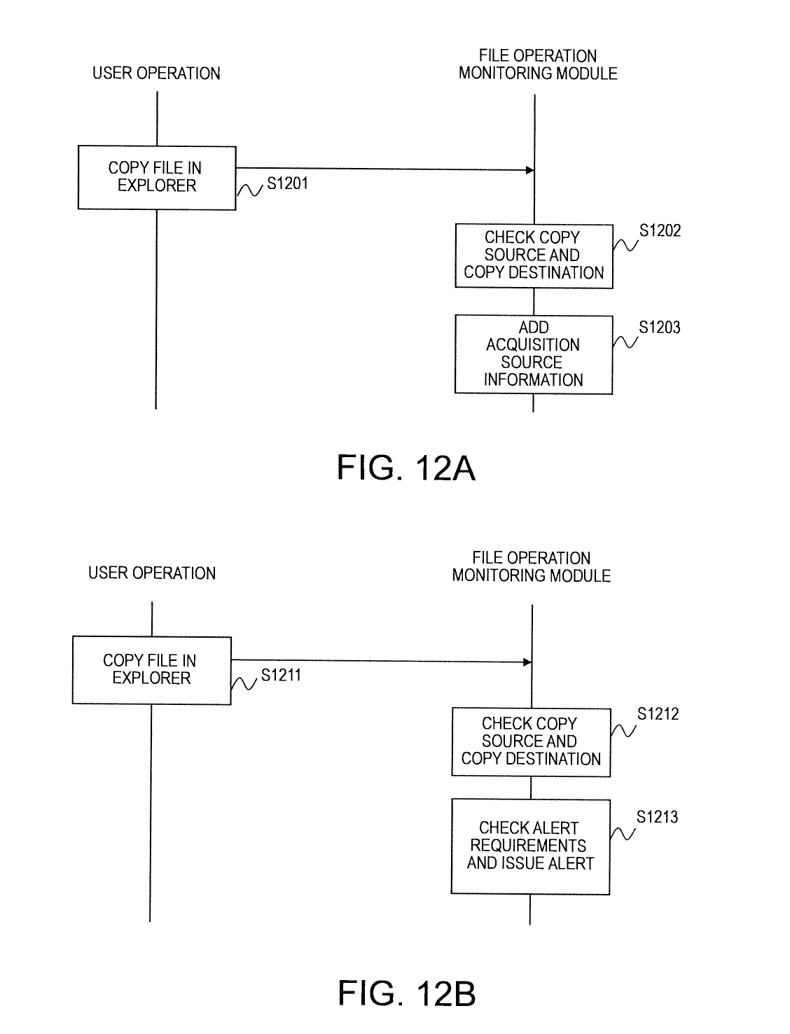

Next, sequences of detecting a user's operation to receive a file to the client computer 121 and adding information on file acquisition source to the received file will be described with reference to FIG. 4 to FIG. 7, and FIG. 12A. Specifically, examples of the following receiving processing will be explained:

(1) Download a file in a web browser;

(2) Receive a mail with a file attached; and

(3) Copy or move a file from a file server to a local file system using a file explorer.

First, “(1) Download a file in a web browser” will be described. FIG. 4 is a sequence diagram exemplifying processing performed by the browser monitoring module 330 and the dialogue operation monitoring module 340 when a user downloads a file through the web browser 305. When the user left-clicks a link displayed by the web browser 305 (S401), a user operation event for page transition occurs in the web browser 305. The browser monitoring module 330 detects the user operation event for page transition (S402).

The browser monitoring module 330 stores the transition destination URL (namely, the URL of the clicked link object) and waits for an information request from the dialogue operation monitoring module 340 (S403).

If the web browser 305 cannot display the object designated by the left click (S401) in-line, the web browser 305 displays a download file dialogue. The dialogue operation monitoring module 340 detects the dialogue display event (S404) upon the display of the download file dialogue. The dialogue operation monitoring module 340 requests the browser monitoring module 330 to supply information on the transition destination URL and then obtains the information on the transition destination URL from the browser monitoring module 330 (S405).

If the save button in the download file dialogue is clicked, the dialogue operation monitoring module 340 obtains a save file name from information displayed in the dialogue (information obtained by operations of the OS 207) and obtains a full path for the information on the save location for the file (S406).

Furthermore, the dialogue operation monitoring module 340 adds acquisition source information indicating the acquisition source to the file (S407). The acquisition source information is meta-information of the file and the dialogue operation monitoring module 340 preferably utilizes a meta-information adding function of the file system. This achieves efficient administration of information on file acquisition source.

For example, if Microsoft's NTFS (New Technology File System) is employed as the local file system 204, “Alternate Data Streams” can be used. If Apple's HFS (Hierarchical File System) is employed, “resource forks” can be used. In this specification, a metadata area added to a file in a file system is referred to as a fork.

The fork is an adjunct-data area belonging to a file. The adjunct-data area can be an operation target in a file system as well as file data. In the adjunct-data area, data is read or written using a function different from a read function or write function for the file data or using the read function or the write function with an argument different than usual.

In copying a file, changing the name of a file, or moving a file within a local file system in a client computer 121, these file systems can add meta-information to the processed file (including the copy file).

The dialogue operation monitoring module 340 obtains acquisition source information on a file from other client computer or creates it by itself. The details of obtaining information on file acquisition source will be described later with reference to FIG. 22 to FIG. 30. The dialogue operation monitoring module 340 adds acquisition source information to the file in both cases where the server included in the transition destination URL obtained in the step 405 is inside and outside the management area. Alternatively, it may add acquisition source information either in the case of an internal web server or an external web server.

The dialogue operation monitoring module 340 refers to the security policy 392 to determine whether the download source web server is an internal server or an external server. The security policy 392 holds information for identifying the servers and the client computers in the management area. The user can preliminarily register the servers and the client computers in the management area in the security policy 392.

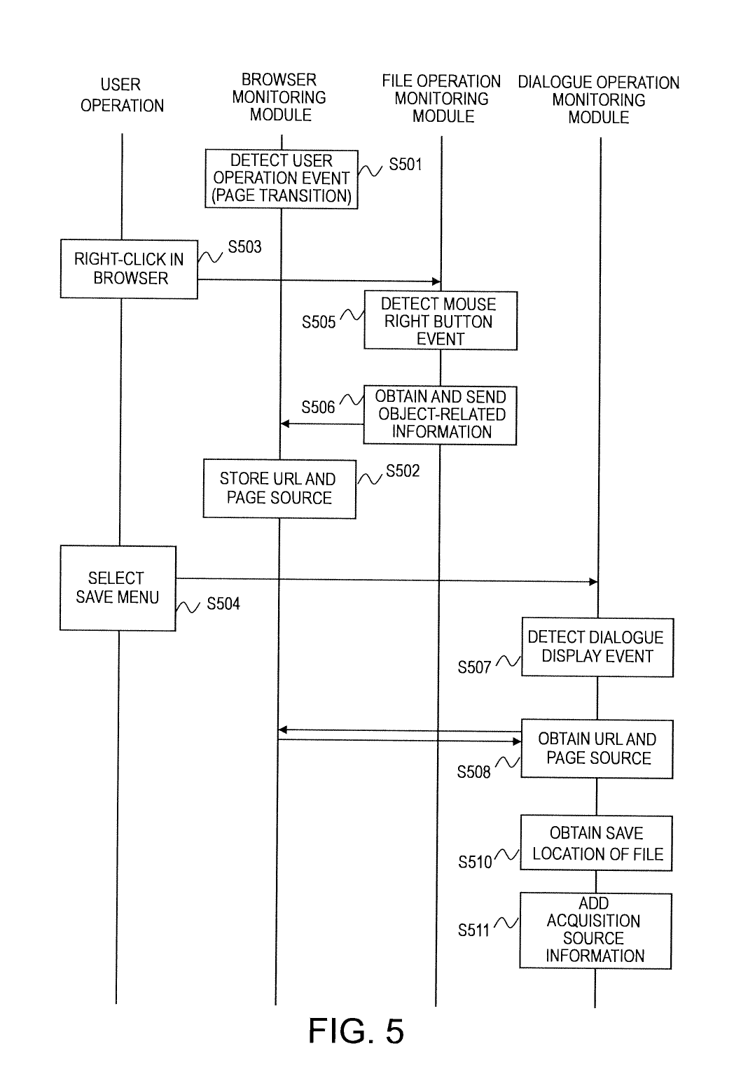

FIG. 5 exemplifies a sequence of processing performed by the browser monitoring module 330, the dialogue operation monitoring module 340, and the file operation monitoring module 350 when a user downloads a file through a web browser.

When the user displays a page in the web browser 305, the browser monitoring module 330 detects a user operation event for page transition (S501). The web browser 305 holds the transition destination URL and the page source, which can be transferred in response to a request from the browser monitoring module 330. If the user performs a right click operation to the link shown in the web browser 305 (S503), a mouse operation event occurs and the file operation monitoring module 350 detects the event (S505).

The file operation monitoring module 350 which detects the occurrence of the mouse operation event stores information on the location where the mouse operation event occurs in the web browser 305 as object-related information and sends it to the browser monitoring module 330 (S506). Every time the web browser 305 displays a page, the browser monitoring module 330 stores the transition destination URL and the source of the page (S502).

If the user selects “Save Target As . . . ” from the context menu displayed by the right click (S504), a save page dialogue is opened. When the dialogue operation monitoring module 340 detects the dialogue display event (S507), it obtains the URL and the page source (page data) of the page on the screen from the browser monitoring module 330 (S508).

The dialogue operation monitoring module 340 further obtains the file path of the save file (S510) and adds acquisition source information to the file (S511). The description on the operations by the dialogue operation monitoring module 340 can apply to the adding of the acquisition source information.

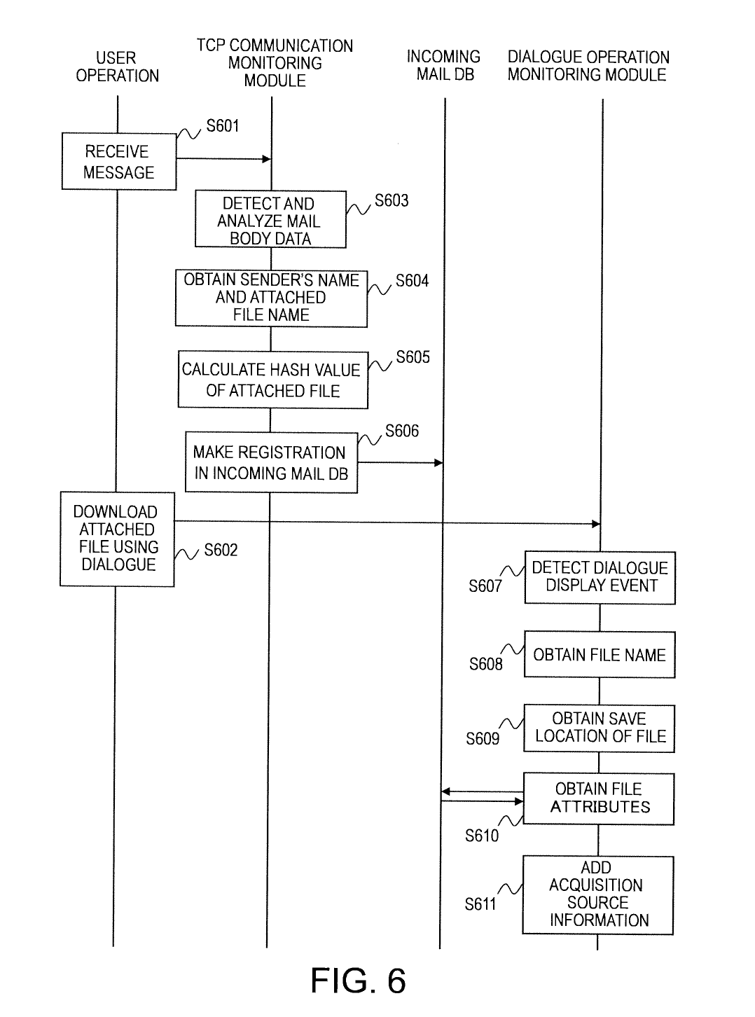

Next, “(2) Receive a mail with a file attached” will be described. FIG. 6 exemplifies a sequence of processing performed by the TCP communication monitoring module 360 and the dialogue operation monitoring module 340 when a user saves a file attached to a mail to the local file system 204 using the mailer.

When the user performs a receive message operation such as a mailer activation operation or a mail display operation (S601), a message is downloaded from the mail server 114 in accordance with a protocol like POP3 (Post Office Protocol version 3) or IMAP4 (Internet Message Access Protocol version 4). The TCP communication monitoring module 360 monitoring the socket 308 in the network driver or the TCP/IP protocol stack analyzes the message data (S603) and obtains the sender's name and the attached-file name in the message (S604).

The TCP communication monitoring module 360 further decodes the data of the attached file encoded in base 64 or others and calculates the hash value (S605). It registers the file name, the hash value, and the sender's name of the attached file in the incoming mail DB 393 (S606).

The user sometimes wants to save an attached file to the local file system 204 while looking at a mail body by the mailer (this operation might be executed not immediate after downloading the mail data but at a considerable time after the downloading).

When the mailer executes an operation to save the attached file using a save file dialogue (S602), the dialogue operation monitoring module 340 detects a dialogue display event (S607), obtains the file name from the information indicated in the dialogue (S608), and obtains the full path of the save location for the file (S609). Furthermore, it searches the incoming mail DB 393 with the file name indicated in the dialogue as a key to obtain the attribution such as the sender's name of the file (S610).

If the attached-file name is a common name, such as “Specification.doc”, the incoming mail DB 393 may contain a plurality of registered records having the same name. In such a case, the dialogue operation monitoring module 340 may calculate the hash value of the file whose file name is obtained at the step 608 and search the incoming mail DB 393 with the hash value as a key to obtain the sender's name of the file.

At step 611, the dialogue operation monitoring module 340 adds acquisition source information to the file. The dialogue operation monitoring module 340 may determine whether to add the acquisition source information or not with reference to the sender of the mail. For example, if the mail sender is another internal user (a different member in the organization), the dialogue operation monitoring module 340 adds the acquisition source information to the file. The other points are the same as in the adding acquisition source information described with reference to FIG. 4.

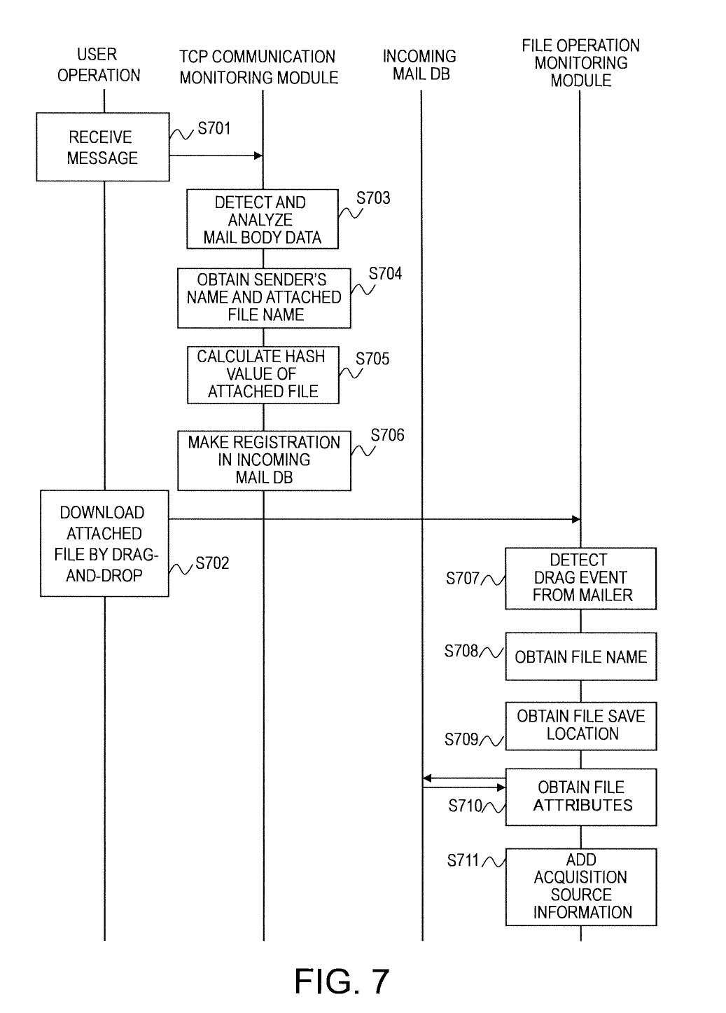

FIG. 7 exemplifies a sequence of processing performed by the TCP communication monitoring module 360 and the file operation monitoring module 350 for a user to save a file attached to a mail to the local file system 204 through the mailer.

The processing from the step 701 to step 706 is the same as in the sequence in FIG. 6 (from the step 601 to the step 606). Operations for the user to save an attached file to the local file system 204 while a mail body is open in the mailer include drag-and-dropping the icon indicating the attached file that is displayed in a window of the mailer to the desktop or the file explorer as well as an operation using a save file dialogue.

If such an operation is performed, the file operation monitoring module 350 detects the drag-and-drop event (S707). Furthermore, the file operation monitoring module 350 monitors the file system for a file create event and obtains the name and the full path of the file created in the local file system 204 (S708 and S709) in response to the drag-and-drop operation by the mouse. Step 710 and step 711 are the same as the step 610 and the step 611, respectively.

Next, “(3) Copy or move a file from a file server to a local file system using a file explorer” will be described. FIG. 12A illustrates a sequence of processing performed by the file operation monitoring module 350 for the user to copy information in the file server 115 to the local file system 204 using the file explorer.

In FIG. 12A, when the user performs a copy file or move file operation using the file explorer (S1201), the file operation monitoring module 350 locates the copy source and the copy destination of the file (S1202). The file operation monitoring module 350 adds acquisition source information to the file (S1203).

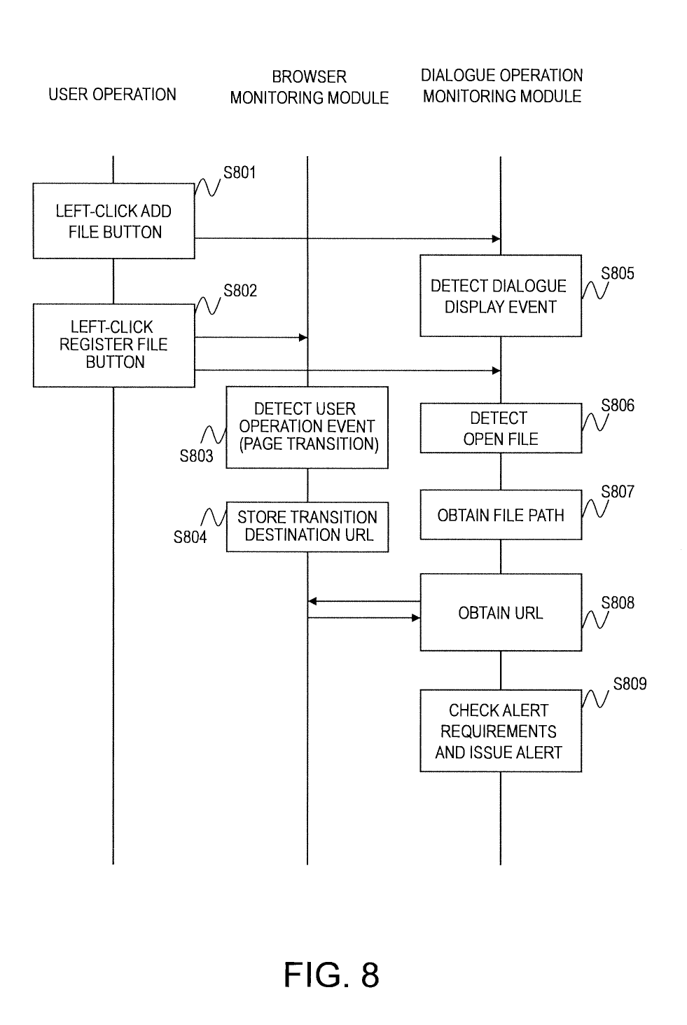

Next, a sequence of detecting a user's operation to transmit a file from the client computer 121 and determining whether the operation is an improper operation or not will be described with reference to FIG. 8 to FIG. 11, and FIG. 12B. Specifically, the following transmission processing will be explained:

(1) Upload a file in a web browser;

(2) Send a mail with a file attached;

(3) Print a file in an application program; and

(4) Store a file to a removable medium.

First, “(1) Upload a file in a web browser” will be described. FIG. 8 exemplifies a sequence of processing performed by the browser monitoring module 330 and the dialogue operation monitoring module 340 when a user uploads a file using the web browser 305.

When a user clicks a button to add an upload target file in a form shown in the web browser 305 for use in uploading a file (S801), the web browser 305 displays a select file dialogue. The dialogue operation monitoring module 340 detects the event that a select file dialogue is displayed, obtains the name of the selected file, and starts monitoring the file open operation (S805).

When the user selects a file using the select file dialogue and clicks the register file button in the above-described form (S802), the form is submitted so that the display screen in the web browser transitions.

The browser monitoring module 330 detects the page transition event (S803) and stores the transition destination URL (S804). If an upload file is submitted at this time, the dialogue operation monitoring module 340 detects an open file for the file (S806) and obtains the file path of the file from the OS 207 (S807).

The dialogue operation monitoring module 340 determines whether alert requirements are met or not. If it determines that the alert requirements are met, it creates an alert to send it to the manager 112 in the management server 111 (S809).

Specifically, the dialogue operation monitoring module 340 obtains the destination URL of the page transition from the browser monitoring module 330. If the web server to which the file is uploaded is an external server, the dialogue operation monitoring module 340 determines that the destination of the file is a check target (a target to determine whether an improper operation is performed or not) and locates the acquisition source of the file by referring to the acquisition source information (for example, the acquisition source information described in the alternate stream) added to the file in the file system 204.

If the upload target file is a file copied from the internal file server 115, a file downloaded from the internal web server 116, or a file attached to a mail from an internal member, the dialogue operation monitoring module 340 performs processing to output an alert (S809).

The processing to output an alert sends an alert to the manager 112 in the management server 111 if specified alert requirements are met. The alert requirements are specified in the security policy 392.

In this processing example, the alert requirements are specified to issue an alert if the upload destination server for a file is an apparatus outside the management area (a check target apparatus) like the external web server 131 and the acquisition source of the upload target file is inside the management area.

For example, if the web server that uploads a file is the external web server 131, the web server 131 is a check target which is different from a management target of the management server 111. If a file is transmitted to a check target, the file is checked whether it is a management target file or not. The management target file of the management server 111 is a file whose acquisition source is a management target.

The management target file is a file whose acquisition source is any one of the internal file server 115, the internal web server 116, and internal users. In this way, if the file acquisition source is a management target of the management server 111, the file transmitted from the client computer 121 is determined to be information transmitted by an improper operation. As a result, an alert indicating that requirements for an improper operation (alert requirements) are met (detection of an improper operation) is created and transmitted to the management server 111.

In such a case, the management server 111 determines that an improper operation with high risk of information leakage is detected and administrates the information accompanied by the improper operation as information to be processed with an alert. Consequently, the administrator can take measures to prevent information leakage based on the alerts gathered by the management server 111.

As described above, it is preferable that the agent 122 send an alert to the manager 112, but the agent may create an alert and stores it in the disk apparatus 209 as log data. The administrator obtains the log information at predetermined intervals to check for an improper operation. In this specification, the alert includes log information to indicate (operations determined to be) improper operations.

If the agent 122 determines that a file transmission is an improper operation, it may prohibit the file transmission together with issuance of an alert or instead of issuance of an alert. After aborting the file transmission, the agent 122 displays the abort on the display device 211.

As described above, information defining the check target and information defining the management target file to be criteria for improper operation are stored in the security policy 392. Information for identifying management target apparatuses can teach check targets. In similar, information for identifying management target apparatuses can teach management target files.

In the foregoing example, the range of the file acquisition source which should be the targets for improper operation (the range of management target files) and the range of the file transmission destination which should be the targets for improper operation (the range of check targets) are specified with the same range (the range configured with the management target apparatuses) (, which means that an improper operation is determined depending on whether the target and destination each is located inside or outside an organization). The administrator may separately define the range of the file acquisition source (acquisition sources) and the range of the file transmission destination (file transmission destinations) to be criterion for improper operation. The above description about determination of improper operation in file transmission can apply to other embodiments.

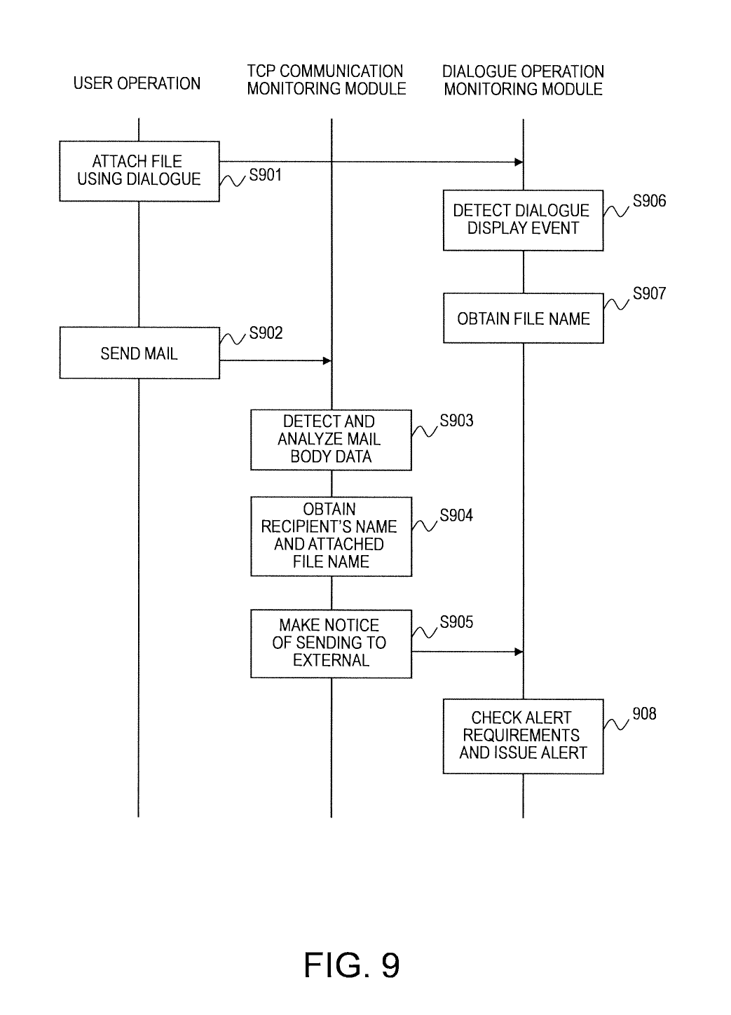

Next, “(2) Send a mail with a file attached” will be described. FIG. 9 exemplifies a sequence of processing performed by the TCP communication monitoring module 360 and the dialogue operation monitoring module 340 when a user sends a mail with a file attached using the mailer.

When the user performs a file attachment operation using a select file dialogue during preparation of an outgoing mail (S901), the dialogue operation monitoring module 340 detects the display event of a select file dialogue (S906), obtains the name and the full path of the selected file (S907), and waits for sending of the mail.

When the user then performs a send mail operation in the mailer (S902), the TCP communication monitoring module 360 analyzes the data to be transmitted using the SMTP (Simple Mail Transfer Protocol) (S903) to obtain the transmission destination and the attached-file name (S904).

If the outgoing mail includes an attached file and the transmission destination thereof is the outside of the organization (outside the management area), the TCP communication monitoring module 360 notifies the dialogue operation monitoring module 340 in a stand-by state that a mail is transmitted to an external destination (S905). The dialogue operation monitoring module 340 refers to the meta-information added to the file to locate the acquisition source of the transmitted file, and if the transmitted file is a management target, it issues an alert (S908).

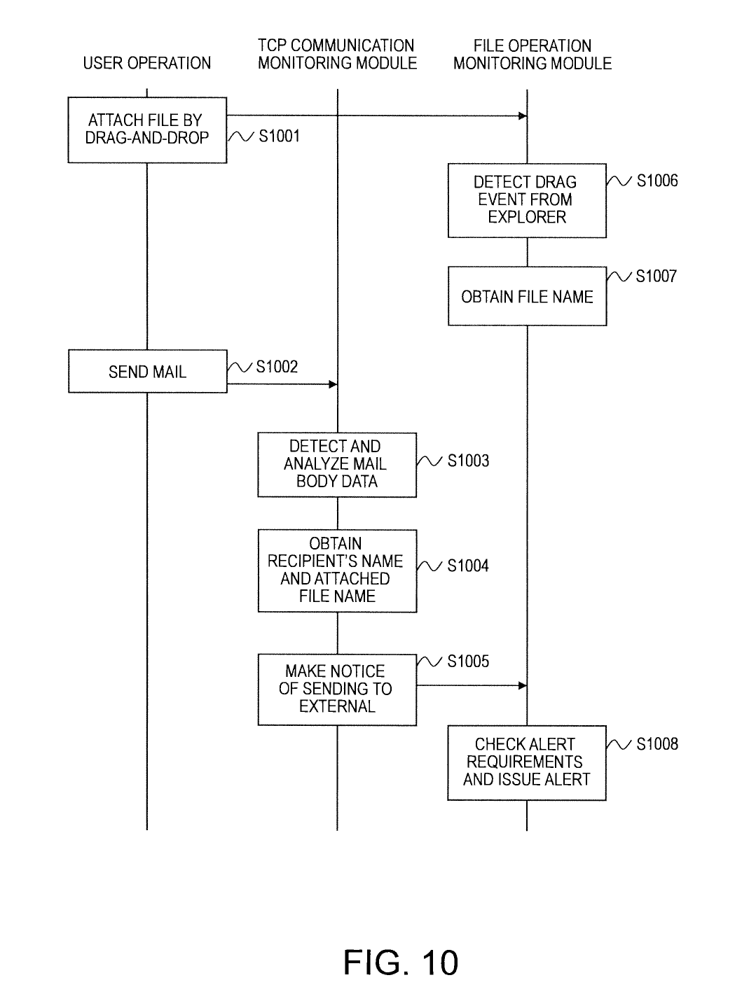

FIG. 10 exemplifies a sequence of processing performed by the TCP communication monitoring module 360 and the file operation monitoring module 350 when a user sends a mail with a file attached using the mailer.

When the user performs a file attachment operation using a drag-and-drop operation during preparation of an outgoing mail (S1001), the file operation monitoring module 350 detects that a file is dragged-and-dropped from the file explorer or the desktop to a window of the mailer (S1006), obtains the name and the full path of the selected file (S1007), and waits for sending of the mail.

When the user then performs a send mail operation in the mailer (S1002), the TCP communication monitoring module 360 analyzes the data to be transmitted using the SMTP (S1003) to obtain the transmission destination and the attached-file name (S1004).

If the outgoing mail includes an attached file and the transmission destination thereof is outside of the organization (outside the management area), the TCP communication monitoring module 360 notifies the dialogue operation monitoring module 340 in a stand-by state that a mail is transmitted to an extei nal destination (a check target) (S1005).

The file operation monitoring module 350 refers to the acquisition source information which is added to the file in the file system (for example, described in the alternate stream) to locate the acquisition source of the transmitted file, and if the transmitted file is a management target, it issues an alert (S1008).

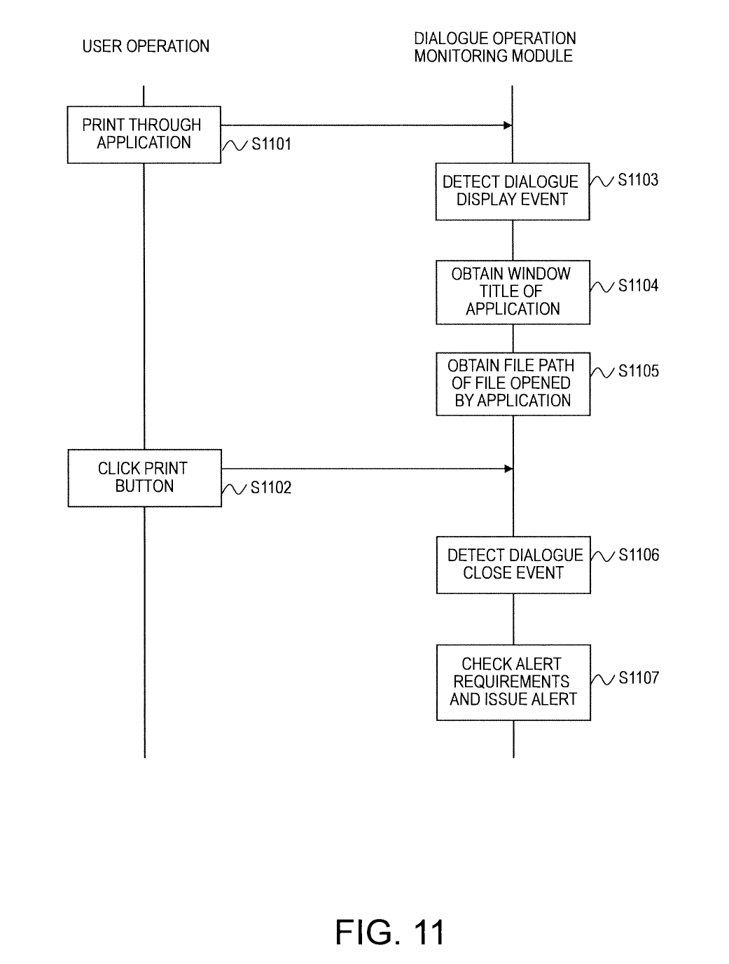

Next, “(3) Print a file in an application program” will be described. FIG. 11 exemplifies a sequence of processing performed by the dialogue operation monitoring module 340 when a user performs a print operation using an application program.

When the user performs a print operation using an application program (S1101), the dialogue operation monitoring module 340 detects a display event of a print dialogue (S1103) and obtains the window title of the application program that executes the print (S1104). Through this operation, the dialogue operation monitoring module 340 obtains the full path of the file opened to be printed by the application program (S1105).

When the user then clicks the print button in the print dialogue (S1102), the dialogue operation monitoring module 340 detects that the dialogue is closed (S1106), refers to the acquisition source information added to the file in the file system 204 to locate the acquisition source of the printed file, and if the printed file is a management target, it issues an alert (S1107).

Next, “(4) Store a file to a removable medium” will be described. Specifically, an example of copying a file to a removable medium 125 will be described with reference to FIG. 12B. The operations of the file operation monitoring module 350 will be described. FIG. 12B exemplifies processing performed by the file operation monitoring module 350 when a user copies a file into a removable medium 125 using the file explorer.

In FIG. 12B, when the user performs a copy file or move file operation using the file explorer (S1211), the file operation monitoring module 350 locates the copy source and the copy destination of the file (S1212).

If the copy source is within a local file system 204 in a client computer 121 and the copy destination is the removable medium 125 connected to the own client computer 121, the file operation monitoring module 350 refers to the acquisition source information added to the operation target file to locate its acquisition source. The file operation monitoring module 350 refers to the security policy 392, and if the operation target file is a management target, it issues an alert (S1213).

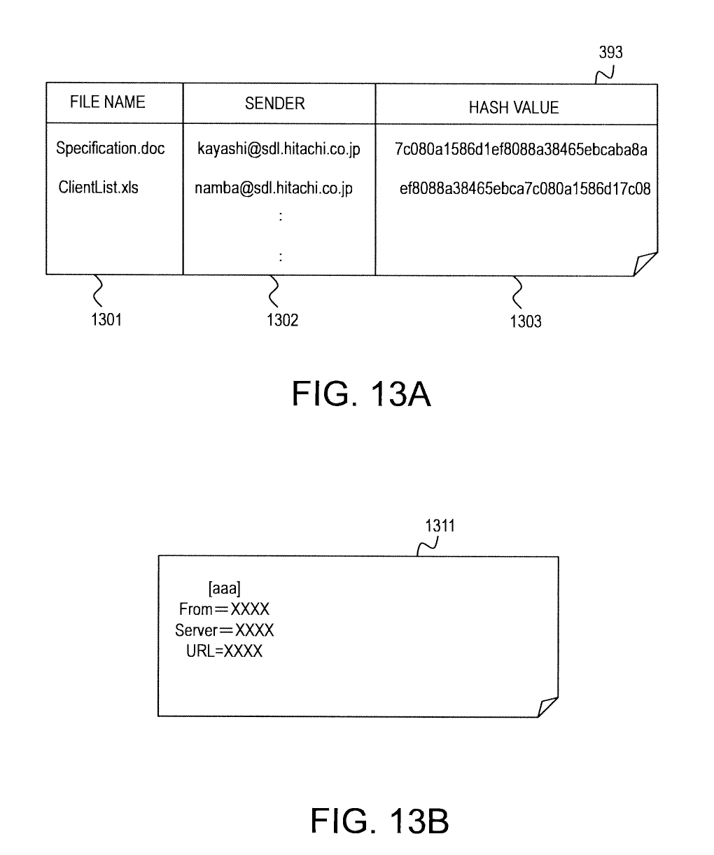

Hereinafter, the incoming mail DB 393 and the acquisition source information will be described with reference to FIG. 13A and FIG. 13B. FIG. 13A shows an example of the incoming mail DB 393 to be used to store information on received mails and FIG. 13B shows an example of the format of meta-information (acquisition source information) 1311 to be added to a file stored in the local file system 204. In the file system 204, the fork of a file (for example, an alternate stream) can store the acquisition source information as described above.

The incoming mail DB 393 has a field 1301 for storing file names, a field 1302 for storing senders' names of mails, and a field 1303 for storing the hash values of the files written in the field 1301.

As described in the explanation on FIG. 5, the information 1311 indicating an acquisition source can be provided with data in the INI file format using the “Alternate Data Stream” in the case of Microsoft's NTFS. For a file obtained from the mail server 114, the mail address of the sender is written in the line of “From”.

For a file obtained from the file server 115, the server name or the IP address of the file server is written in the line of “Server”. For a file obtained from the internal web server 116, the URL indicating the obtained file is written. Unused lines may be deleted or the spaces after equal signs thereof may be kept blank.

In this embodiment, the contents of the acquisition source information 1311 can be sent to the management server 111 in an alert. If meta-information (the acquisition source information 1311 in FIG. 13B) includes the time received by the client computer 121, the alert can contain the acquisition date and time of the transmitted information in addition to the acquisition source.

To provide such an alert, the incoming mail DB 393 may further have a time information field for storing the received times of mails including an attached file. For example, the TCP communication monitoring module 360 records the receipt time written in the mail header in the time information field at the steps 606 and 706, obtains the recorded time in the time information field at the steps 610 and 710, and writes the time information in the meta-information of the file (in this example, the acquisition source information 1311).

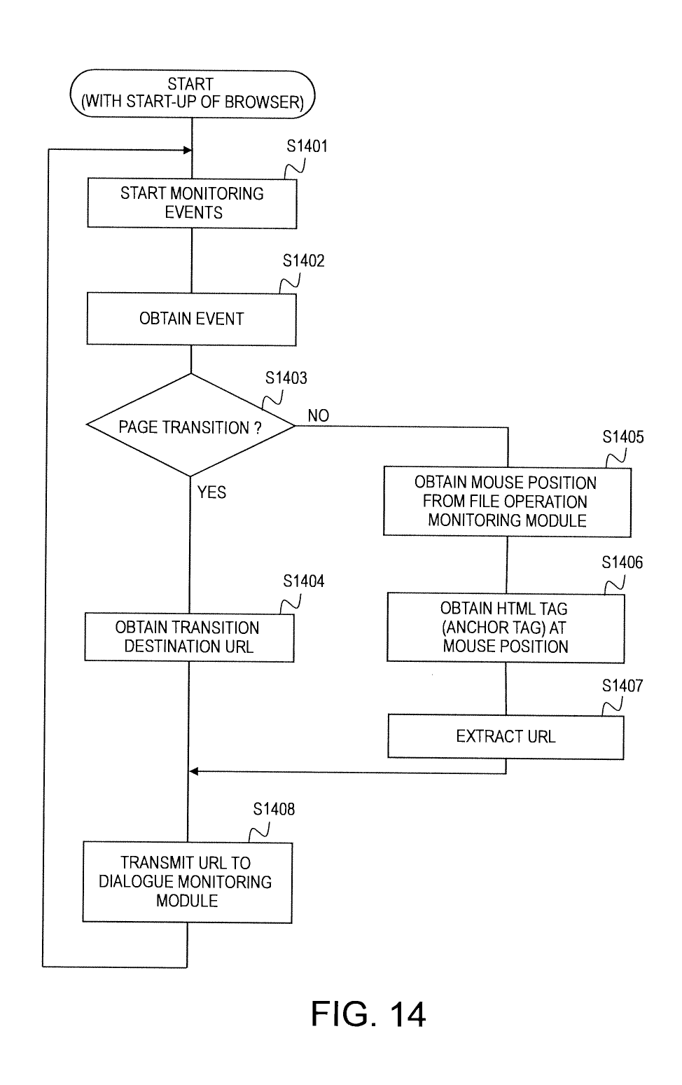

Hereinafter, with reference to FIG. 14, operations of the browser monitoring module 330 will be described. FIG. 14 is an example of a flowchart illustrating an outline of processing performed by the browser monitoring module 330. The browser monitoring module 330 is activated when the web browser is started. It starts monitoring user operations to the web browser that have been described with reference to FIG. 4, FIG. 5, and FIG. 8 (S1401) to enter the loop of checking whether an event occurs (S1402).

Upon detection of occurrence of an event, the browser monitoring module 330 checks whether the user's left click causes page transition (S1403). If the user's left click causes page transition (YES at S1403), the browser monitoring module 330 obtains the transition destination URL (S1404) and then transmits the URL to the dialogue operation monitoring module 340 (S1408).

If the page does not transition (NO at S1403), the browser monitoring module 330 obtains the coordinate information on the browser about the mouse event from the file operation monitoring module 350 (S1405). The browser monitoring module 330 obtains the anchor tag of the HTML under the mouse cursor (S1406) to extract the URL selected by the mouse cursor (S1407). The browser monitoring module 330 transmits the URL to the dialogue operation monitoring module 340 (S1408).

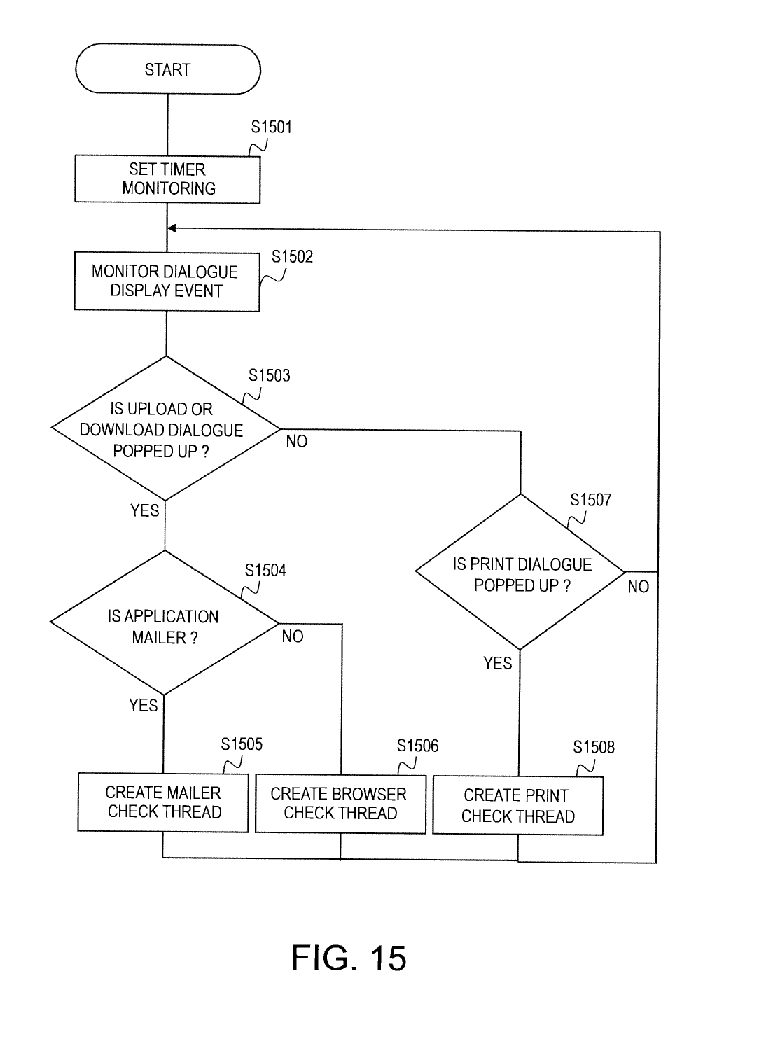

Hereinafter, with reference to FIG. 15 to FIG. 18, operations of the dialogue operation monitoring module 340 will be described. FIG. 15 is an example of a flowchart illustrating an outline of processing performed by the dialogue operation monitoring module 340.

The dialogue operation monitoring module 340 is activated when a user logs on the client computer 121. The dialogue operation monitoring module 340 monitors the file operations using dialogues described with reference to FIG. 4, FIG. 5, FIG. 6, FIG. 8, FIG. 9, and FIG. 11. For example, after setting up the timer monitoring (S1501), it monitors events that display dialogues (S1502).

Upon occurrence of such an event, the dialogue operation monitoring module 340 checks whether either an upload dialogue or a download dialogue is displayed or not (S1503), and if either dialogue is displayed, it identifies the kind of the application program that displays the dialogue (S1504).

If the application program is a mailer, it creates a mailer check thread (S1505); if a web browser, it creates a web browser check thread (S1506).

At the step 1503, if the displayed dialogue is neither an upload dialogue nor a download dialogue, the dialogue operation monitoring module 340 checks whether the displayed dialogue is a print dialogue or not (S1507). If the displayed dialogue is a print dialogue, the dialogue operation monitoring module 340 creates a print check thread (S1508). After any one of the steps of creating a thread, the dialogue operation monitoring module 340 returns to the step of monitoring events that display dialogues (S1502).

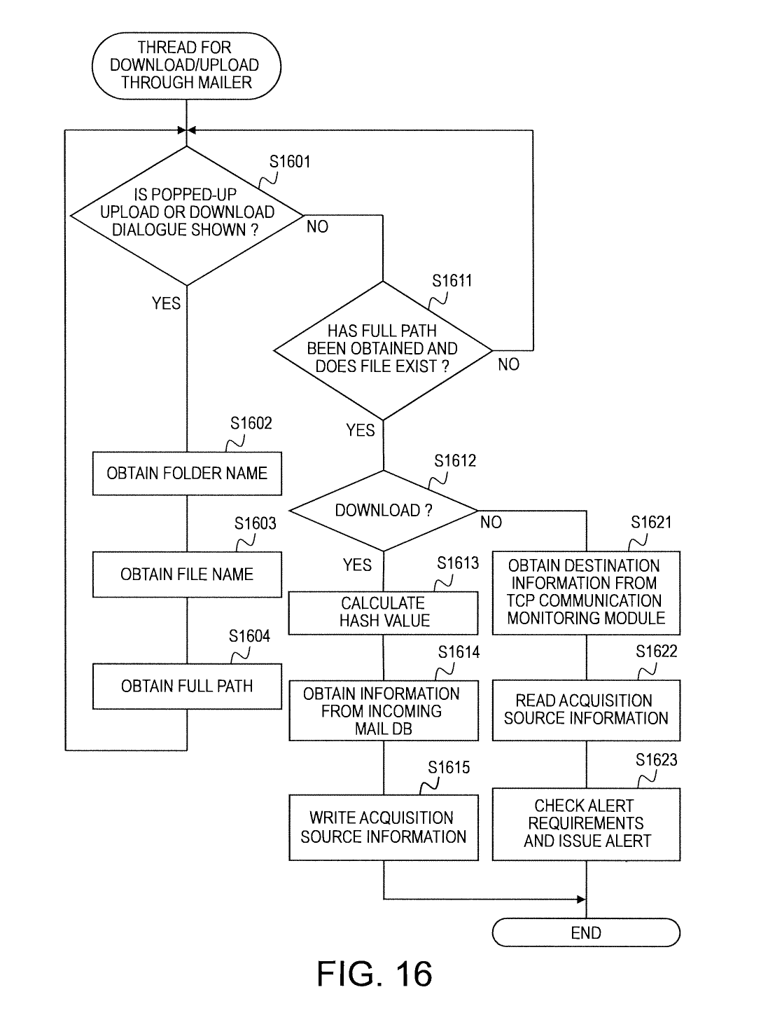

FIG. 16 is an example of a flowchart illustrating an outline of the step of creating a mailer check thread (S1505) in the processing performed by the dialogue operation monitoring module 340. In this thread, the dialogue operation monitoring module 340 checks whether either an upload dialogue or a download dialogue is on the screen (S1601).

If either dialogue is shown on the screen, the dialogue operation monitoring module 340 obtains the folder name (S1602) and the file name (S1603) from the text indicated in the dialogue. The dialogue operation monitoring module 340 configures the full path of the upload target file or the download target file (S1604) and returns to the step 1601. Thereafter, if the dialogue is hidden through the user's operation such as a click of the save button in the dialogue, the dialogue operation monitoring module 340 performs the processing at step 1611 and the subsequent steps.

First, the dialogue operation monitoring module 340 checks whether the full path has been obtained at the step 1604 or not, and further, checks whether a file designated by the full path exists or not (S1611). If such a file exists, the dialogue operation monitoring module 340 performs the step 1612 and the subsequent steps, and if such a file does not exist, it returns to the step 1601.

If the file exists, the dialogue operation monitoring module 340 first checks whether a download dialogue is displayed or not (S1612), and if a download dialogue is displayed, it calculates the hash value of the file designated by the step 1604 (S1613).

The dialogue operation monitoring module 340 searches the information which the TCP communication monitoring module 360 has registered in the incoming mail DB 393 (S1614) as illustrated in FIG. 6 and FIG. 7, and if the registered information meets predetermined requirements like in the case where the acquisition source is another internal user, it adds acquisition source information to the file designated by the full path obtained at the step 1604 (S1615).

If the displayed dialogue is an upload dialogue, the dialogue operation monitoring module 340 receives information on the transmission destination from the TCP communication monitoring module 360 as illustrated in FIG. 9 and FIG. 10 (S1621). If the file indicated in the upload dialogue is sent with a mail as an attachment, the dialogue operation monitoring module 340 reads the acquisition source information on the file designated at the step 1604 (S1622). The dialogue operation monitoring module 340 checks the alert requirements and creates an alert as necessary to send it to the management server 111 (S1623).

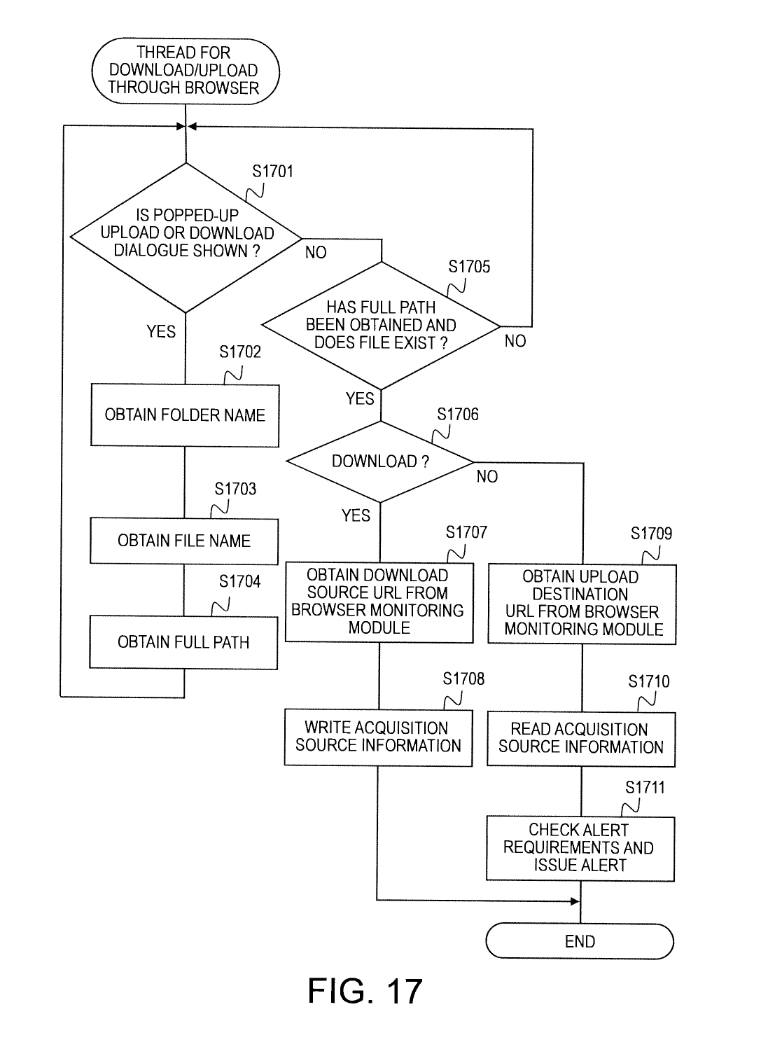

FIG. 17 is an example of a flowchart illustrating an outline of the step 1506 of creating a web browser check thread in the processing performed by the dialogue operation monitoring module 340. In this thread, the dialogue operation monitoring module 340 checks whether either an upload dialogue or a download dialogue is on the screen (S1701).

If either dialogue is shown on the screen, the dialogue operation monitoring module 340 obtains the folder name (S1702) and the file name (S1703) from the text indicated in the dialogue. The dialogue operation monitoring module 340 configures the full path of the upload target file or the download target file (S1704) and returns to the step 1701. Thereafter, if the dialogue is hidden through the user's operation (such as a click of the save button in the dialogue), the dialogue operation monitoring module 340 performs the processing at step 1705 and the subsequent steps.

First, the dialogue operation monitoring module 340 checks whether the full path has been obtained at the step 1704 or not, and further, checks whether a file designated by the full path exists or not (S1705). If such a file exists, the dialogue operation monitoring module 340 performs the step 1706 and the subsequent steps, and if such a file does not exist, it returns to the step 1701.

If the file exists, the dialogue operation monitoring module 340 first checks whether the dialogue in the display is a download dialogue or not (S1706), and if it is a download dialogue, it obtains the download source information held by the browser monitoring module 330 as illustrated in FIG. 4 and FIG. 5 (S1707) and writes the acquisition source information to the file designated by the full path obtained at the step 1704 (S1708).

If the displayed dialogue is an upload dialogue, the dialogue operation monitoring module 340 obtains upload destination information held by the browser monitoring module 330 from the browser monitoring module 330 as illustrated in FIG. 8 (S1709). If the file indicated in the upload dialogue is sent, the dialogue operation monitoring module 340 reads the acquisition source information on the file designated by the full path obtained at step 1704 (S1710). It checks whether the acquisition source information meets the alert requirements, creates an alert as necessary, and sends it to the management server 111 (S1711).

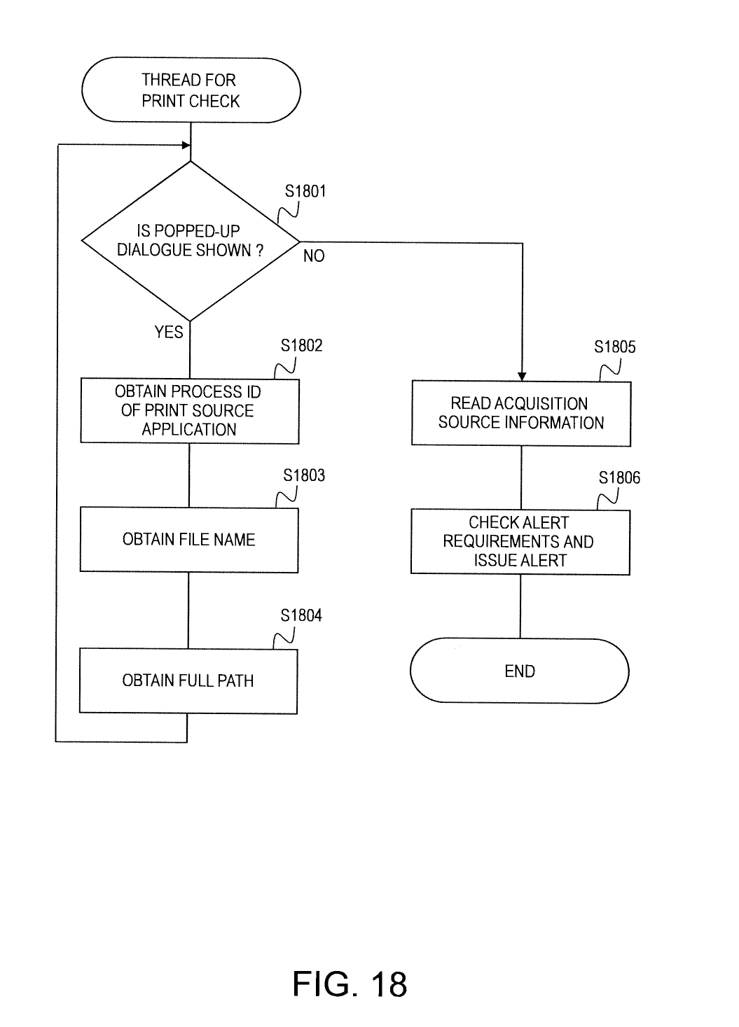

FIG. 18 is an example of a flowchart illustrating an outline of the step 1508 of creating a print check thread in the processing performed by the dialogue operation monitoring module 340. In this thread, the dialogue operation monitoring module 340 checks whether a print dialogue is on the screen or not (S1801).

If the dialogue is shown on the screen, the dialogue operation monitoring module 340 obtains the process ID of the print source application program (S1802) and the file name from a file list opened by the application program identified by the process ID (S1803). The dialogue operation monitoring module 340 configures the full path of the print target file (S1804) and returns to the step 1801.

Thereafter, if the dialogue is hidden through the user's operation (such as a click of the print button in the dialogue), the dialogue operation monitoring module 340 reads the acquisition source information on the print target file (S1805), checks the alert requirements, creates an alert as necessary, and sends the alert to the management server 111 (S1806).

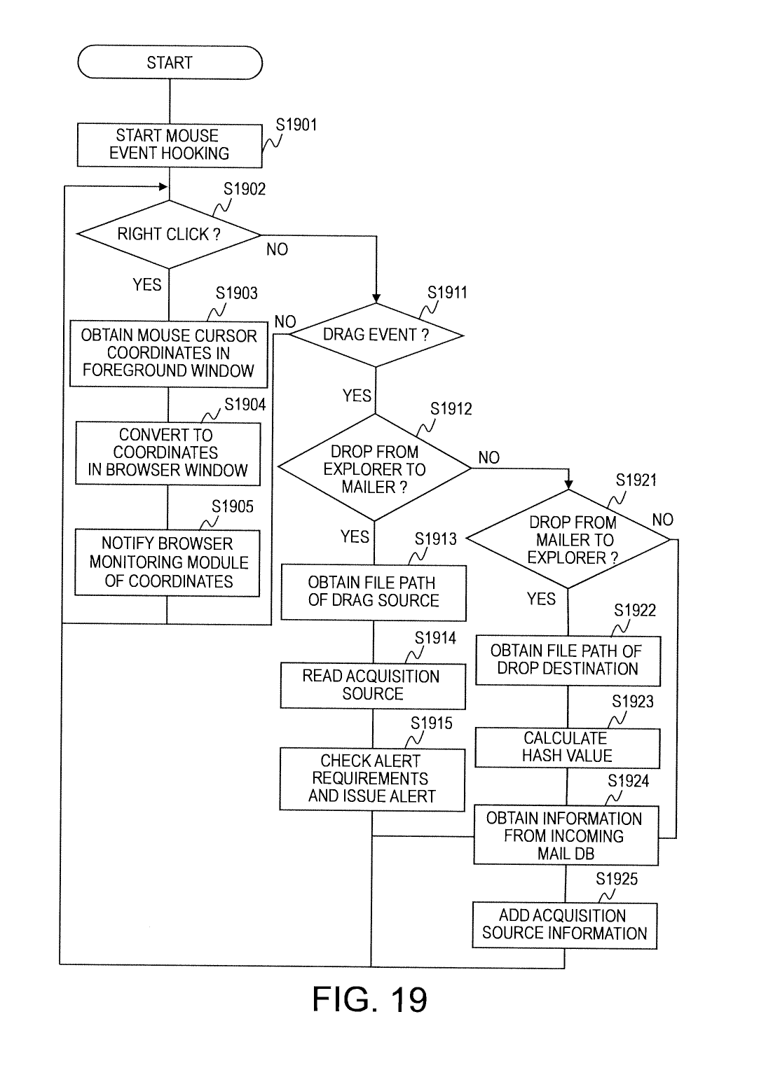

Next, with reference to FIG. 19, operations of the file operation monitoring module 350 will be described. FIG. 19 is an example of a flowchart illustrating an outline of processing performed by the file operation monitoring module 350.

The file operation monitoring module 350 is activated when a user logs on the client computer 121. Upon the start of hooking mouse events (S1901), it monitors file operations using a mouse which have been described with reference to FIG. 5, FIG. 7, and FIG. 10. When the file operation monitoring module 350 detects an event, it determines whether the detected mouse operation event is a right click or not (S1902).

In the case of a right click, the file operation monitoring module 350 obtains the mouse cursor coordinates in the foreground window (S1903), converts it to browser window coordinates (S1904), notifies the browser monitoring module 330 of the obtained coordinates at the step 1904 (S1905), and returns to the monitoring of events.

If the file operation monitoring module 350 determines that the mouse operation event is not a right click at the step 1902, it determines whether the event is a drag event or not (S1911). If it is not a drag event, the file operation monitoring module 350 returns to the monitoring of events. If it is a drag event, the file operation monitoring module 350 detects a drop event for the dragged object and determines whether the file dragged on the file explorer is dropped on the mailer or not (S1912).

If the determination at the step 1912 is NO, the file operation monitoring module 350 proceeds to step 1921, which will be described later. If the determination at the step 1912 is YES, the file operation monitoring module 350 obtains the file path of the drag source (S1913), reads the acquisition source information on the file designated by the full path obtained at the step 1913 (S1914), and sends an alert to the management server 111 as necessary after checking the alert requirements (S1915).

At the step 1912, if the object is not dropped on the mailer, the file operation monitoring module 350 determines whether, in the drag-and-drop event, the object is dragged on the mailer and dropped on the file explorer or not (S1921).

If the determination at the step 1921 is NO, the file operation monitoring module 350 returns to the monitoring of events. If the determination at the step 1921 is YES, the file operation monitoring module 350 obtains the file path of the drop destination of the file attached to a mail (S1922).

Next, the file operation monitoring module 350 calculates the hash value of the file whose full path is obtained at the step 1922 (S1923) and searches the information registered in the incoming mail DB 393 (S1924). The file operation monitoring module 350 writes acquisition source information to the fork (for example, the alternate stream) of the file designated by the full path obtained at the step 1922 (S1915).

It should be noted that the operations of the file operation monitoring module 350 for the sequences illustrated in FIG. 12A and FIG. 12B may be the operations according to the steps 1922 and step 1925 in the case where the drag source is the file server 115 and the drop destination is the local file system 204 or the operations according to the steps 1913 and step 1915 in the case where the drag source is the local file system 204 and the drop destination is the removable medium 125.

If the drag source is the file server 115 and the drop destination is the removable medium 125, the file operation monitoring module 350 can perform an operation according to step 1915.

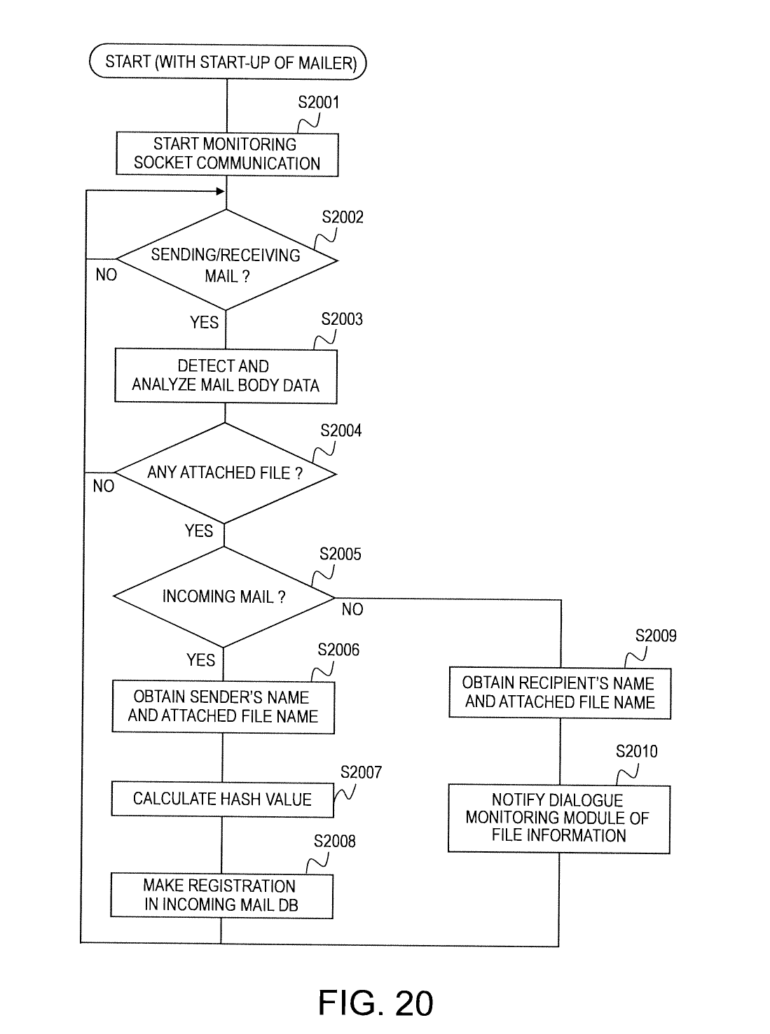

Next, with reference to FIG. 20, the operations of the TCP communication monitoring module 360 will be described. FIG. 20 is an example of a flowchart illustrating an outline of processing performed by the TCP communication monitoring module 360.

The TCP communication monitoring module 360 is activated when a user logs on the client computer 121, and monitors data in communication using protocols of SMTP, POP3, and IMAP4. The TCP communication monitoring module 360 starts monitoring socket communication (S2001) and determines whether transmitted or received data is sent by any one of the above-mentioned protocols or not (S2002). If the result of the determination at the step 2002 is NO, the TCP communication monitoring module 360 returns to the monitoring of socket communication, and if the result of the determination is YES, it performs step 2003 and the subsequent steps.

At the step 2003, the TCP communication monitoring module 360 analyzes mail data. In this analysis, information on the sender and the recipient can be obtained by analysis of the header area of the mail data and further, information on the existence of an attached file and its name, if any, can be obtained by analysis of the MIME (Multipurpose Internet Mail Extension) part.

Next, the TCP communication monitoring module 360 checks whether the mail includes an attached file or not (S2004), and if it includes an attached file, it determines whether the type of the protocol is either the POP3 or the IMAP4 for receiving mails or the SMTP for sending mails (S2005). In the case of an incoming mail, the TCP communication monitoring module 360 obtains the sender's name and the attached file name (S2006), calculates the hash value (S2007) after decoding the data of the attached file, registers the hash value in the incoming mail DB 393, and then returns to the monitoring of socket communication.

At the step 2005, if the TCP communication monitoring module 360 determines that the mail is an outgoing mail, it obtains the recipient's name and the attached file name (S2009) and sends the information obtained at the step 2009 to the dialogue operation monitoring module 340 and the file operation monitoring module 350 (S2010).

In this way, this system can detect that a file (information) from a predetermined specific acquisition source (for example, an acquisition source in the organization) is transmitted from a monitoring target (a computer in which an agent 122 is working to make determination of improper operation) to a predetermined specific node (a check target node). This capability leads to detection of (an operation with high probability of) leakage of confidential information. In this system, the apparatus that transmits a file determines whether the file transmission is an improper operation or not. This operation can reduce the processing load in a management apparatus.

As described above, the security policy 392 specifies the range of acquisition source to be criterion for improper operation as alert requirements to issue an alert using this system. The foregoing example registers apparatuses within the management area. The acquisition source to determine an improper operation is the inside of the management area and the transmission destination to determine an improper operation is the outside of the management area.

The administrator can set the ranges of acquisition source and transmission destination determined to be an improper operation in the security policy 392 in accordance with design at his own discretion. For example, if a web server that holds important information can be located, the agent 122 may determine that an improper operation is detected only if the URL of the specific web server out of the web servers in the management area is the acquisition source. The same can apply to the transmission destination range in determining improper operation.

The improper operation requirements may include requirements other than the combination of an acquisition source and a transmission destination. For example, the improper operation requirements include requirements on time slot when a transmission operation is performed, type of information, and file size. The agent 122 may determine whether to issue an alert or not depending on these improper operation requirements.

### <System Configuration for Transferring (Receiving and Transmitting) Acquisition Source Information>

Hereinafter, processing (file meta-information including) acquisition source information on a file will be described in detail. The foregoing configuration stores the acquisition source information to a fork (alternate stream or resource fork) of a file. As to the fork (adjunct-data area of a file and the data), (the meta-information in) the fork is removed if the file is sent from a current node (computer) to another with an application that does not support forks or if the file is sent from a current node to another node that does not support the forks used by the current node.

Files may be transferred between client computers in the system (management area) (monitoring target computers). For example, a client computer in the management area obtains a file from the outside of the management area and transfers the file to another client computer in the management area. In such a case, the transfer destination client computer can locate the transfer source client computer but cannot locate the acquisition source of the file only by referring to the file because the meta-information of the transferred file is deleted.

Hence, in the system in this embodiment, a client computer provides the acquisition source information (meta-information) of the file to other computers. In the system in the following description, the acquisition source information is included in file meta-information and the system transfers the meta-information between computers or adds it to files.

In this way, transferring (receiving and transmitting) acquisition source information between client computers allows a client computer that transmits a file to the outside of the management area (check target) to obtain the acquisition source information on the file, so that determination of improper operation based on the acquisition source and the transfer destination can be made accurately.

There are a plurality of manners for a client computer to obtain meta-information including acquisition source information on a file. This embodiment explains a configuration that a client computer (an agent program) of the transmission source (sender) of a file transmits the acquisition source information to a client computer (an agent program) of the transmission destination (recipient). Other methods will be described later in the second embodiment and the third embodiment.

The system configuration in the following explanation detects a receipt/transmission of file by a different method from that in the system (agent) explained with reference to FIG. 1 to FIG. 21. The agent in the foregoing system includes a browser monitoring module 330 and a dialogue operation monitoring module 340 and detects a receipt/transmission of file by monitoring mouse operations by the user and detecting a specific operation.

In the system in the following description, an agent monitors sending and receiving files to and from outside apparatuses (computers) to detect receipt/transmission of a file and further, identifies the communication protocol (the application in use). This configuration enables accurate detection of receipt/transmission of a file more easily. In the following description, the parts different from the configuration explained with reference to FIG. 1 to FIG. 21 are mainly described. The following processing including transfer of meta-information is applicable to the configuration explained with reference to FIG. 1 to FIG. 21. The same applies to other embodiments.

FIG. 22 is a system configuration diagram illustrating an example for sharing acquisition source information in an improper operation detection system. Explanations on the same parts as the configuration shown in FIG. 1 are omitted. In this configuration, agent programs 1141 to 1161 work in the servers 114 to 116, respectively, in addition to the agents in the client computers 121. In this configuration, the agent programs 122, 1141 to 1161 have the same functions. The servers 114 to 116 store information to be used by the agents in their respective disc apparatuses 1142, 1152, and 1162 as in the same manner in the client computers 121.

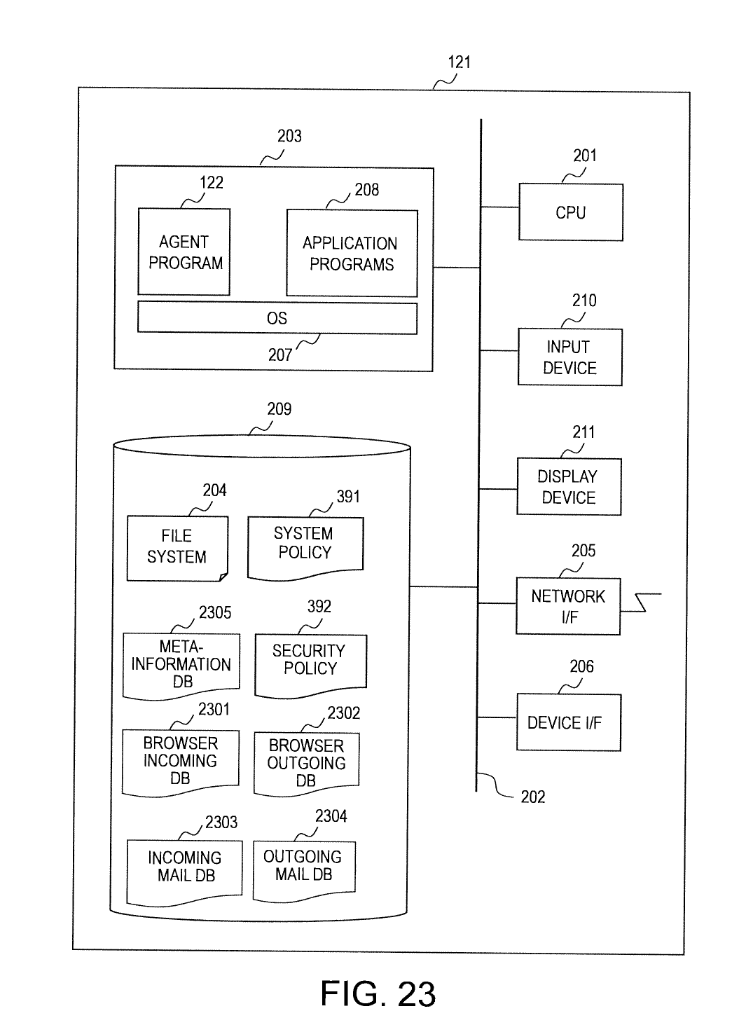

FIG. 23 is a block diagram schematically illustrating a configuration of a client computer 121. A disk apparatus 209, which is a storage apparatus equipped with a non-transitory storage medium, holds a file system 204, a system policy 391, a security policy 392, a browser incoming DB 2301, a browser outgoing DB 2302, an incoming mail DB 2303, an outgoing mail DB 2304, and a meta-information DB 2305.

The security policy 392 holds information for identifying the servers 114 to 116 on which agent programs 122 run, in addition to the client computers. The servers and the client computers are monitoring target computers (computers to determine regarding improper operations) in the management area.

In comparison with the configuration in FIG. 2, the browser incoming DB 2301, the browser outgoing DB 2302, the outgoing mail DB 2304, and the meta-information DB 2305 are added. The details of these databases will be described later. As described above, information to be used by an agent, which is stored in a memory 203 or a disk apparatus 209, may have any data structure.

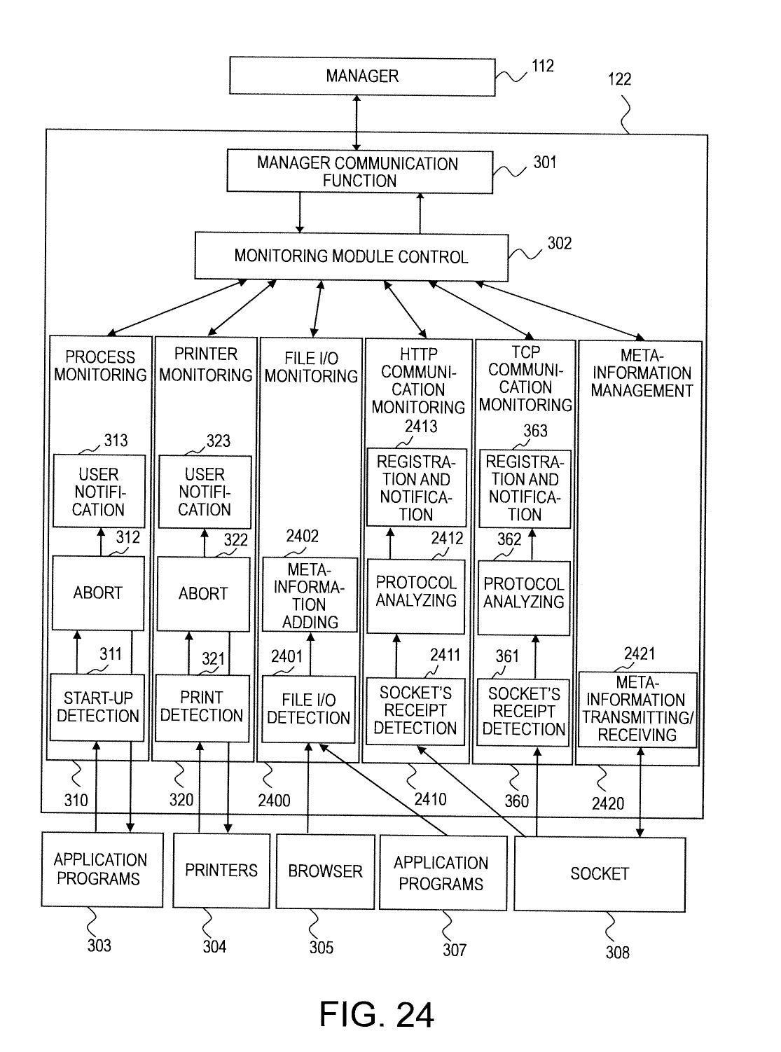

FIG. 24 schematically illustrates a configuration of an agent program 122. As described above, the agent programs 1141, 1151, and 1161 that run on the servers 114 to 116 have the same configuration and the servers 114 to 116 have the same databases.

In this example, the agent program 122 includes a process monitoring module 310, a printer monitoring module 320, a file I/O monitoring module 2400, an HTTP (HyperText Transfer Protocol) communication monitoring module 2410, a TCP communication monitoring module 360, and a meta-information management module 2420. The process monitoring module 310 and the printer monitoring module 320 have the same configurations as those shown in FIG. 3.

The file I/O monitoring module 2400 has a file I/O detection function 2401 and a meta-information adding function 2402. The file I/O detection function 2401 detects file inputs and outputs (inputs and outputs to and from the file system) performed by the web browser 305 or other application program 307 (an example of a mailer will be described in the following explanation). The meta-information adding function 2402 writes meta-information including acquisition source information to a fork (alternate data stream or resource fork) in a file.

The HTTP communication monitoring module 2410 has a socket's receipt detection function 2411 for detecting a file transmission or receipt with an outside apparatus, a protocol analyzing function 2412 for analyzing data transmitted or received through a socket 308, and a function 2413 for recording information to the browser incoming DB 2301, checking alert requirements (determining whether alert requirements are met) and issuing an alert. This function 2413 make registration in the browser incoming DB 2301 if a file is downloaded to the client computer 121 through the socket 308.

The TCP communication monitoring module 360 and the HTTP communication monitoring module 2410 are communication monitoring modules for monitoring communication in a communication network. The TCP communication monitoring module 360 monitors transmission and receipt of mails (using POP3, IMAP, and SMTP). The HTTP communication monitoring module 2410 monitors HTTP communication.

The meta-information management module 2420 has a meta-information transmitting and receiving function 2421. If a file transfer is performed between any of the servers and client computers managed by the management server 111, the meta-information transmitting and receiving function 2421 in the transmission source of the file transmits the meta-information (including acquisition source information) of the file to the meta-information transmitting and receiving function 2421 in the transmission destination of the file.

This configuration includes the browser incoming DB 2301, the browser outgoing DB 2302, the incoming mail DB 2303, and the outgoing mail DB 2304 to relate a file transmitted or received via a communication network to a file input to or output from the file system 204 (to identify the same file).

The browser incoming DB 2301 and the incoming mail DB 2303 store information on files received by the browser 305 and the mailer, respectively. The HTTP communication monitoring module 2410 and the TCP communication monitoring module 360 store information in the browser incoming DB 2301 and the incoming mail DB 2303, respectively.

The browser outgoing DB 2302 and the outgoing mail DB 2304 store information on files outputted from the file system 204. The file I/O monitoring module 2400 stores information to the outgoing DBs 2302 and 2304. The DBs 2301 to 2304 relate the I/O files via a network to the I/O files in the file system 204 with the hash values of the files as keys.

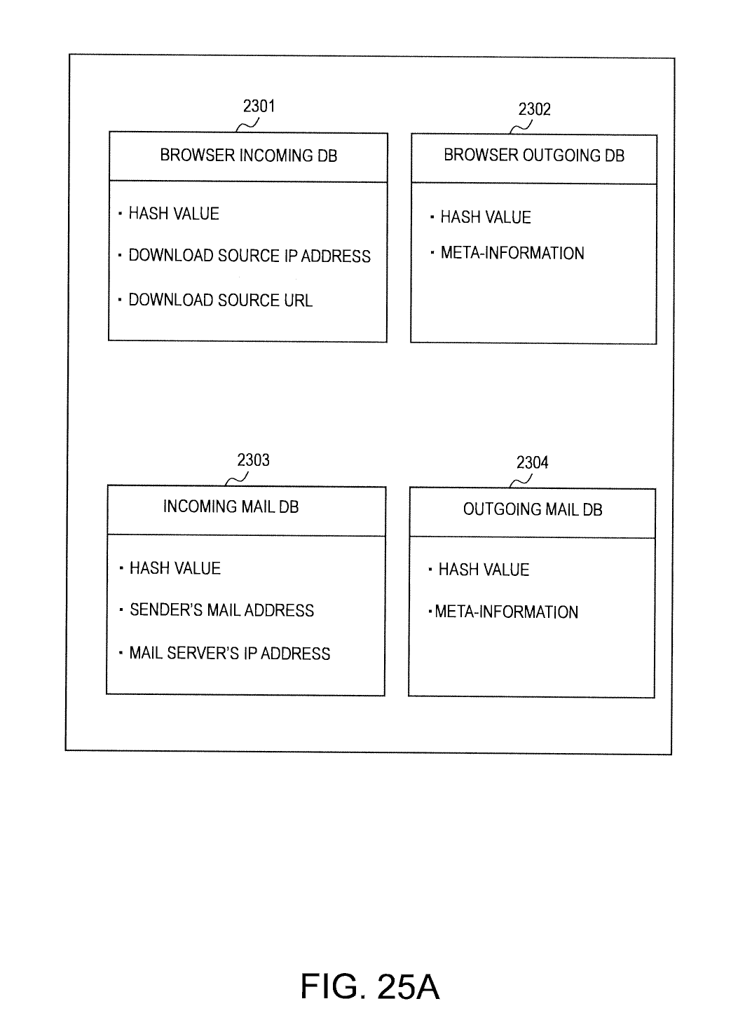

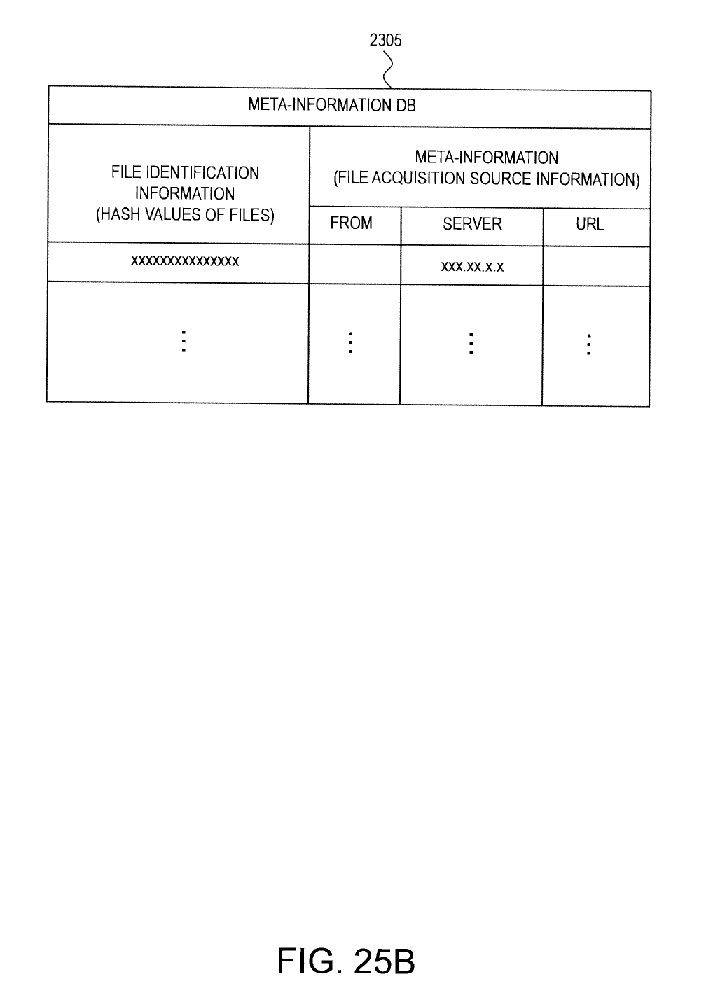

FIG. 25A shows respective constituents (fields in columns or records) to be stored in the browser incoming DB 2301, the browser outgoing DB 2302, the incoming mail DB 2303, and the outgoing mail DB 2304. The browser incoming DB 2301 stores information on files downloaded (received) by the browser 305. The browser outgoing DB 2302 stores information on files retrieved from the file system 204 by the browser 305.

The incoming mail DB 2303 stores information on files attached to incoming mails (files received by the mailer). The outgoing mail DB 2304 stores information on files retrieved from the file system 204 by the mailer.

Specifically, as shown in FIG. 25A, the browser incoming DB 2301 stores download source IP addresses that are information for identifying the download sources of files, download URLs (a kind of information for identifying download sources), and the hash values of files. The hash values are information for identifying files. The browser outgoing DB 2302 and the outgoing mail DB 2304 each store the hash values and the meta-information of outgoing files.

The incoming mail DB 2303 stores senders' mail addresses, which are information for identifying mail senders, the hash values of incoming mails, and the IP addresses of mail servers. The senders' names may be used as the identification information of the mail senders. The IP addresses of mail servers are information for identifying mail servers. A receiving terminal of a mail receives the mail from a sending terminal through a mail server. Actually, the receiving terminal receives a mail direct from a mail server.

In this configuration, the file I/O monitoring module 2400 adds meta-information including acquisition source information to a file in the file system 204. The file I/O monitoring module 2400 obtains meta-information from the transmission source computer through the meta-information management module 2420. The download source IP addresses (IP addresses of web servers) in the browser incoming DB 2301 and the IP addresses of mail servers in the incoming mail DB 2303 are used to locate a transmission source computer.

FIG. 25B shows information stored in the meta-information DB 2305. The meta-information management module 2420 in a file transmission source sends meta-information stored in the meta-information DB 2305 responsive to a request from the file transmission destination. The meta-information DB 2305 relates files transmitted and received between monitoring targets which are computers (nodes) with agents 122 implemented to one another, and further relates each file to its meta-information.

As shown in FIG. 25B, the meta-information DB stores the hash values of files, which are file identification information, and the meta-information of the files. This prevents transmission of wrong meta-information. The file identification information may include information different from hash values. For example, the file identification information may include the IP addresses of transmission sources, the IP addresses of transmission destinations, and Message IDs (mail IDs). The same applies to other DBs.

In this configuration, the meta-information of a file may additionally include information other than the acquisition source information. For example, it may store user's operation history to the file. The user's operation history information may include information on copying of the file, transmission and receipt between nodes, changing file names, and the like.

In this configuration, the meta-information is added to all files regardless of their acquisition sources. The acquisition source information specifically locates the acquisition source of a file to achieve more appropriate management of files in the system. Moreover, the meta-information can adapt to change of the management area (the range of targets for determination of improper operation) without difficulty.

For determination of improper operation, all files do not need to include meta-information (acquisition source information). Depending on the design, acquisition source information may be added only to files with acquisition sources that are the targets for improper operation determination or are not the targets for improper operation determination (in this example, the acquisition sources in the management area or outside of the management area). As long as the acquisition source of a file indicates whether the file is a target for improper operation determination or not, the acquisition source information does not need to identify the specific acquisition source. The same applies to other embodiments.

Hereinafter, transmitting and receiving meta-information accompanied by sending and receiving a file will be described in detail. As examples of sending a file, uploading a file by a browser and sending a mail with a file attached by a mailer will be described. As examples of receiving a file, downloading a file by the web browser and receiving a mail with a file attached will be described. The transfer of file meta-information in this embodiment can be applied to file transfer by other applications. The same applies to other embodiments.

### <Send File>

First, processing that a monitoring target (a client computer 121 being monitored by the agent 122 for improper operation) sends a file will be described. In sending a file, an application program (hereinbelow, examples of the browser 305 and the mailer will be described) retrieves a file of a transmission target from the file system 204.

The file I/O monitoring module 2400 detects the file retrieval from the file system 204. The file I/O monitoring module 2400 calculates the hash value of the file retrieved by the browser 350 or the mailer and stores it in the browser outgoing DB 2302 or the outgoing mail DB 2304.

The browser 305 or the mailer retrieves a file and transmits the file. The communication monitoring module (the HTTP communication monitoring module 2410 or the TCP communication monitoring module 360) detects the transmission of the file. The HTTP communication monitoring module 2410 or the TCP communication monitoring module 360 obtains the file which is going to be transmitted (or has been transmitted) and calculates its hash value.

The HTTP communication monitoring module 2410 or the TCP communication monitoring module 360 searches the browser outgoing DB 2302 or the outgoing mail DB 2304, respectively, for a record having the same hash value as obtained. If there is a record with the same hash value in the browser outgoing DB 2302 or the outgoing mail DB 2304, the either module determines that the user sends the file retrieved from the file system 204 through the browser 305 or in a mail.

If the processing being executed is a file transmission, the HTTP communication monitoring module 2410 or the TCP communication monitoring module 360 checks the alert requirements (improper operation requirements) as explained with reference to FIG. 1 to FIG. 21. The check may be performed before actual transmission of the file.

Specifically, the HTTP communication monitoring module 2410 or the TCP communication monitoring module 360 refers to the meta-information stored in the record of the outgoing DB 2302 or 2304 to locate the acquisition source of the file. Moreover, it refers to the security policy 392 to determine whether the acquisition source and the transmission destination meet the improper operation requirements or not. If they meet the improper operation requirements, it creates an alert and sends it to the manager 112. If they do not meet the improper operation requirements, it does not create an alert.

The HTTP communication monitoring module 2410 or the TCP communication monitoring module 360 stores the required information in the meta-information DB 2305 in accordance with predetermined requirements. Specifically, if the transmission destination is a node on which an agent 122 is working (in this example, a node in the management area), the HTTP communication monitoring module 2410 or the TCP communication monitoring module 360 stores the hash value, which is file identification information, and meta-information in the meta-information DB 2305. This information can be obtained from the browser outgoing DB 2302 or the outgoing mail DB 2304.

### <Upload>

Next, with reference to FIG. 26, processing of uploading a file by the browser 305 will be described as an example of processing of sending a file. The user starts the upload processing (performs an operation for uploading) using the browser (S2601). The browser 305 retrieves the upload target file from the local file system 204 (S2602). The file I/O monitoring module 2400 detects the operation of the step 2602 by API hooking or any other way (S2603).

The file I/O monitoring module 2400 calculates the hash value of the file retrieved by the browser (S2604). The file I/O monitoring module 2400 obtains the meta-information including acquisition source information from the fork of the file (S2605). The file I/O monitoring module 2400 stores the calculated hash value and the obtained meta-information in the browser outgoing DB 2302 (S2606).

Upon retrieval of the file to be uploaded, the browser 305 uploads the file through the socket 208. This transmission operation is detected by the HTTP communication monitoring module 2410 (S2611). The HTTP communication monitoring module 2410 analyzes the HTTP header (S2611) and if the operation is a transmission operation, it performs step S2612 and the subsequent steps.

The HTTP communication monitoring module 2410 obtains the upload destination URL from the HTTP header and further, obtains the file to be uploaded (S2612). The HTTP communication monitoring module 2410 calculates the hash value of the obtained file (S2613).

The HTTP communication monitoring module 2410 searches the browser outgoing DB 2302 with the hash value obtained at the step 2613 as a key. If the browser outgoing DB 2303 includes a record having the same hash value as that of the file to be uploaded, the HTTP communication monitoring module 2410 obtains the record (S2614). The record includes the property of the file: specifically, the hash value of the file and the meta-information (acquisition source information) of the file.

If the HTTP communication monitoring module 2410 cannot find a record with the same hash value, the transmitted file is a file to be transmitted by any program other than the browser of the monitoring target. The agent 122 terminates the processing.

If the HTTP communication monitoring module 2410 obtains such a record from the browser outgoing DB 2302, it refers to the security policy 392 to determine whether the upload of the file by the browser meets the alert requirements (improper operation requirements) or not on the basis of the acquisition source information and the upload destination URL. The determination is made by the same method as that described with reference to FIG. 1 to FIG. 21. If the alert requirements are met, the HTTP communication monitoring module 2410 creates an alert and sends it to the manager 112 (S2615).

Moreover, if the upload destination URL of the file indicates a management target computer of the management server 111 (a computer with an agent program working), the HTTP communication monitoring module 2410 stores the hash value and the meta-information of the uploaded file in the meta-information DB 2305 (S2616). As described above, the information for identifying management target computers is held in the security policy 392.

### <Send Mail>

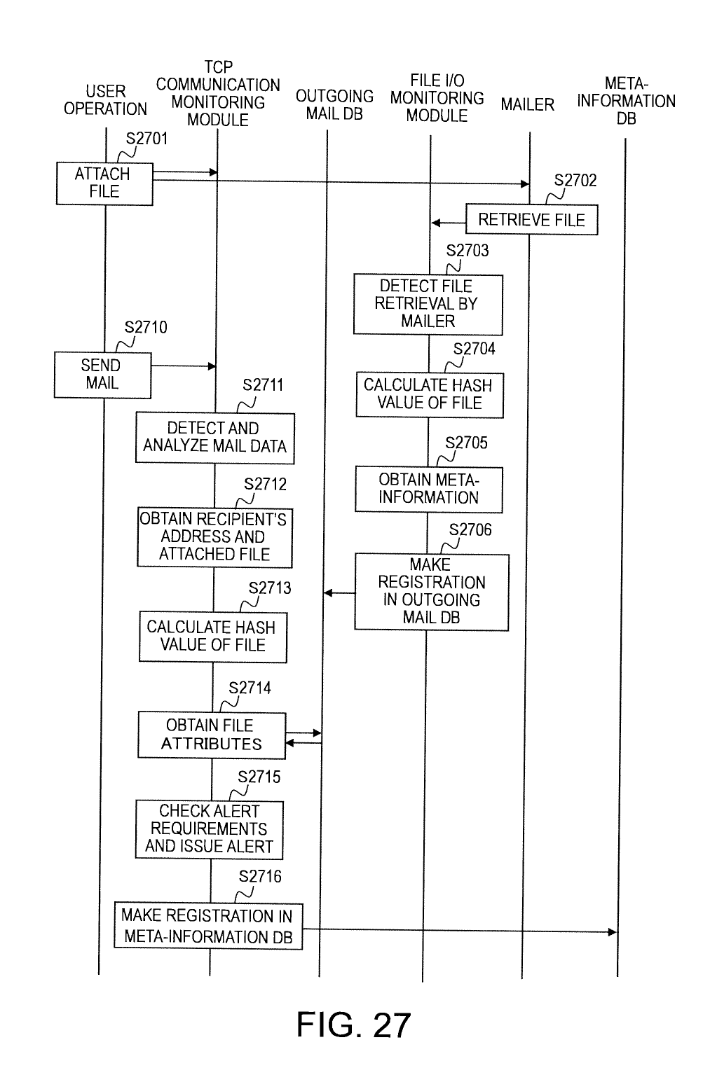

Next, processing of sending a mail with a file attached will be described as another example of processing of sending a file. FIG. 27 illustrates a sequence of attaching a file to a mail to send the mail. When the user operates the input device to attach a file to a mail using the mailer (S2701), the mailer retrieves the file to be attached to the mail from the local file system 204 (S2702).

The file I/O monitoring module 2400 detects the file retrieval at the step 2702 by API hooking or any other way (S2703). The file I/O monitoring module 2400 calculates the hash value of the file retrieved by the mailer (S2704). The file I/O monitoring module 2400 obtains the meta-information including acquisition source information from the fork of the file (S2705). The file I/O monitoring module 2400 stores the hash value and the meta-information including the acquisition source information in the outgoing mail DB 2304 (S2706).

When the user performs a send operation to the mail with a file attached (S2710), the mailer starts a transmission processing of the mail with a file attached through the socket 308. The TCP communication monitoring module 360 detects the transmission of the mail and analyzes the TCP header and the mail body (S2711). In the case of sending a mail with a file attached, the TCP communication monitoring module 360 executes step 2712 and the subsequent steps. In the case of sending a mail without a file attached, receiving a mail, or communication other than sending or receiving a mail, the agent 122 terminates the processing.

The TCP communication monitoring module 360 obtains the destination mail address and the file attached to the mail from the result of the analysis at the step 2711 (S2712). The TCP communication monitoring module 360 calculates the hash value of the file obtained at the step 2712 (S2713). The TCP communication monitoring module 360 searches the outgoing mail DB 2304 with the hash value obtained at the step 2713 as a key.

If the HTTP communication monitoring module 2410 finds a record having the same hash value as the foregoing hash value, it obtains the record (S2714). The record includes the hash value and the meta-information (file attributes) of the file. If no record having the same hash value exists, the communication is not sending a mail with a file attached by the mailer of a monitoring target, the agent 122 terminates the processing.

If the TCP communication monitoring module 360 obtains a record from the outgoing mail DB 2304, it refers to the security policy 392 to determine whether the sending the mail with the file attached by the mailer meets the alert requirements (improper operation requirements) or not based on the acquisition source information and the destination mail address. The determination is made by the same method as that described with reference to FIG. 1 to FIG. 21. If the alert requirements are met, the TCP communication monitoring module 360 creates an alert and sends it to the manager 112 (S2715).

Moreover, if the destination mail server of the file is a management target computer of the management server 111 (a computer with an agent program working), the TCP communication monitoring module 360 stores the hash value and the meta-information of the attached file in the meta-information DB 2305 (S2716). This determination refers to the registered information in the security policy 392.

### <Receive File>

Hereinafter, processing that a monitoring target in this configuration (a client computer 121 being monitored by the agent 122) receives a file will be described. Examples of receiving a file by the browser 305 and the mailer will be described in detail. Upon receipt of a file (through the browser 305 or the mailer), the communication monitoring module (the HTTP communication monitoring module 2410 or the TCP communication monitoring module 360) detects receipt of a file.

The HTTP communication monitoring module 2410 or the TCP communication monitoring module 360 calculates the hash value of the incoming file and stores it in the browser incoming DB 2301 or the incoming mail DB 2303 together with information for locating the transmission source. The transmission source information on a mail is information on a mail server, typically the IP address of the mail server. In downloading through the browser, typical transmission source information is the IP address of the transmission source.

To create new acquisition source information on the file in case that meta-information cannot be obtained from the outside, the incoming DB 2301 or 2303 stores information to locate the acquisition source, which is specifically the download source URL or the mail address of the mail sender.

The browser 305 or the mailer receives the file and writes the received file in the file system 204 in the client computer 121. The file I/O monitoring module 2400 detects the write of the file to the file system 204.

The file I/O monitoring module 2400 obtains the hash value of the file saved by the browser 305 or the mailer and searches the browser incoming DB 2301 or the incoming mail DB 2303 for a record having the same hash value. If there is a record having the same hash value, the record indicates the file received by the browser 305 or the mailer.

The file I/O monitoring module 2400 refers to the transmission source IP address stored in the incoming DB 2301 or 2303 to determine whether the transmission source is a computer with an agent 122 working or not. If the transmission source is a computer with an agent 122 working, the file I/O monitoring module 2400 requests the meta-information management module 2420 of the agent 122 (the computer) to obtain the meta-information. The meta-information management module 2420 receives meta-information from (the agent 122 of) the transmission source of the file (this processing will be described later with reference to the flowchart of FIG. 30).

Specifically, the meta-information management module 2420 obtains the hash value of the received file and requests transmission of meta-information to the IP address of the transmission source while designating the meta-information with the hash value. The meta-information management module 2420 of the transmission source searches the meta-information DB 2305 for the meta-information designated with the hash value in response to the received request. If the designated meta-information exists in the meta-information DB 2305, the meta-information management module 2420 in the transmission source sends the meta-information to the request source. If it does not, the meta-information management module 2420 notifies the request source of it.

The file I/O monitoring module 2400 in the computer which receives the file adds the meta-information received from the transmission source of the file to the received file. If the meta-information is not available from the transmission source of the file, the file I/O monitoring module 2400 creates new meta-information using information in the incoming DB 2301 or 2303 and adds it to the file.

### <Download>

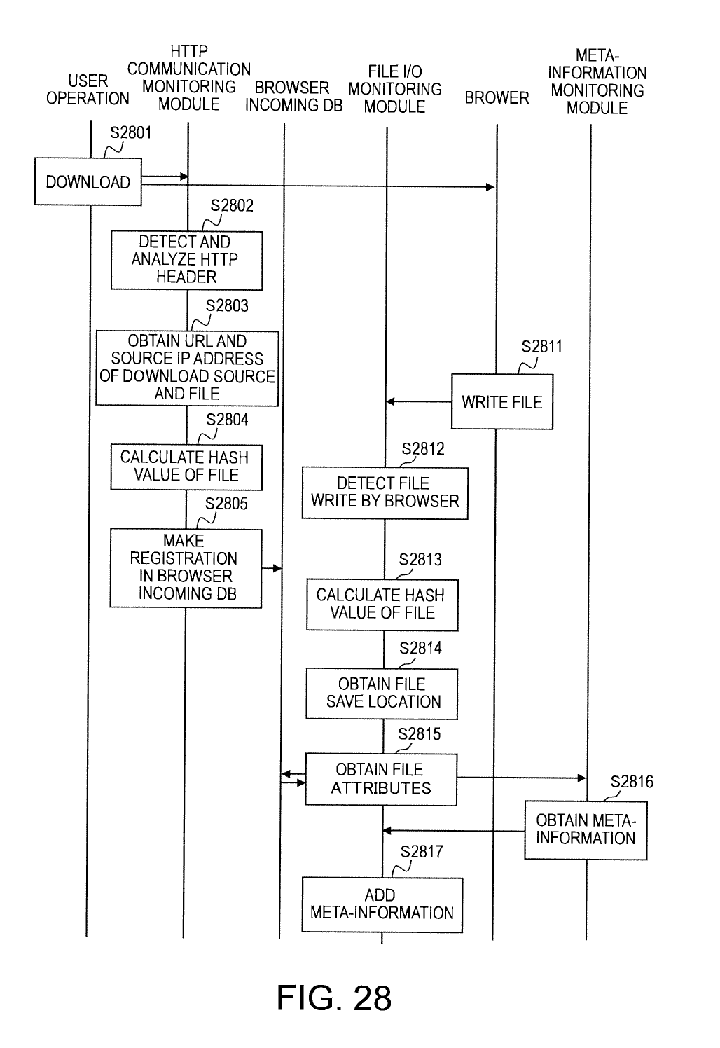

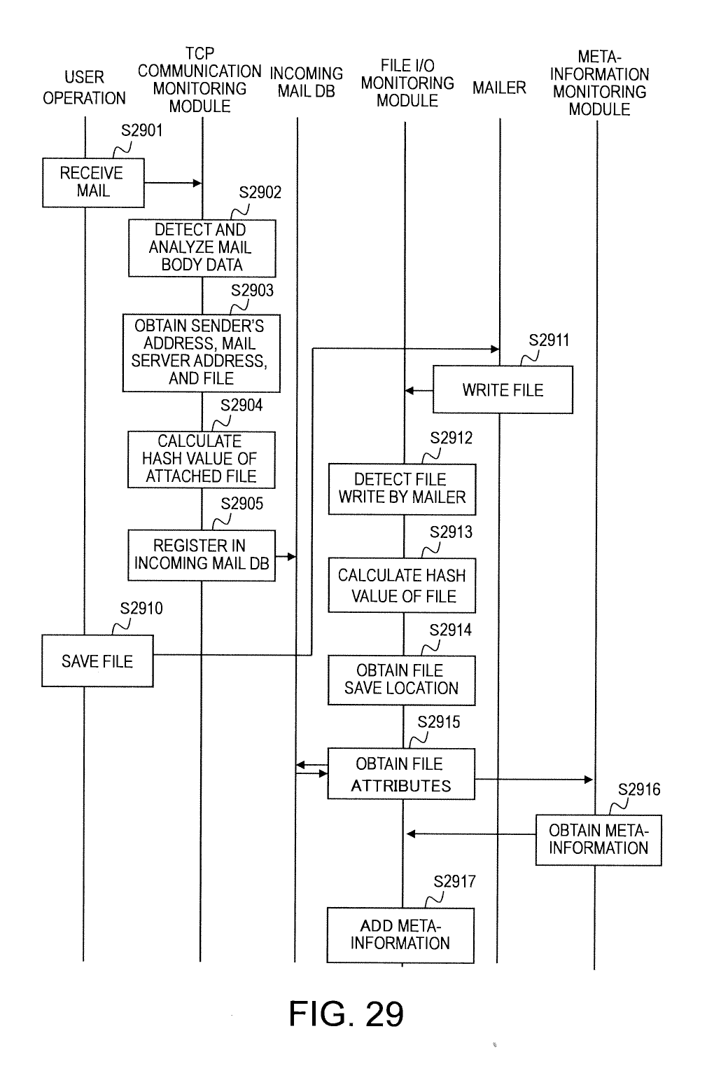

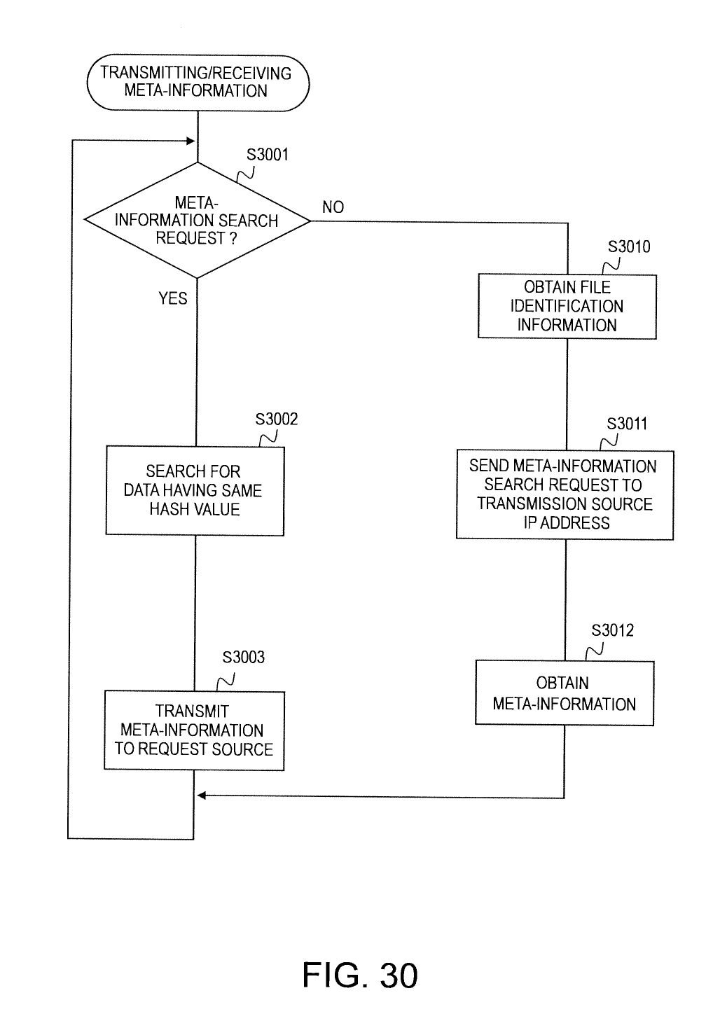

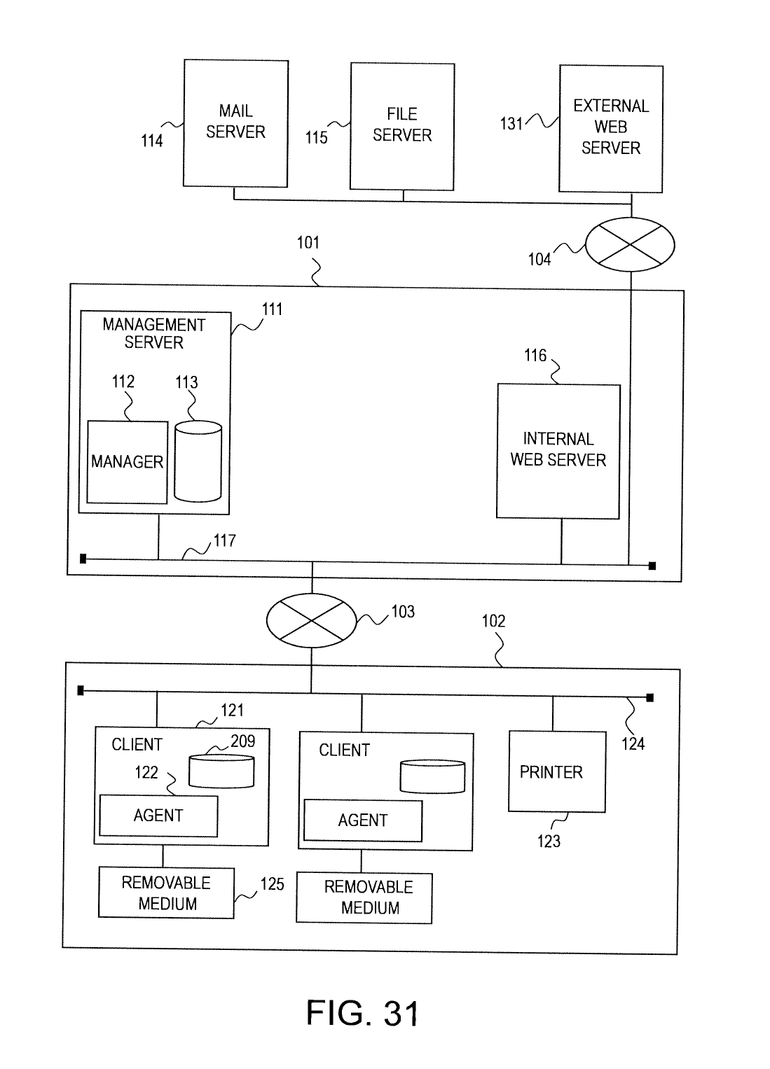

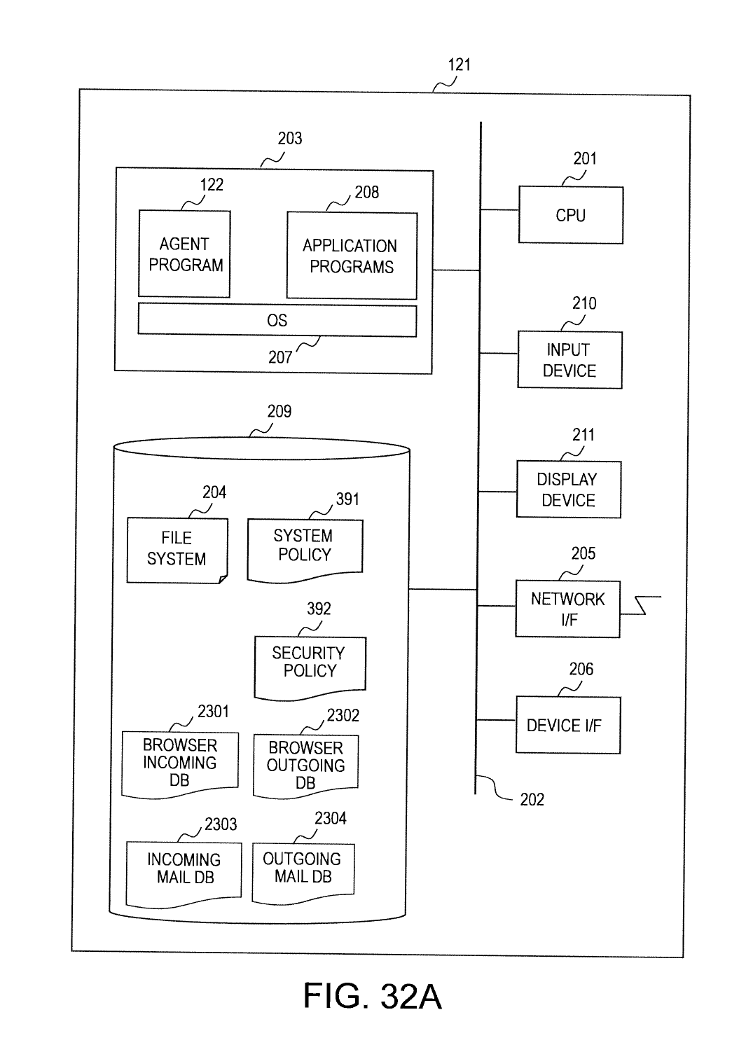

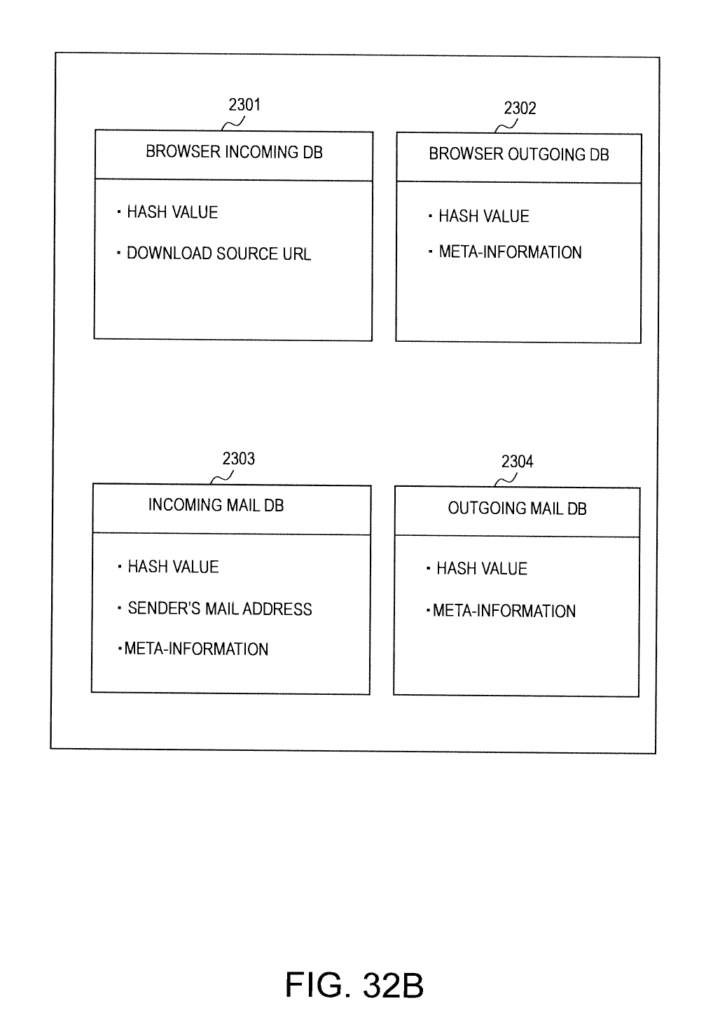

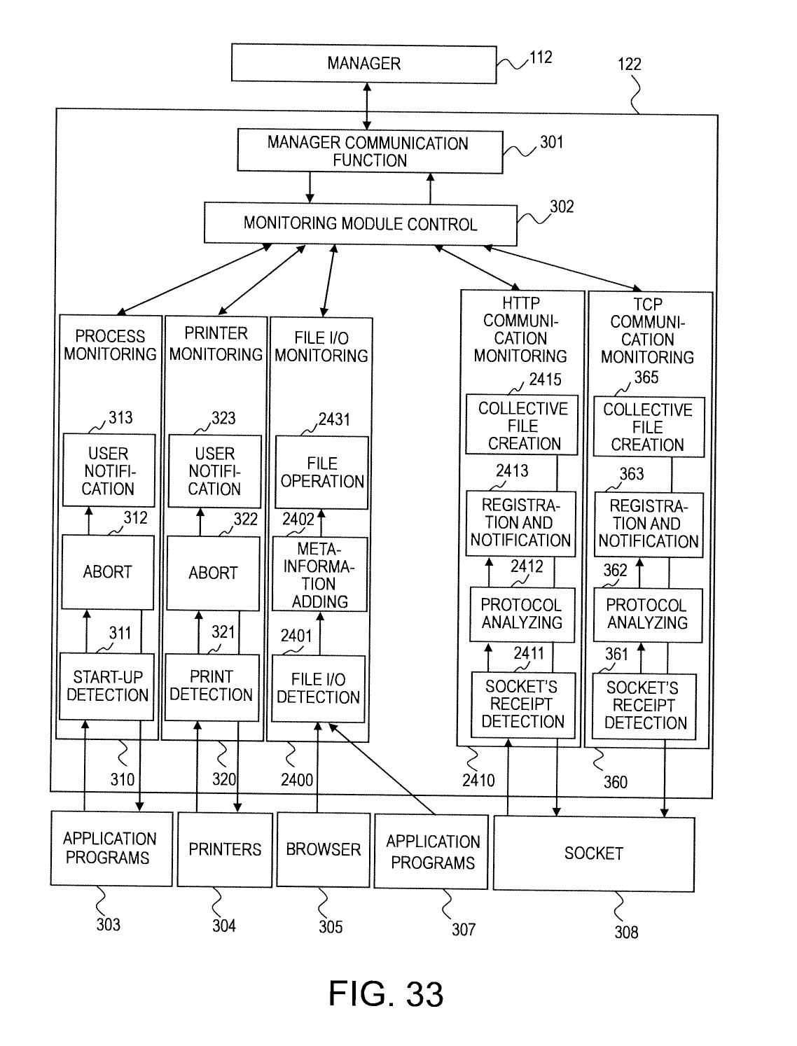

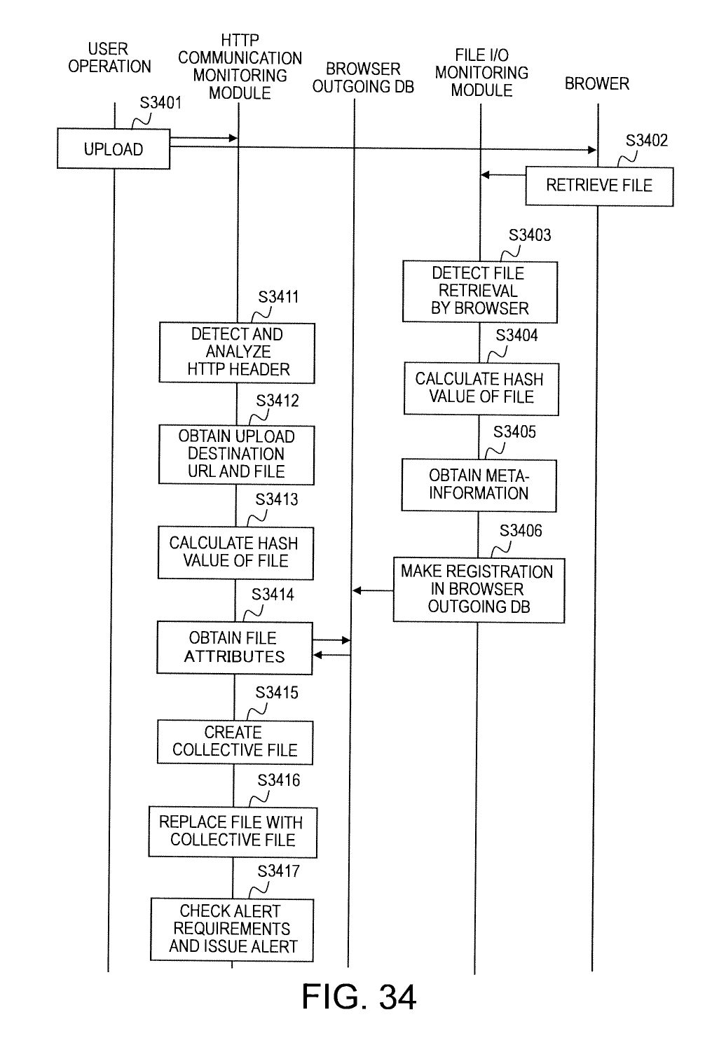

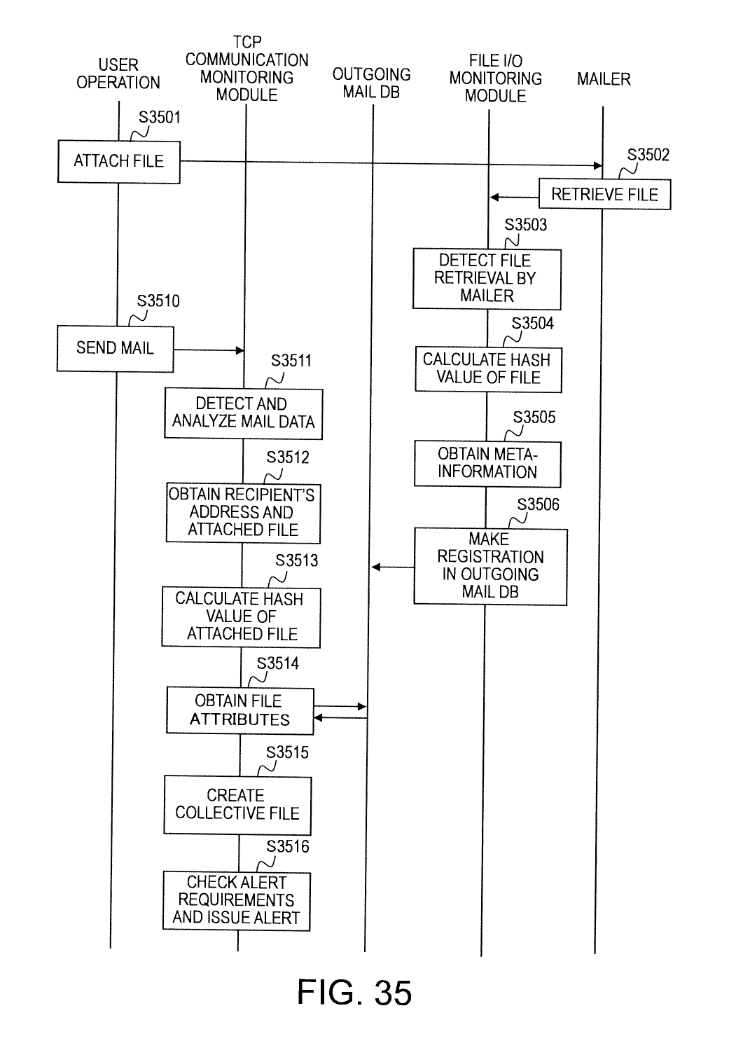

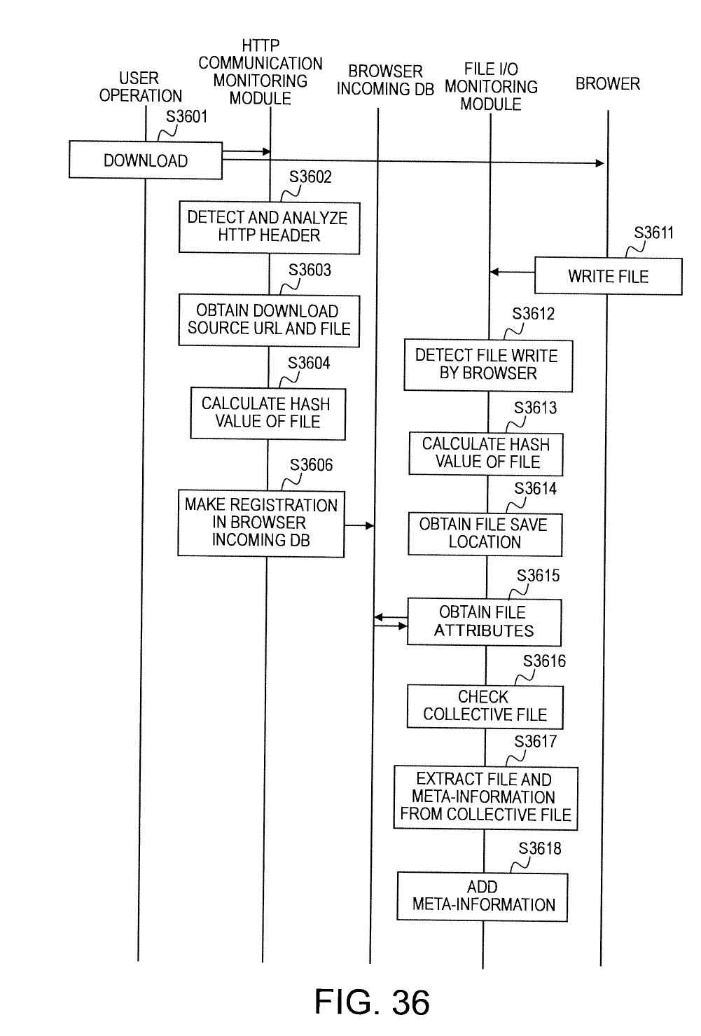

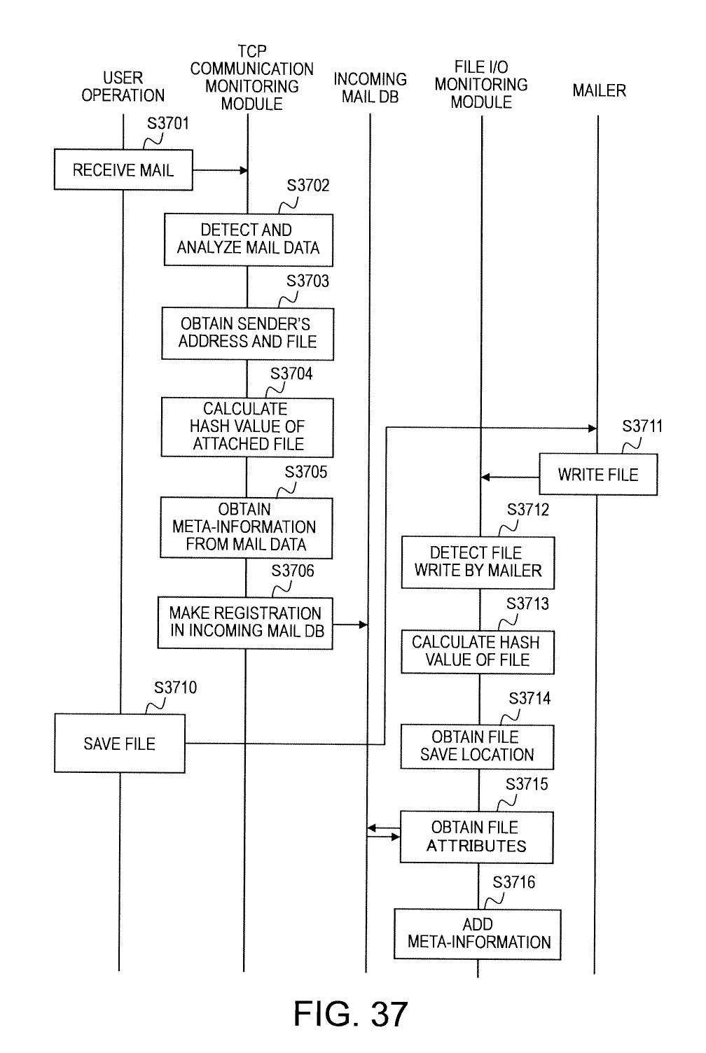

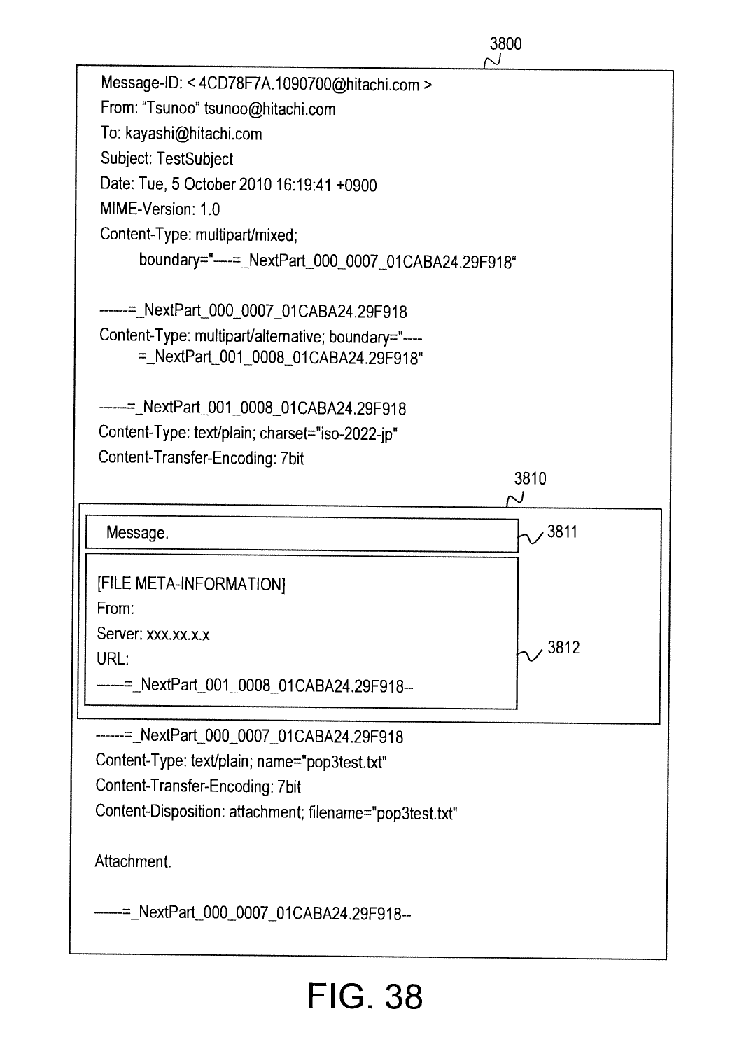

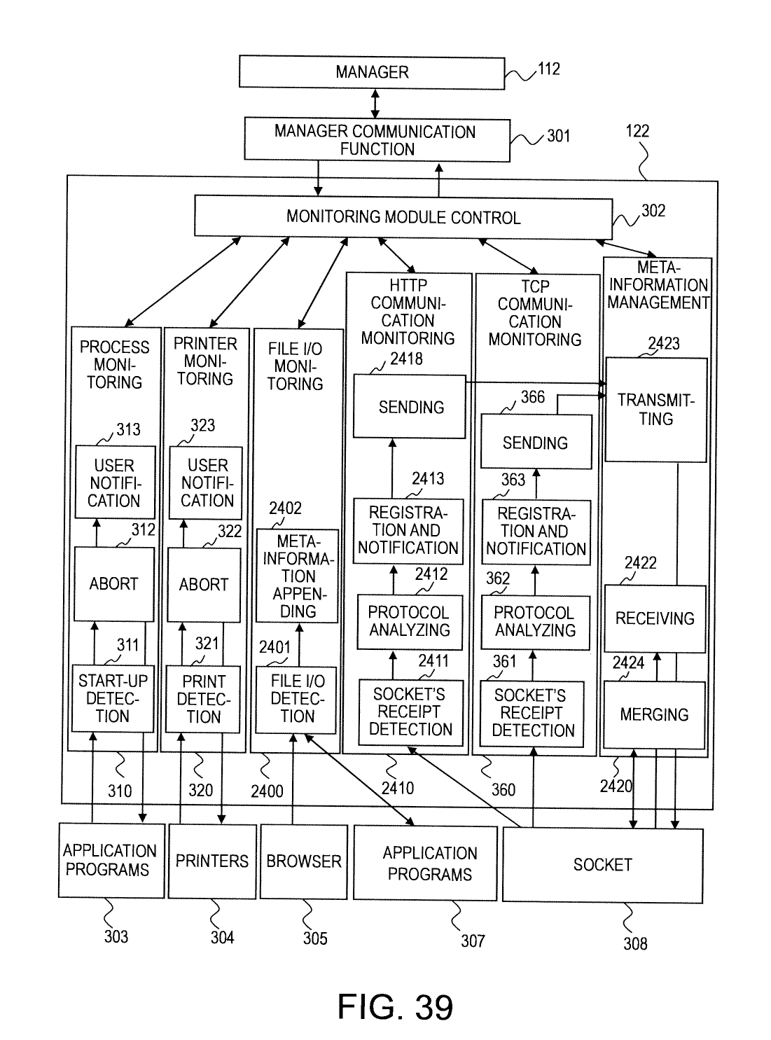

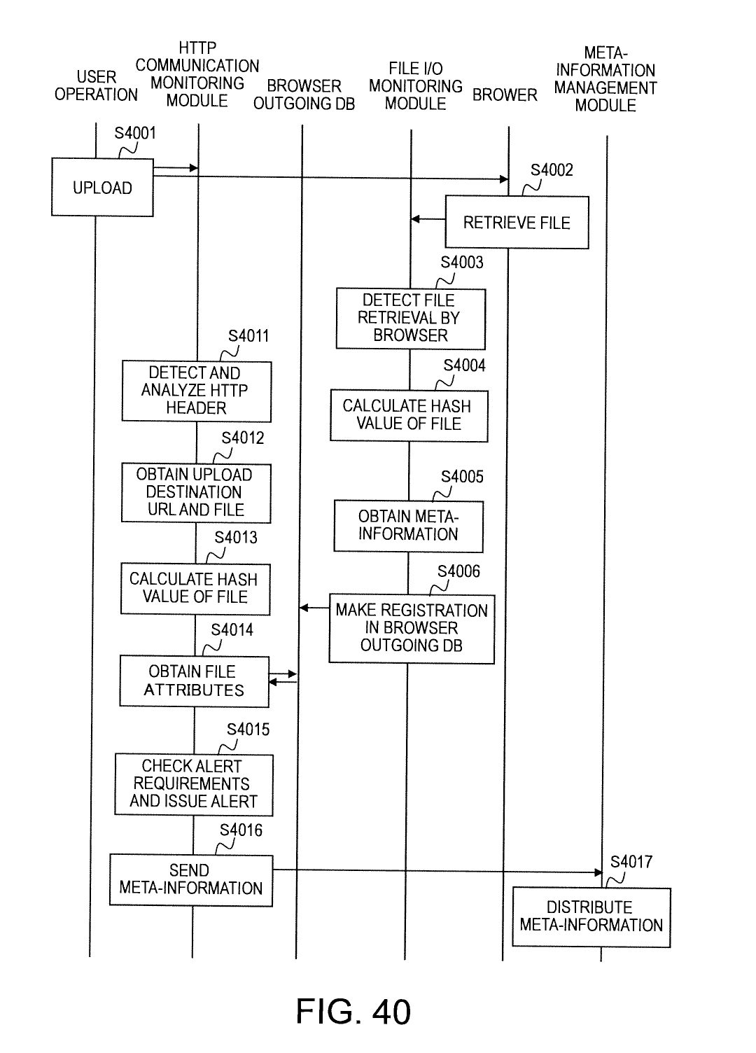

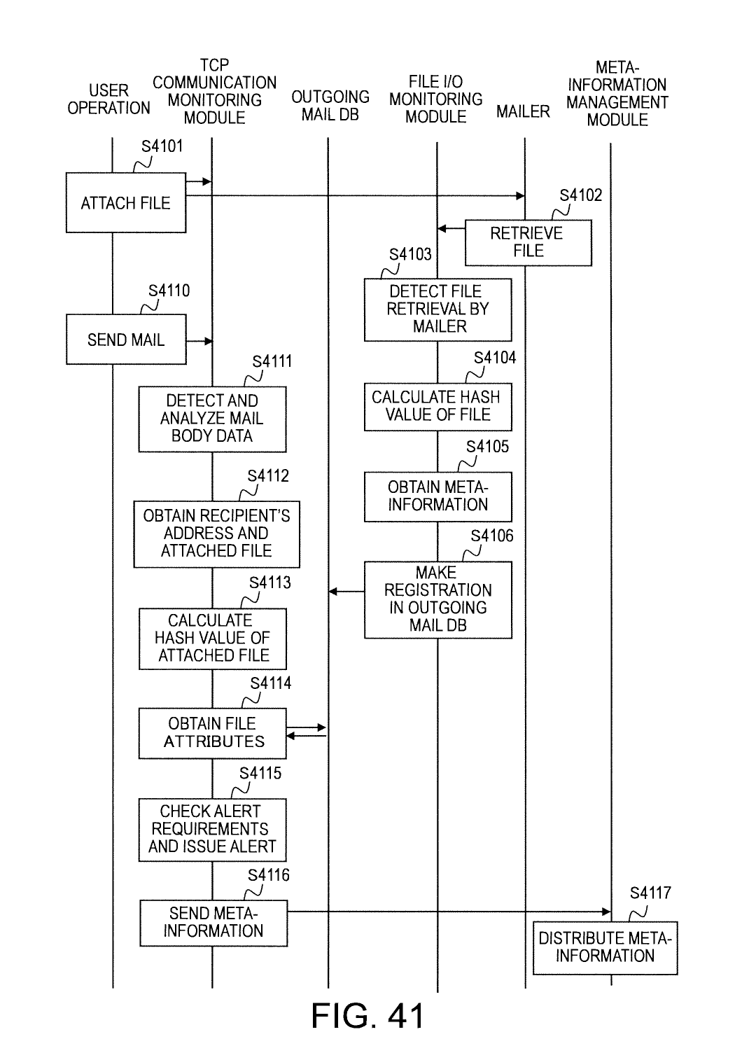

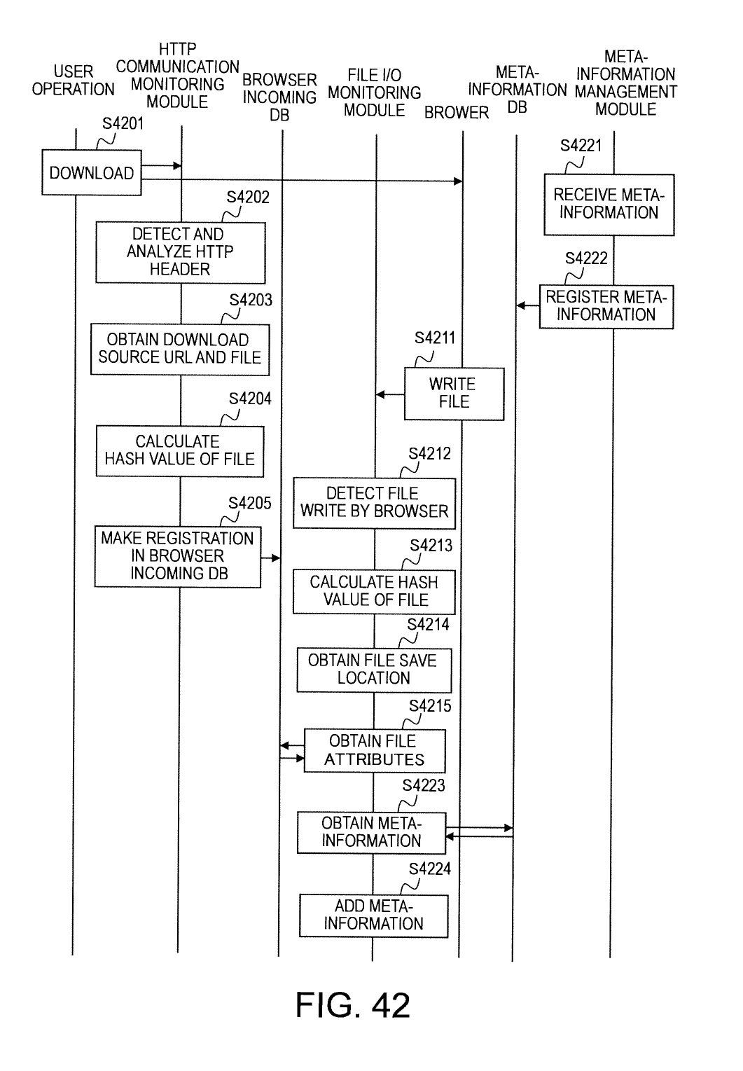

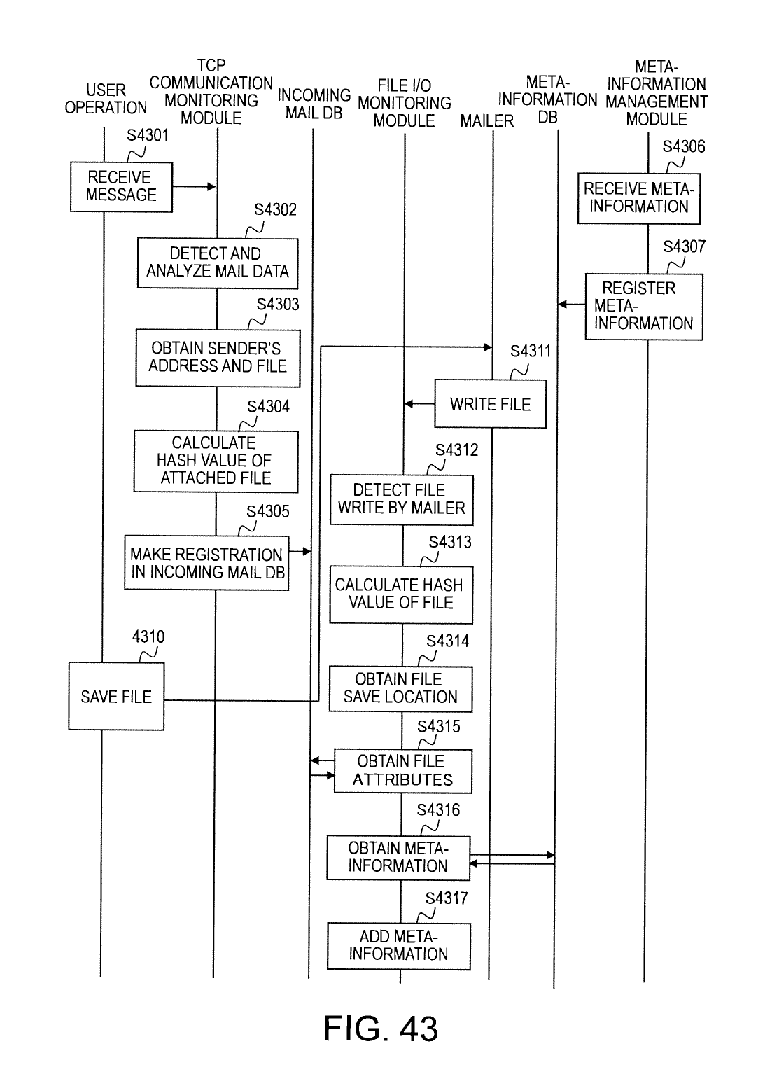

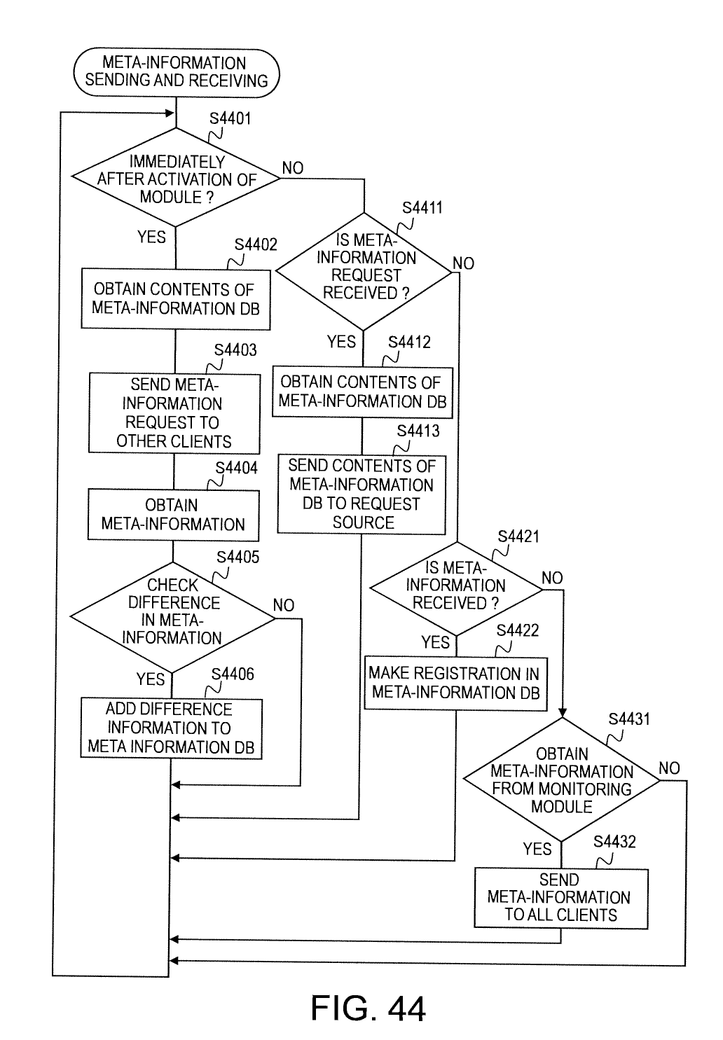

Next, with reference to FIG. 28, processing of downloading a file by the browser 305 will be described as an example of the processing of receiving a file. FIG. 28 illustrates processing of downloading a file using the browser 305.

When the user performs a download operation using the browser 305 (S2801), the HTTP communication monitoring module 2410 detects the download. The HTTP communication monitoring module 2410 analyzes the HTTP header (S2802) and if the HTTP header indicates a download operation, it performs step 2803 and the subsequent steps.

The HTTP communication monitoring module 2410 obtains the transmission source URL, the IP address of the transmission source, and the download file from the result of the analysis at the step 2802 (S2803). The HTTP communication monitoring module 2410 calculates the hash value of the file obtained at the step 2803 (S2804).

The HTTP communication monitoring module 2410 refers to the security policy 392 to determine whether the download source URL (or the IP address) is an URL (or IP address) of a monitoring target (a computer with an agent 122 working) or not. If the download source (transmission source) is a monitoring target (an apparatus to which the meta-information can be requested later), the HTTP communication monitoring module 2410 stores the IP address of the download source in the browser incoming DB 2301 together with the hash value and the download source URL of the downloaded file (S2805).

The IP address of the download source is used in subsequent receiving meta-information. The download source URL is referred to in creating meta-information. The HTTP communication monitoring module 2410 may store the IP addresses of the transmission sources of all downloaded files. In such a case, the file I/O monitoring module 2400 determines whether each of the transmission source IP addresses in the browser incoming DB 2301 is a monitoring target or not in a subsequent step.

When downloading the file starts, the browser receives the download file from the socket 308. The browser writes the download data to the file system 204 (S2811). The file I/O monitoring module 2400 detects the storing of the file to the file system 204 by API hooking or any other way (S2812).

The file I/O monitoring module 2400 calculates the hash value of the data written by the browser to the file system 204 (S2813). The file I/O monitoring module 2400 obtains the path of the location where the file has been written (S2814).

The file I/O monitoring module 2400 searches the browser incoming DB 2301 with the hash value obtained at the step 2813 as a search key. If no record having the same hash value is found, the communication is performed by a program other than the monitoring target of the browser; accordingly, the agent 122 terminates the processing.

If the browser incoming DB 2301 includes a record with the same hash value as the search key, the file I/O monitoring module 2400 obtains the record (file attribute information) (S2815). The obtained record includes fields of the hash value, the transmission source IP address, and the transmission source URL and if the transmission source web server is a monitoring target, the field of the transmission source IP address holds a value.

If the file I/O monitoring module 2400 can obtain the transmission source IP address from the record, it requests the meta-information management module 2400 to obtain meta-information from the transmission source web server. The meta-information management module 2420 obtains the hash value and the transmission source IP address of the file from the file I/O monitoring module 2400 and sends a request of meta-information together with the hash value to the transmission source IP address. The processing in the meta-information management module 2420 will be described later with reference to FIG. 30.

When the meta-information management module 2420 obtains the meta-information from the file transmission source (S2816), the meta-information transfers the received meta-information to the file I/O monitoring module 2400. The file I/O monitoring module 2400 writes the obtained meta-information in the fork of the file in the file system 204 (S2817).

If the transmission source is not a monitoring target or the meta-information management module 2420 does not obtain meta-information, the file I/O monitoring module 2400 creates new meta-information and adds it to the file. In this case, the acquisition source information included in the meta-information is information for locating the transmission source of the file, which is the download source URL in this example.

### <Receive Mail>

Next, with reference to FIG. 29, processing of receiving a file by the mailer will be described as an example of the processing of receiving a file. FIG. 29 illustrates a processing of receiving a file using the mailer and saving the received file.

When the user starts receiving a mail using the mailer (S2901), the TCP communication monitoring module 360 detects a header of a TCP communication and analyzes the header and the mail body (S2902). If the result of the analysis indicates that the incoming mail includes an attached file, the TCP communication monitoring module 360 performs step 2903 and the subsequent steps. In the case of transmitting or receiving a mail without a file attached or any communication other than transmitting or receiving of a mail, the agent 122 terminates the processing.

The TCP communication monitoring module 360 obtains the sender's mail address (, which may be other sender's identification information such as the sender's name), the data of the attached file, and the IP address of the mail server of the transmission source (S2903). The TCP communication monitoring module 360 calculates the hash value of the attached file (S2904). The TCP communication monitoring module 360 stores the hash value and the sender's mail address in the incoming mail DB 2303 (S2905).

The TCP communication monitoring module 360 further refers to the security policy 392 to determine whether the mail server is a monitoring target or not from the IP address of the mail server. If it is a monitoring target, the TCP communication monitoring module 360 also stores the IP address to the incoming mail DB 2303 (S2905). Like in the explanation on the browser incoming DB 2301, the TCP communication monitoring module 360 may store the IP addresses of mail servers with regard to all files.

When the user performs a save file operation on the file attached to the mail (S2910), the mailer writes the attached file to the file system 204 (S2911). The file I/O monitoring module 2400 detects the write of the file to the file system 204 by API hooking or any other way (S2912). The file I/O monitoring module 2400 obtains the hash value of the file data written by the mailer (S2913). Moreover, the file I/O monitoring module 2400 obtains the path of the location where the mailer has written the file (S2914).

The file I/O monitoring module 2400 searches the incoming mail DB 2303 based on the hash value obtained at the step 2913. If the file I/O monitoring module 2400 finds a record with the same hash value as that of the file written to the file system 204 in the incoming mail DB 2303, it indicates that the file corresponding to the record is the file attached to the mail. The file I/O monitoring module 2400 obtains the record (file attributes) (S2915).

If no record having the same hash value exists in the incoming mail DB 2303, the writing of a file at the step 2911 is not the writing of the file attached to the mail; accordingly, the agent 122 terminates the processing.

The record which the file I/O monitoring module 2400 obtains from the incoming mail DB 2303 (S2915) includes fields of the sender's mail address, the hash value, and the IP address of the mail server and if the mail server (transmission source) is a monitoring target (a computer with an agent 122 working), the field of the IP address of mail server holds a value.

If the file I/O monitoring module 2400 can obtain the IP address of the mail server from the record, it requests the meta-information management module 2400 to obtain meta-information from the mail server. The meta-information management module 2420 obtains the hash value of the file and the IP address of the mail server from the file I/O monitoring module 2400 and sends a request of meta-information together with the hash value to the IP address of the mail server. The processing by the meta-information management module 2420 will be described later with reference to FIG. 30.

When the meta-information management module 2420 obtains meta-information from the file transmission source of the mail server (S2916), it transfers the received meta-information to the file I/O monitoring module 2400. The file I/O monitoring module 2400 writes the obtained meta-information in the fork of the file in the file system 204 (S2917).

If the mail server of the transmission source is not a monitoring target or the meta-information management module 2420 does not obtain meta-information, the file I/O monitoring module 2400 creates new meta-information and adds it to the file. In this case, the acquisition source information included in the meta-information is information for identifying the mail sender (such as the name or the mail address), which is the mail address in this example.

The above-described configuration detects saving a received file to the file system 204 by the user and adds meta-information to the file. The file I/O monitoring module 2400 may detect storing of a mail with a file attached to the file system 204 by the mailer and add meta-information to the file.

In another example, if the user transfers a mail (the transfer here means transmit a mail from someone to another) without saving the attached file, the agent 122 may refer to the incoming mail DB 2303 to obtain the meta-information through the meta-information management module 2420 and store the obtained meta-information in the outgoing mail DB 2304 and the meta-information DB 2305.

### <Transfer Meta-Information>

Next, with reference to FIG. 30, transfer of meta-information between the meta-information management modules 2420 of the transmission source and the destination will be described. As described above, the meta-information management module 2420 in the transmission destination receives meta-information from the meta-information management module 2420 in the transmission source.

FIG. 30 is a flowchart exemplifying processing performed by a meta-information management module 2420. This flowchart includes the processing of the meta-information management module 2420 (the file transmission destination) that requests meta-information (S3002 and S3003) and the processing of the meta-information management module 2420 (the file transmission source) that receives the request of meta-information (S3010 to S3012).

When the meta-information management module 2420 receives a request, it determines whether the request is a meta-information acquisition request from the file I/O monitoring module 2400 or a meta-information search request from any other monitoring target (specifically, the meta-information management module 2420 in the file transmission destination) (S3001).

If the request received at the step 3001 is a meta-information search request (YES at S3001), the meta-information search request includes identification information for identifying meta-information. Specifically, it is the hash value of the file corresponding to the requested meta-information. The meta-information management module 2420 searches the meta-information DB 2305 with the hash value as the search key (S3002). The information for identifying meta-information may include the message ID of the mail, the IP address of the transmission source of the file, and the address of the transmission destination of the file, other than the hash value of the file.

If the meta-information DB 2305 has a record having the designated hash value, the meta-information management module 2420 obtains the record from the meta-information DB 2305 and transmits it to (the meta-information management module 2420 of) the request source of the meta-information (S3003). If the meta-information DB 2305 does not have the requested meta-information, the meta-information management module 2420 notifies the request source of the result.

If the request received at the step 3001 is a meta-information acquisition request from the file I/O monitoring module 2400 (NO at S3001), the meta-information management module 2420 obtains the file identification information (meta-information identification information) and the request destination IP address for the meta-information, from the file I/O monitoring module 2400 (S3010).

In this example, the file identification information is the hash value of a file. The meta-information management module 2420 sends a meta-information search request to the computer at the transmission source IP address together with the hash value (S3011). The meta-information management module 2420 receives meta-information as a result of the request sent at the step 3011 (S3012). The receipt of meta-information at the step 3012 corresponds to the transmission of meta-information at the step 3003.

When a user of a client computer 121 receives confidential information created in any other computer in the organization and transmits it to the outside of the organization thereafter, this configuration regards the operation as an improper operation to detect it. Consequently, an operation performed by a user that might lead to information leakage can be detected as an improper operation.

To detect a user operation with high risk of information leakage based on the combination of the acquisition source and the transmission destination of a file, the initial settings for issuing an alert when a specific information output operation is performed or detailed initial settings defining patterns of improper operations can be omitted. Moreover, in transferring a file between internal apparatuses, the meta-information including the acquisition source information on the file is sent to the transmission destination of the file in the above-described configuration. Accordingly, in a system which cannot transfer meta-information together with a file, a computer that transmits a file can determine improper operation more accurately.

In this configuration, a recipient of a file requests the sender of the file to transmit the meta-information. Through this operation, the recipient in need of the meta-information (acquisition source information) can definitely obtain the meta-information if it exists. Depending on the design, the transmission source may transmit the meta-information without waiting for the request from the transmission destination.

As described above, a client computer 121 transfers meta-information accompanied by a file transfer and performs determination of improper operation. The server computers 114 to 115 have the same agent function as the client computers 121 but the servers 114 to 115 do not need to have the improper operation determination function.

On the server computers 114 to 115, server programs different from the browser or the mailer are working; however, their agents 122 monitor the processing by those programs to monitor inputs and outputs of files in their own computers or file systems, and add or transfer meta-information in the same manner as in the client computers 121.

### SECOND EMBODIMENT

Hereinafter, another method of transferring meta-information, which is different from the one in the first embodiment, will be described. The system of this embodiment creates and transfers a collective file including a file and meta-information including the acquisition source information on the file. Through this configuration, the file and the meta-information thereof can be transferred at the same time. Consequently, communication between transmitting and receiving nodes can be made more efficient and the data traffic amount can be reduced compared with the meta-information transfer in the first embodiment. Hereinafter, the points different from the first embodiment will be mainly explained.

FIG. 31 is a system configuration diagram schematically illustrating an overall configuration of an improper operation detection system in this embodiment. The improper operation detection system in this embodiment comprises a management server 111 provided in an information center 101 and client computers 121 provided in a site 102.

A mail server 114 and a file server installed in external sites are connected via a wide area network 104 and they are management targets of a management server 111. In each client computer 121, an agent 122 operates. Unlike the configuration of FIG. 22, agents do not operate in the servers. The system in this embodiment may have the same configuration as the one in FIG. 1.

FIG. 32A illustrates a configuration of a client computer 121. A disk apparatus 209 stores a file system 204, a system policy 391, a security policy 392, a browser incoming DB 2301, a browser outgoing DB 2302, an incoming mail DB 2303, and an outgoing mail DB 2304. The meta-information DB 2305 shown in FIG. 23 is removed. Since this embodiment transmits meta-information together with a file, the meta-information DB 2305 is not necessary.

FIG. 32B shows respective constituents (fields in columns or records) to be stored in the DBs 2301 to 2304. Compared with the DBs 2301 to 2304 in FIG. 25A, the incoming mail DB 2303 stores meta-information.

In the browser incoming DB 2301, the download source IP address is deleted; in the incoming mail DB 2303, the mail server IP address is deleted. Since this embodiment receives meta-information together with a file and does not need to receive the meta-information from the sender separately from the file, the incoming DBs 2301 and 2303 do not need to store the information for locating transmission source (the IP addresses of web servers and mail servers) to obtain meta-information.

FIG. 33 illustrates a configuration of an agent 122 in this embodiment. The agent 122 includes a process monitoring module 310, a printer monitoring module 320, a file I/O monitoring module 2400, an HTTP communication monitoring module 2410, and a TCP communication monitoring module 360.

The meta-information management module 2420 is deleted from the configuration shown in FIG. 24. Since this embodiment transmits meta-information together with a file, the meta-information management module 2420 that transfers meta-information independently from file transfer is not necessary. Instead, in order to create a collective file including a file and meta-information, new functions are added to the other modules.

Specifically, the HTTP communication monitoring module 2410 has a function 2415 to create a collective file with a file and meta-information bundled in transmitting the file, in addition to a socket's receipt detection function 2411 for detecting a file transmission or reception with an outside apparatus, a protocol analyzing function 2412 for analyzing data transmitted or received through a socket 308, and a function 2413 for recording information to the browser incoming DB 2301, checking alert requirements, and issuing an alert.

The TCP communication monitoring module 360 has a function 365 for adding the meta-information of an attached file to mail data to create a collective file (including a mail and an attached file thereto) formatted into a standard mail style in sending a mail with a file attached, in addition to a socket's receipt detection function 361 for detecting a file transmission or receipt, a protocol analyzing function 362 for analyzing the data transmitted or received through the socket 308, and a function 363 for registering information to the incoming mail DB 2303, checking the alert requirements, and issuing an alert.

The file I/O monitoring module 2400 has a file I/O detection function 2401 for detecting a file input or output generated in the web browser 305 or other application program 307 and a file operation function 2431 instead of the meta-information adding function 2402. The file operation function 2431 has a function for extracting the meta-information from a received collective file and adding the meta-information to a file stored in the file system 204, in addition to the function for adding newly created meta-information to a file.

In this configuration, the communication monitoring modules (the HTTP communication monitoring module 2410 and the TCP communication monitoring module 360) create collective files including meta-information and files and transmit the collective files. Moreover, the file I/O monitoring module 2400 extracts meta-information from a collective file and adds the meta-information to the file stored in the file system 204.

### <Send File>

Hereinafter, processing of sending a file will be described. When the user starts sending a file, the browser 305 or the mailer retrieves the transmission target file from the file system 204. The file I/O monitoring module 2400 detects the file retrieval. The file I/O monitoring module 2400 calculates the hash value of the file retrieved by the browser or the mailer and stores it in the browser outgoing DB 2302 or the outgoing mail DB 2304.

Upon retrieval of the file from the file system 204, the browser or the mailer starts processing to transmit the file. The HTTP communication monitoring module 2410 or the TCP communication monitoring module 360 detects the transmission of the file.

Before the actual transmission of the file, the HTTP communication monitoring module 2410 or the TCP communication monitoring module 360 obtains the transmitted file and calculates the hash value. The HTTP communication monitoring module 2410 or the TCP communication monitoring module 360 searches the browser outgoing DB 2302 or the outgoing mail DB 2304, respectively, for a record having the same hash value as calculated. If there is a record with the same hash value in the outgoing DB 2302 or 2304, the either module determines that the user sends the file through the browser 305 or in a mail.

If the HTTP communication monitoring module 2410 or the TCP communication monitoring module 360 determines that the transmission processing is a file transmission through the browser 305 or the mailer, it obtains the record. The record includes the meta-information of the file. The HTTP communication monitoring module 2410 or the TCP communication monitoring module 360 creates a collective file including the file retrieved by the browser 305 or the mailer and its meta-information. The created collective file may be assigned a new extension to indicate a collective file (for example, “.meta”).

A method of creating a collective file adds meta-information to the header or the footer of the file data, or creates a text file (meta file) of the meta-information and compresses the outgoing file and the meta file into a compressed file. In sending a mail, meta-information may be described in the mail data.

For example, if the HTTP communication monitoring module 2410 determines that the file is to be transmitted through the browser, it replaces the outgoing file stored in the memory 203 with the collective file created by the above-described method. If the TCP communication monitoring module 360 determines that the file is to be transmitted through the mailer, it adds meta-information to the mail body. The mail body configures a part of the collective file.

Furthermore, the HTTP communication monitoring module 2410 or the TCP communication monitoring module 360 refers to the security policy 392 to check whether the alert requirements are met or not based on the acquisition source and the transmission destination of the file as explained in the first embodiment. If the alert requirements are met, it creates an alert and sends it to the manager 112.

### <Upload>

Next, with reference to FIG. 34, a sequence of processing of uploading a file by the browser, which is an example of sending file, will be described. In FIG. 34, step 3401 of an upload operation by the user in the browser to step 3413 of calculation of the hash value of the uploaded file by the HTTP communication monitoring module 2410 are the same as the steps 2601 to the step 2613 shown in FIG. 26; accordingly, explanations on these steps are omitted.

The HTTP communication monitoring module 2410 searches the browser outgoing DB 2302 based on the hash value obtained at the step 3413 to obtain a record having the same hash value as that of the uploaded file. If a record with the same hash value is found, the file is the upload file.

If the record of the upload file is found, the HTTP communication monitoring module 2410 obtains the record (including the file attributes) (S3414). The record includes the hash value and the meta-information (acquisition source information) of the file. If a record having the same hash value is not found, the communication is made by any program other than the browser of a monitoring target. Accordingly, the agent 122 terminates the monitoring operation.

The HTTP communication monitoring module 2410 creates a collective file from the upload file and the meta-information thereof (S3415) and replaces the upload file in the memory 203 with the collective file to send it (S3416). The HTTP communication monitoring module 2410 refers to the security policy 392 to determine whether the uploading the file by the browser meets the alert requirements (improper operation requirements) or not based on the file acquisition source information and the upload destination. If the alert requirements are met, HTTP communication monitoring module 2410 creates an alert and sends it to the manager 112 (S3417).

### <Send Mail>

Next, with reference to FIG. 35, processing of sending a mail with a file attached, which is another example of sending a file, will be described. FIG. 35 illustrates a sequence of attaching a file to a mail to send the mail. When the user performs an attachment operation of a file to a mail using the mailer (S3501), the mailer retrieves the file to be attached to the mail from the local file system 204 (S3502). Then, the file I/O monitoring module 2400 performs step 3503 to step 3506. The steps 3503 to 3506 are the same as the step 2703 to the step 2706 and explanations on these steps are omitted.

When the user performs an operation to send the mail with a file attached (S3510), the mailer starts transmitting the mail with a file attached through the socket 308. The TCP communication monitoring module 360 detects the transmission of the mail and analyzes the TCP header and the mail body (S3511).

In the case of sending a mail with a file attached, the TCP communication monitoring module 360 executes step 3512 and the subsequent steps. In the case of sending a mail without a file attached, receiving a mail, or communication other than sending or receiving a mail, the agent 122 terminates the monitoring.

The TCP communication monitoring module 360 obtains the destination mail address and the file attached to the mail from the result of the analysis at the step 3511 (S3512). The TCP communication monitoring module 360 calculates the hash value of the file obtained at the step 3512 (S3513).

The TCP communication monitoring module 360 searches the outgoing mail DB 2304 based on the hash value obtained at the step 3513 to obtain a record (including the file attributes) having the same hash value (S3514). The record includes the meta-information of the file in addition to the hash value.

The TCP communication monitoring module 360 creates a collective file including the mail body and the outgoing file (S3515). In an example, the TCP communication monitoring module 360 adds the meta-information to the mail body. FIG. 38 shows data of a mail 3800 including meta-information. The mail data 3800 has a field 3810 of the mail body.

In the example of FIG. 38, the meta-information 3812 is described in the mail body field 3810, which includes a message 3811 written by the user. The TCP communication monitoring module 360 adds the meta-information 3812 obtained at the step 3514 to a field 3810 located by analysis of the MIME part.

The TCP communication monitoring module 360 refers to the security policy 392 to determine whether the sending the mail with a file attached by the mailer meets the alert requirements (improper operation requirements) or not based on the acquisition source information on the file and the destination mail address. If the alert requirements are met, the TCP communication monitoring module 360 creates an alert and sends it to the manager 112 (S3516).

### <Receive File>

Hereinafter, processing of receiving a file will be described. When a user performs an operation to receive a file, the communication monitoring module (the HTTP communication monitoring module 2410 or the TCP communication monitoring module 360) detects the receipt of the file.

The HTTP communication monitoring module 2410 or the TCP communication monitoring module 360 calculates the hash value of the incoming file and stores it in the browser incoming DB 2301 or the incoming mail DB 2303. This embodiment receives the meta-information together with the file and does not need to receive the meta-information from the transmission source separately from the file. Accordingly, the incoming DBs 2301 and 2303 do not need to store location information on transmission source (the IP addresses of web servers and IP addresses of mail servers, respectively) to obtain meta-information.

The browser or the mailer receives the file and writes the received file to the file system 204 in the client computer 121. The file I/O monitoring module 2400 detects the write of the file to the file system 204.

The file I/O monitoring module 2400 obtains the hash value of the file saved by the browser or the mailer and searches the browser incoming DB 2301 or the incoming mail DB 2303 for a record having the same hash value. If there is a record having the same hash value, the record indicates the file received by the browser or the mailer.

If the received file is a collective file, the file I/O monitoring module 2400 extracts the meta-information from the collective file and adds the meta-information to the file in the file system.

Specifically, if the received file is a collective file downloaded through the browser, the file I/O monitoring module 2400 obtains the collective file in the file system 204 to extract the original file and the meta-information. It replaces the collective file in the file system 204 with the extracted file and adds the extracted meta-information to the file.

If the received file is attached to a received mail, the file system 204 holds the original file. The file I/O monitoring module 2400 extracts meta-information from the received mail and adds the meta-information to the file stored in the file system 204.

If the received file is not a collective file, the file I/O monitoring module 2400 newly creates meta-information and adds it to the file. The file I/O monitoring module 2400 refers to the identification information on the file acquisition source and/or the received file to determine whether the received file includes meta-information or not. The processing of creating new meta-information and adding the meta-information to a file by the file I/O monitoring module 2400 is the same as the processing explained in the first embodiment.

### <Download>

Next, with reference to FIG. 36, a sequence of processing of downloading a file by the browser will be described. Step 3601 of an download operation by the user in the browser to step 3614 of obtaining the file save location by the file I/O monitoring module 2400 are the same as the steps 2801 to the step 2814 shown in FIG. 28; accordingly, explanations on these steps are omitted.

The file I/O monitoring module 2400 obtains a matching record (file attributes) from the browser incoming DB 2301 with the hash value calculated at the step 3613 as a search key. If no record having the same hash value is found, the communication is performed by a program other than the browser of a monitoring target; accordingly, the agent 122 terminates the processing.

The file I/O monitoring module 2400 determines whether the file downloaded and stored in the file system 204 is a collective file or not (S3616). The file I/O monitoring module 2400 can determine whether the file is a collective file or not by referring to the extension of the file, for example.

If the obtained file is not a collective file, the file I/O monitoring module 2400 skips step 3617 to execute step 3618. Specifically, the file I/O monitoring module 2400 creates meta-information using the information in the browser incoming DB 2301 and adds it to the file in the file system 204.

If the downloaded file is a collective file, the file I/O monitoring module 2400 extracts a file and meta-information from the collective file (S3617), replaces the file with the collective file, and adds the meta-information (including acquisition source information) obtained at the step 3615 to the file (S3618).

### <Receive Mail>

Next, with reference to FIG. 37, processing of receiving a mail with a file attached by the mailer will be described as an example of processing of receiving a file. FIG. 37 illustrates a sequence of receiving a file using the mailer and saving the received file.

As shown in FIG. 37, when the user performs a receive mail operation using the mailer (S3701), the TCP communication monitoring module 360 detects a header of a TCP communication and analyzes the header and the mail body (S3702). If the result of the analysis indicates that the incoming mail includes an attached file, the TCP communication monitoring module 360 performs step 3703 and the subsequent steps. In the case of transmitting or receiving a mail without a file attached or any communication other than transmitting or receiving a mail, the agent 122 terminates the processing.

The TCP communication monitoring module 360 obtains the attached mail and the mail address of the sender from the result of the analysis of the mail data at the step 3702 (S3703). The TCP communication monitoring module 360 calculates the hash value of the attached file (S3704).

The TCP communication monitoring module 360 searches the mail for the field 3810 of the mail body data and if the field 3810 includes a field 3812 of meta-information, it obtains the data in the field for the meta-information of the file (S3705). The TCP communication monitoring module 360 stores the mail address of the sender, the hash value of the attached file, and the meta-information to the incoming mail DB 2303 (S3706).

When the user performs a save file operation on the file attached to the mail (S3710), the mailer writes the attached file to the file system 204 (S3711). The file I/O monitoring module 2400 detects the write of the file (S3712). The file I/O monitoring module 2400 calculates the hash value of the file data written by the mailer (S3713). Moreover, the file I/O monitoring module 2400 obtains the path of the location where the mailer writes the file (S3714).

The file I/O monitoring module 2400 searches the incoming mail DB 2303 based on the hash value obtained at the step 3713. If the file I/O monitoring module 2400 finds a record with the same hash value as that of the file written to the file system 204, the file corresponding to the record is a file attached to the mail.

The file I/O monitoring module 2400 then obtains the record (S3715). If it cannot find a record having the same hash value, the file write at the step 3711 is not a file write caused by a save operation of an attached file (S3710); accordingly, the agent 122 terminates the processing.

If the file I/O monitoring module 2400 can obtain a record (including meta-information) from the incoming mail DB 2303 at the step 3715, it writes the meta-information included in the obtained record to the fork of the file stored in the file system 204 (S3716).

If the received mail does not have meta-information (the step 3705 does not obtain meta-information), the file I/O monitoring module 2400 newly creates meta-information and adds it to the file stored in the file system 204 (S3716). For example, the file I/O monitoring module 2400 can learn the existence of the meta-information by referring to the meta-information field of the record in the incoming mail DB 2303. The method of creating new meta-information is the same as in the first embodiment.

When the user transfers the mail without saving the attached file, if the mail body includes meta-information, the meta-information does not need to be added to the transferred mail. If the mail body does not include meta-information, the TCP communication monitoring module 360 creates meta-information from the information in the incoming mail DB 2303 and adds it to the mail body.

### THIRD EMBODIMENT

Hereinafter, yet another method of transferring meta-information in the management area, which is different from those in the first embodiment and the second embodiment, will be described. In the system of this embodiment, each agent sends meta-information to other agents so that each agent shares all meta-information.

Consequently, each client computer can definitely obtain necessary meta-information through a configuration that transmits and receives meta-information separately from files. Specifically, since the meta-information is shared by a plurality of computers, resistance against failure increases and even if some computer is not working, meta-information can be obtained from other computer.

Hereinafter, the points different from the first embodiment and the second embodiment will be mainly explained. The overall configuration of the system in this embodiment is the same as that shown in FIG. 1. In this embodiment, agents 122 are working on client computers 121 and are not installed in servers. FIG. 39 schematically illustrates the configuration of an agent 122 in this embodiment.

In this embodiment, the agent 122 includes a process monitoring module 310, a printer monitoring module 320, a file I/O monitoring module 2400, an HTTP communication monitoring module 2410, a TCP communication monitoring module 360, and a meta-information management module 2420.

The HTTP communication monitoring module 2410 has a socket's receipt detection function 2411 for detecting a file transmission or receipt with an outside apparatus, a protocol analyzing function 2412 for analyzing data transmitted or received through a socket 308, and a function 2413 for recording information in the browser incoming DB 2301, checking alert requirements, and issuing an alert, and a function 2418 for sending file meta-information to the meta-information management module 2420.

The TCP communication monitoring module 360 has a socket's receipt detection function 361, a protocol analyzing function 362, a function 363 for registering information in the incoming mail DB 2303, checking the alert requirements, and issuing an alert, and a function 366 for sending file meta-information to the meta-information management module 2420.

The meta-information management module 2420 has a meta-information receiving function 2422, a meta-information transmitting function 2423, and a meta-information merging function 2424. The meta-information receiving function 2422 receives meta-information from other client computer 121 and registers it in a meta-information DB 2305.

The meta-information transmitting function 2423 obtains meta-information from the HTTP communication monitoring module 2410 or the TCP communication monitoring module 360 and transmits meta-information of other client computer 121. The meta-information merging function 2424 merges the meta-information DB 2305 of its own client computer 121 and the meta-information DB 2305 of a different client computer 121. As to the information to be stored in the DBs 2301 to 2305, this embodiment does not need the IP addresses of transmission source servers in the incoming DBs 2301 and 2303 shown in FIG. 25A in the first embodiment.

### <Send File>

Hereinafter, processing of sending a file from a client computer 121 of a monitoring target will be described. The processing from the operation by the user to send a file to the determination that the file is transmitted is the same as in the explanation in the first embodiment with reference to FIG. 22 to FIG. 30.

When the agent 122 determines to transmit a file, it determines whether the alert requirements are met or not and if the requirements are met, it creates and sends an alert. Furthermore, the agent 122 determines whether the transmission destination of the file is a node other than a check target or not (in this example, nodes other than the check targets correspond to the nodes in the management area). The nodes in the management area include servers on which agents 122 are not working.

If the transmission destination of the file is a node in the management area, the agent 122 distributes the meta-information to the other client computers 121 (agents 122) and its own client computer 121. In other words, the distribution destinations of the meta-information are the all client computers including the client computer 121 of the transmission source of the file (distribution source of the meta-information).

The agents 122 that receive the meta-information update their meta-information DBs 2305 with the received meta-information. The distribution destinations of the meta-information may not include the distribution source of client computer 121. The agent 122 that distributes the meta-information updates its own meta-information DB 2305 with the meta-information to be distributed. If the transmission destination of the file is a check target (a recipient included in the improper operation requirements), the distribution of the meta-information is not necessary.

### <Upload>

Next, with reference to FIG. 40, uploading a file by a browser 305, which is an example of sending a file, will be described. FIG. 40 illustrates a sequence of processing of uploading a file using the browser 305. In FIG. 40, step 4001 to step 4014, which is the start of an upload by a user using the browser 305 to the detection of the upload file by the HTTP communication monitoring module 2410, are the same as the step 2601 to step 2614 in FIG. 26; accordingly, explanations on these steps are omitted.

If the communication detected by the HTTP communication monitoring module 2410 is an upload of a file by the browser 305, the HTTP communication monitoring module 2410 obtains the record (file attributes) of the file from the browser outgoing DB 2302 (S4014). The record includes meta-information including the acquisition source of the file.

If the HTTP communication monitoring module 2410 cannot find a record with the same hash value in the browser outgoing DB 2302, the communication is made by any program other than the browser of a monitoring target. Accordingly, the agent 122 terminates the monitoring operation.

When the HTTP communication monitoring module 2410 obtains the meta-information from the browser outgoing DB 2302, it refers to the security policy 392 to determine whether the uploading of the file by the browser 305 meets the alert requirements or not based on the acquisition source and the upload destination included in the meta-information. If it meets the alert requirements, the HTTP communication monitoring module 2410 creates and sends an alert (S4015).

Furthermore, the HTTP communication monitoring module 2410 determines whether the upload destination is a node of a check target or not. If the upload destination is a node of a check target (a node outside the management area), the processing ends. If the upload destination is not a node of a check target (a node within the management area), the agent 122 performs step 4016 and the subsequent steps.

Specifically, the HTTP communication monitoring module 2410 sends the meta-information obtained from the browser outgoing DB 2302 to the meta-information management module 2420 (S4016). The meta-information management module 2420 distributes the obtained meta-information to all of the client computers (including the own client computer 121) (S4017).

### <Send Mail>

Next, with reference to FIG. 41, processing of sending a mail with a file attached, which is another example of sending a file, will be described. FIG. 41 illustrates a sequence of attaching a file to a mail to send the mail. The operation that the user attaches a file to a mail using the mailer (S4101) to the processing that the file I/O monitoring module 2400 stores the hash value and the meta-information in the outgoing mail DB 2304 (S4106) are the same as the step 2801 to the step 2806 in FIG. 28; accordingly, the explanation is omitted.

When the user performs an operation to send a mail with a file attached (S4110), the mailer starts processing of sending the mail with a file attached through the socket 308. The TCP communication monitoring module 360 detects the transmission of the mail and analyzes the TCP header and the mail body (S4111).

In the case of sending a mail with a file attached, the agent 122 executes step 4112 and the subsequent steps. In the case of sending a mail without a file attached, receiving a mail, or communication other than sending or receiving a mail, the agent 122 terminates the processing.

The TCP communication monitoring module 360 obtains the destination mail address and the file attached to the mail from the result of the analysis at the step 4111 (S4112). The TCP communication monitoring module calculates the hash value of the file obtained at the step 4112 (S4113).

The TCP communication monitoring module 360 searches the outgoing mail DB 2304 based on the hash value calculated at the step 4113. If a record having the same hash value is held in the outgoing mail DB 2304, the TCP communication monitoring module 360 obtains the record (S4114).

The TCP communication monitoring module 360 refers to the security policy 392 to determine whether the sending a file with a mail meets the alert requirements or not based on the recipient's mail address and the acquisition source information in the meta-information. If the alert requirements are met, the TCP communication monitoring module 360 creates an alert and sends it to the manager 112 (S4115).

Furthermore, the TCP communication monitoring module 360 determines whether the recipient's mail address is a node of a check target or not. If the recipient's mail address is a node of a check target (a node outside the management area), the processing ends. If the recipient's mail address is not a node of a check target (if it is a node within the management area), the agent 122 executes step 4116 and the subsequent steps.

Specifically, the TCP communication monitoring module 360 sends the meta-information obtained from the outgoing mail DB 2304 to the meta-information management module 2420 (S4116). The meta-information module 2420 distributes the meta-information to all of the client computers 121 (all of the agents 122) (S4117).

### <Receive File>

Hereinafter, processing of receiving a file will be described. The processing from the receiving of a file by a user to the detecting write of the file to the file system 204 is the same as that in the first embodiment; accordingly, the explanation is omitted.

The file I/O monitoring module 2400 obtains the hash value of the file saved by the browser 305 or the mailer and searches the browser incoming DB 2301 or the incoming mail DB 2303 for a record having the same hash value. If there is a record having the same hash value in the browser incoming DB 2301 or the incoming mail DB 2303, the record indicates the file received by the browser 305 or the mailer.

As described in the explanation of the processing of sending a file, the agent 122 distributes the meta-information, accompanied by sending the file to a management target. Typically, in receiving a file from a management target, the meta-information management module 2420 preliminarily receives the meta-information from any other agent 122 and registers it in the meta-information DB 2305.

The file I/O monitoring module 2400 obtains a record having the same hash value of the file identification information as that obtained from the incoming DB 2301 or 2303, from the meta-information DB 2305. The file I/O monitoring module 2400 adds the meta-information included in the obtained record to the received file.

If the client computer 121 receives a file (by downloading through the browser or by receiving a mail) from a node other than the management targets, the file I/O monitoring module 2400 adds the information (in this example, the acquisition source information) obtained from the incoming DB 2301 or 2303 to the received file as the meta-information.

### <Download>

Next, with reference to FIG. 42, processing of downloading a file by a browser, which is an example of receiving a file, will be described. FIG. 42 illustrates a sequence of processing of downloading a file using the browser 305.

The operation by the user to start downloading using the browser 305 (S4201) to the step where the file I/O monitoring module 2400 obtains a record from the browser incoming DB 2301 (S4215) are the same as the steps 2801 to the step 2815 in FIG. 28; accordingly, explanations on these steps are omitted. The IP address of the download source does not need to be stored in the browser incoming DB 2301.

If the URL of the web server of the transmission source (download source) obtained at the step 4215 is the one outside the management area, the file I/O monitoring module 2400 creates new meta-information including the acquisition source information on the file and writes it to the fork of the downloaded file (S4224).

If the URL of the web server of the transmission source obtained at the step 4215 is the one inside the management area (in this example, of the internal web server 116), the file I/O monitoring module 2400 performs step 4221 and the subsequent steps.

If the download source is the server 116 in the management area, the meta-information management module 2420 has already received the meta-information from any other client computer 121 (S4221) and registered it in the meta-information DB 2305 (S4222). The client computer 121 that has transmitted the meta-information is the client computer 121 that uploaded the download file to the web server 116 or any other client computer 121.

The file I/O monitoring module 2400 obtains the meta-information of the record having the same hash value (file identification information) as the hash value of the file obtained at the step 4215 (S4223) from the meta-information DB 2305 and writes it to the fork of the downloaded file (S4224).

### <Receive Mail>

Next, with reference to FIG. 43, processing of receiving a mail with a file attached, which is an example of receiving a file, will be described. FIG. 43 illustrates a sequence of processing of receiving a file using the mailer and saving the received file.

The operation by the user to start receiving a mail using the mailer (S4301) to the step where the TCP communication monitoring module 360 stores information to the incoming mail DB 2303 (S4305) are the same as the step 2901 to the step 2905 in FIG. 29. The IP address of the mail server does not need to be stored in the incoming mail DB 2303.

If the received mail is from a client computer 121 of a management target, the meta-information management module 2420 has received the meta-information from any other client computer 121 (S4306) and stored it in the meta-information DB 2305 (S4307). The meta-information is sent from the client computer 121 of the transmission source of the mail or any other client computer 121.

When the user performs a save file operation to the file attached to the mail (S4310), the mailer writes the attached file to the file system 204 (S4311). The file I/O monitoring module 2400 detects the operation at the step 4311 (S4312). The file I/O monitoring module 2400 obtains the hash value of the file written by the mailer (S4313). Furthermore, the file I/O monitoring module 2400 obtains the path of the location where the mailer writes the file (S4314).

The file I/O monitoring module 2400 searches the incoming mail DB 2303 based on the hash value obtained at the step 4313. If the incoming mail DB 2303 does not have a matching record, the written file is not a file received by the mailer; accordingly, the processing ends.

If a record having the same hash value as that of the file written in the file system is found, the file corresponding to the record is the file attached to the mail. The file I/O monitoring module 2400 obtains the record from the incoming mail DB 2303 (S4315).

The file I/O monitoring module 2400 obtains the sender's address included in the obtained record and refers to the security policy 392 to determine whether the mail sender is someone in the management area or not. If the mail sender is not a management target, the file I/O monitoring module 2400 creates new meta-information using the information obtained from the incoming mail DB 2303 and writes it to the fork of the file (S4317).

If the mail sender is a management target, the file I/O monitoring module 2400 obtains meta-information from the meta-information DB 2305 (S4316). Specifically, the file I/O monitoring module 2400 obtains the meta-information of the record having the same hash value as the one obtained from the incoming mail DB 2303 from the meta-information DB 2305. The file I/O monitoring module 2400 writes the obtained meta-information to the fork of the file (S4317).

If the user transfers the mail together with the attached file without saving the attached file, the TCP communication monitoring module 360 requests the meta-information management module 2420 to obtain and distribute the meta-information while designating the hash value of the attached file, for example. The meta-information management module 2420 distributes the meta-information if the meta-information DB 2305 includes a record including the hash value.

### <Distribute Meta-Information>

Hereinafter, distribution of meta-information in this embodiment will be described. FIG. 44 is an example of a flowchart illustrating an outline of processing performed by the meta-information management module 2420. The meta-information management module 2420 is activated when the user logs on the client computer 121.

The meta-information management module 2410 merges the contents of the meta-information DBs of the other client computers into the meta-information DB at the start-up. Furthermore, as described with reference to FIG. 40 and FIG. 41, the meta-information management module 2420 transmits (distributes) meta-information. Then, as described with reference to FIG. 42 and FIG. 43, the meta-information management module 2420 receives meta-information and stores it to the meta-information DB 2305.

As shown in FIG. 44, immediately after the activation of the meta-information management module 2420 (YES at S4401), the meta-information management module 2420 obtains the contents of the meta-infoi illation DB 2305 in the client computer 121 (S4402). Next, at step 4403, it sends the other client computers 121 requests of meta-information, and at step 4404, it receives the contents of the meta-information DBs in the other client computers 121.

At step 4406, the meta-information management module 2420 determines whether any difference exists or not between the meta-information obtained at the step 4402 and the meta-information obtained at the step 4405. If there is some difference (YES at S4405), the meta-information management module 4240 adds the different information to the meta-information DB 2305. If there is no difference (NO at S4405), the processing returns to the step 4401.

If the meta-information management module 2420 receives a meta-information request from any other meta-information management module 2420 after its activation (YES at S4411), it obtains the contents of its own meta-information DB 2305 (S4412) and send the contents of the meta-information DB to the request source (S4413).

If the meta-information management module 2420 receives meta-information from any other client computer 121 (YES at S4421) in the case where it is neither immediately after the activation (NO at S4401) nor it receives a meta-information request (NO at S4411), the meta-information management module 2420 registers the received data in the meta-information DB 2305 (S4422). This is receipt of the meta-information which is distributed by other computer 121 accompanying a file transmission.

If the meta-information management module 2420 does not receive meta-information from other client computers 121 (NO at S4421) but receives meta-information from the HTTP communication monitoring module 2410 or the TCP communication monitoring module 360 (YES at S4431), the meta-information management module 2420 sends the meta-information to all of the other agents 122 (client computers 121) (S4432). This is the distribution of meta-information concomitantly with a file transmission by the own client computer 121. The IP addresses of the computers to which the meta-information is to be transmitted are held in the security policy 392. If the determination at the step 4431 is NO, the processing returns to the step 4401.

The above-described configuration transmits and receives all contents of the meta-information DB in sending and receiving the meta-information after activation (S4404). Unlike this configuration, in requesting the contents of meta-information DBs in the other client computers, the agent 122 may add time data to request information to obtain the data after the designated time for the difference.

As set forth above, this invention has been described in detail with reference to the accompanying drawings; however, this invention is not limited to these specific configurations but includes various modifications and equivalent configurations within the scope of the added claims. For example, the computer system of this invention may comprise only a part of the constituents in the embodiments or comprise the constituents in the different embodiments.

For example, at least a part of the agent programs may be provided with dedicated hardware. Programs may be installed in each apparatus through a program distribution server or a computer-readable non-transitory storage medium to store in a non-volatile storage area in each apparatus. As described above, it is preferable that meta-information be written in the fork of a file, but the system may use a table that associates meta-information with file identification information.

In the system explained in each of the above-described embodiments, a part of the configuration constituents may be omitted. The configuration constituents explained in different embodiments may be included in one system. For example, a request for transmission of meta-information and the consequent transmitting and receiving of meta-information explained in the first embodiment may be applied to the third embodiment. Specifically, an agent may send a request for meta-information if the own meta-information DB does not include a matching record.

1. A method for detecting an improper operation to a file in a computer of a monitoring target in a computer system including a plurality of computers connected via a network, the method comprising:
receiving, by a first computer of a monitoring target, a file;
receiving, by the first computer, acquisition source information which is transmitted from a second computer and indicates an acquisition source of the file;
receiving, by the first computer, an operation for transmitting the file;
referring to, by the first computer, information on improper operation requirements held in a data storage apparatus to determine whether the transmission of the file meets the improper operation requirements or not, based on a combination of the acquisition source of the file indicated by the acquisition source information and a transmission destination of the file; and
determining, by the first computer, that the transmission of the file is an improper operation if the improper operation requirements are met.

2. The method for detecting an improper operation according to claim 1, wherein:
the first computer adds the acquisition source information to the file stored in a file system, and
the determination regarding the improper operation requirements refers to the acquisition source information added to the file.

3. The method for detecting an improper operation according to claim 2, wherein the second computer transmits the file separately from the acquisition source information to the first computer.

4. The method for detecting an improper operation according to claim 3, wherein:
the first computer transmits a request for the acquisition source information together with identification information on the file to the second computer, and
the second computer transmits the acquisition source information to the first computer in response to the request.

5. The method for detecting an improper operation according to claim 4, wherein the first computer is a client computer and the second computer is a server computer.

6. The method for detecting an improper operation according to claim 5, wherein:
the first computer receives a second file transmitted from a third computer;
the first computer analyzes information received with the second file to obtain identification information on the third computer, and stores the identification information on the third computer to the data storage apparatus;
the first computer refers to information which is held in the data storage apparatus and indicates computers being capable of transmitting acquisition source information to determine whether the third computer is capable of transmitting acquisition source information on the second file based on identification information on the third computer; and
the first computer newly creates acquisition source information on the second file without transmitting a request for acquisition source information to the third computer if the first computer determines that the third computer is not capable of transmitting the acquisition source information on the second file.

7. The method for detecting an improper operation according to claim 2, wherein:
the second computer creates and transmits a collective file including the file and the acquisition source information; and
the first computer obtains the collective file transmitted from the second computer and extracts the file and the acquisition source information from the collective file.

8. The method for detecting an improper operation according to claim 7, wherein the collective file includes a mail body including the acquisition source information and the file attached to the mail body.

9. The method for detecting an improper operation according to claim 2, wherein the second computer transmits the acquisition source information on the file to the first computer and another monitoring target computer.

10. The method for detecting an improper operation according to claim 9, wherein the second computer transmits the acquisition source information on the file to all monitoring target computers registered as transmission destinations of acquisition source information concomitantly with the transmission of the file.

11. The method for detecting an improper operation according to claim 10, wherein:
the first computer requests another monitoring target computer for acquisition source information held by the another monitoring target computer in response to a start-up;
the another monitoring target computer transmits acquisition source information held by the another monitoring target computer to the first computer in response to the request for transmission of acquisition source information; and
the first computer merges the acquisition source information received from the another monitoring target computer to acquisition source information held in the data storage apparatus in the first computer.

12. An improper operation detection system which comprises a plurality of monitoring target apparatuses connected via a network to detect an improper operation in each of the plurality of monitoring target apparatus, each of the monitoring target apparatuses including:
a file transmitting and receiving module for transmitting and receiving a file;
a data storage apparatus for storing the received file, acquisition source information on the file obtained from any other one of the plurality of monitoring target apparatuses, and information on improper operation requirements; and
an improper operation determination module that refers to the information on improper operation requirements to determine whether the transmission of the file meets the improper operation requirements or not, based on a combination of an acquisition source of the file indicated by the acquisition source information and a transmission destination of the file, and determines that the transmission of the file is an improper operation if the improper operation requirements are met.

13. A computer-readable non-transitory storage medium for storing a program to allow a computer to perform processing for detecting an improper operation to a file in the computer, wherein the processing comprising:
receiving a file via a network;
receiving acquisition source information, which is transmitted from a second computer and indicates an acquisition source information on the file, via the network;
receiving an operation for transmitting the file;
referring to information on improper operation requirements held in a data storage apparatus to determine whether the transmission of the file meets the improper operation requirements or not, based on a combination of the acquisition source of the file indicated by the acquisition source information and a transmission destination of the file; and
determining that the transmission of the file is an improper operation if the improper operation requirements are met.
